(19) United States
(12) Patent Application Publication
(10) Pub. No.: US 2026/0184297 A1
(43) Pub. Date: Jul. 2, 2026

(54) DISPLAY SYSTEM AND VEHICLE

(71) Applicant: TS TECH CO., LTD., Saitama (JP)

(72) Inventors: Hiroyuki NUMAJIRI, Tochigi (JP); Kazuhiro SHIMIZU, Tochigi (JP); Mika KUROSAWA, Tochigi (JP); Hiroshi YOGO, Tochigi (JP); Shoichi TAKAHASHI, Tochigi (JP); Yuta OSHINO, Tochigi (JP); Takuya OZAKI, Tochigi (JP); Hiroki ITO, Tochigi (JP); Jinichi TANABE, Tochigi (JP); Takayoshi ITO, Tochigi (JP)

(21) Appl. No.: 19/550,436

(22) Filed: Feb. 26, 2026

Related U.S. Application Data
(63) Continuation of application No. 18/565,108.
(60) Provisional application No. 63/196,724, filed on Jun. 4, 2021.
(60) Provisional application No. 63/234,742, filed on Aug. 19, 2021.
(60) Provisional application No. 63/239,430, filed on Sep. 1, 2021.
(60) Provisional application No. 63/239,443, filed on Sep. 1, 2021.

(30) Foreign Application Priority Data
Sep. 27, 2021 (JP) 2021-157176
Sep. 27, 2021 (JP) 2021-157177

(51) Int. Cl. B60W 10/30; B60N 2/00; B60N 2/20; B60Q 3/70; B60R 16/023; B60W 60/00

(52) U.S. Cl. CPC B60W 10/30; B60R 16/0231; B60W 60/005; B60N 2/002; B60N 2/20; B60Q 3/70

(57) ABSTRACT

There are provided a display system and a vehicle that provide good usability to an occupant. A display system includes: a projection device provided in a vehicle interior of a vehicle and capable of projecting a video in the vehicle interior; a sensor provided in the vehicle to detect a state of the vehicle or an occupant of the vehicle; and a control unit that receives a signal from the sensor to control the projection device. The control unit changes a projection state of the projection device based on the signal from the sensor. By automatically changing the projection state of the projection device, the effort for the occupant to operate the projection device is saved, and the usability of the projection device is improved.

### CROSS REFERENCE TO RELATED APPLICATIONS

This application is a continuation of U.S. application Ser. No. 18/565,108, filed on Nov. 29, 2023, which is a National Entry application of PCT Application Serial Number PCT/JP2022/022560, filed on Jun. 2, 2022. Further, this application claims from priority U.S. Provisional Application No. 63/196,724, filed on Jun. 4, 2021, U.S. Provisional Application No. 63/234,742, filed on Aug. 19, 2021, U.S. Provisional Application No. 63/239,430, filed on Sep. 1, 2021, U.S. Provisional Application No. 63/239,443, filed on Sep. 1, 2021, Japanese Patent Application Number 2021-157176, filed on Sep. 27, 2021, and Japanese Patent Application Number 2021-157177, filed on Sep. 28, 2021, the entire contents of which are hereby incorporated by reference into this application.

### TECHNICAL FIELD

The present invention relates to a display system and a vehicle, particularly to a display system and a vehicle including a projection device operating in conjunction with the state of a seat in a vehicle interior.

### BACKGROUND ART

In the related art, a technique in which a video is projected onto an inner wall of a vehicle by a projection device (projector) provided inside the vehicle to display a video inside the vehicle has been known. PATENT LITERATURE 1 discloses a projection device mounted in a vehicle to project a video onto a vehicle interior wall (rear glass).

### CITATION LIST

### Patent Literature

PATENT LITERATURE 1: WO 2018/55852

### SUMMARY OF INVENTION

### Technical Problem

Since the projection device described in PATENT LITERATURE 1 is not in cooperation with other systems (for example, an opening/closing system of a door) inside the vehicle, when a system inside the vehicle is used during the projection of the video (for example, an occupant opens a door to get out of the vehicle), the occupant needs to manually stop the projection device, so that usability is not sufficiently good for the occupant.

For that reason, for example, there has been a desire for a display system that cooperates with other systems in the vehicle and that provides good usability.

The present invention has been made in view of the above-described problems, and an object of the present invention is to provide a display system and a vehicle that provides good usability to an occupant.

### Solution to Problem

The above-described problems are solved by a display system and a vehicle including the display system according to the present invention that include: a projection device provided in a vehicle interior of the vehicle and capable of projecting a video in the vehicle interior; a sensor provided in the vehicle to detect a state of the vehicle or an occupant of the vehicle; and a control unit that receives a signal from the sensor to control the projection device. The control unit changes a projection state of the projection device based on the signal from the sensor.

In the display system of the present invention, based on the signal from the sensor provided in the vehicle, the projection state of the projection device can be changed, and the display system that provides good usability to the occupant can be provided.

In this configuration, the sensor may be a door sensor that detects an open/closed state of a door of the vehicle, and the control unit may stop the projection of the projection device when the door sensor detects that the door is opened.

When the door sensor detects that the door of the vehicle is opened, the projection of the projection device is automatically stopped, so that the effort for the occupant to operate the projection device is saved and the usability of the projection device is improved.

In addition, in this configuration, the sensor may be a window sensor that detects an open/closed state of a window or a roof window of the vehicle, and the control unit may stop the projection of the projection device when the window sensor detects that the window or the roof window is opened.

When the window sensor detects that the window or the roof window is opened, the projection of the projection device is automatically stopped, so that the effort for the occupant to operate the projection device is saved and the usability of the projection device is improved.

In addition, in this configuration, the sensor may be an incoming call sensor that detects an incoming call on a mobile phone of the occupant, and the control unit may stop the projection of the projection device when the incoming call sensor detects an incoming call on the mobile phone.

When the incoming call sensor detects an incoming call on the mobile phone, the projection of the projection device is automatically stopped, so that the effort for the occupant to operate the projection device is saved and the usability of the projection device is improved.

In addition, in this configuration, the sensor may be a seating sensor that detects a seated state of the occupant, and the control unit may stop the projection of the projection device when the seating sensor detects that the occupant leaves a seat.

When the seating sensor detects that the occupant leaves the seat, the projection of the projection device is automatically stopped, so that the effort for the occupant to operate the projection device is saved and the usability of the projection device is improved.

In addition, in this configuration, the sensor may be an illuminance sensor that measures an illuminance of the vehicle interior, and the control unit may correct the video projected by the projection device, based on the illuminance measured by the illuminance sensor.

By measuring the illuminance of the vehicle interior and by automatically correcting the video based on the illuminance, the effort for the occupant to operate the projection device is saved, and the usability of the projection device is improved.

In addition, in this configuration, the vehicle may include an illuminance adjustment mechanism that adjusts the illuminance of the vehicle interior based on the illuminance measured by the illuminance sensor. The control unit may correct the video projected by the projection device, based on an illuminance measured by the illuminance sensor after the adjustment.

By adjusting the illuminance of the vehicle interior using the illuminance adjustment mechanism, the vehicle interior can be adjusted to a brightness suitable for the projected video, so that the usability of the projection device is improved.

In addition, in this configuration, the vehicle may be an autonomous driving vehicle that can travel autonomously, and include a mode switching unit that switches between a manual driving mode and an autonomous driving mode. The control unit may set the projection device to be operable when the vehicle is switched to the autonomous driving mode by the mode switching unit, and may set the projection device to be inoperable or stop the projection of the projection device when the vehicle is switched to the manual driving mode.

The projection device can be switched between being operable and being inoperable by switching between the manual driving mode and the autonomous driving mode, so that the effort for the occupant to operate the projection device is saved and the usability of the projection device is improved.

In addition, in this configuration, a seat state changing mechanism that changes a state of a seat in which the occupant is seated may be provided, and the control unit may prompt a use of the projection device when a seat back of the seat is tilted rearward by more than a predetermined angle by the seat state changing mechanism.

When the seat back is tilted rearward by the seat state changing mechanism, the use of the projection device is prompted, so that the effort for the occupant to operate the projection device is saved and the usability of the projection device is improved.

### Advantageous Effects of Invention

According to the display system and the vehicle including the display system of the present invention, based on the signal from the sensor provided in the vehicle, the projection state of the projection device can be changed, and the display system that provides good usability to the occupant can be provided.

In addition, when the sensor in the present invention is a door sensor, in a case where the door sensor detects that a door of the vehicle is opened, the projection of the projection device is automatically stopped, so that the effort for the occupant to operate the projection device is saved and the usability of the projection device is improved.

In addition, when the sensor is a window sensor, in a case where the window sensor detects that a window or a roof window is opened, the projection of the projection device is automatically stopped, so that the effort for the occupant to operate the projection device is saved and the usability of the projection device is improved.

In addition, when the sensor in the present invention is an incoming call sensor that detects an incoming call on the mobile phone of the occupant, in a case where the incoming call sensor detects an incoming call on the mobile phone, the projection of the projection device is automatically stopped, so that the effort for the occupant to operate the projection device is saved and the usability of the projection device is improved.

In addition, when the sensor in the present invention is a seating sensor, in a case where the seating sensor detects that the occupant leaves a seat, the projection of the projection device is automatically stopped, so that the effort for the occupant to operate the projection device is saved and the usability of the projection device is improved.

In addition, when the sensor in the present invention is an illuminance sensor, by measuring an illuminance of the vehicle interior and by automatically correcting the video based on the illuminance, the effort for the occupant to operate the projection device is saved, and the usability of the projection device is improved.

In addition, by adjusting the illuminance of the vehicle interior using the illuminance adjustment mechanism that adjusts the illuminance of the vehicle interior, the vehicle interior can be adjusted to a brightness suitable for the projected video, so that the usability of the projection device is improved.

In addition, when the vehicle in the present invention is an autonomous driving vehicle that can travel autonomously, the projection device can be switched between being operable and being inoperable by switching between the manual driving mode and the autonomous driving mode, so that the effort for the occupant to operate the projection device is saved and the usability of the projection device is improved.

In addition, when the seat back is tilted rearward by the seat state changing mechanism, the use of the projection device is prompted, so that the effort for the occupant to operate the projection device is saved and the usability of the projection device is improved.

### BRIEF DESCRIPTION OF DRAWINGS

FIG. 1 is a side view schematically showing a display system according to the present embodiment.

FIG. 2 is a top view schematically showing the display system according to the present embodiment.

FIG. 3 is a diagram showing an ECU and control objects of the ECU.

FIG. 4 is a flowchart showing the contents of control of a projector by a door sensor.

FIG. 5 is a flowchart showing the contents of control of the projector by an illuminance sensor.

FIG. 6 is a flowchart showing the contents of control of the projector when the driving mode is switched.

FIG. 7 is a flowchart showing the contents of control of the projector based on the seat state.

FIG. 8 is a side view schematically showing a display system that projects a video onto a vehicle seat arranged in tandem.

FIG. 9 is a side view schematically showing a display system that projects a video onto a tailgate.

FIG. 10 is a plan view schematically showing a display system in which a screen is disposed to bridge between right and left vehicle seats and a video is projected onto the screen.

FIG. 11 is a plan view schematically showing a display system in which a screen is disposed to bridge between right and left vehicle seats and which projects a video onto the screen.

FIG. 12 is a side view schematically showing another example of the attachment and storage position of the projector.

FIG. 13 is a top view schematically showing another example of the attachment and storage positions of the ECU and the projector.

FIG. 14 is a perspective view showing a vehicle seat to which operation levers are attached.

FIG. 15 is a top view schematically showing the armrests that are rotatable in a right to left direction.

FIG. 16 is a view showing a storage portion provided in a door.

FIG. 17 is a perspective view showing a vehicle seat provided with an air outlet and a moisture outlet.

FIG. 18 is a perspective view showing a headrest to which a VR goggle is detachably attached.

FIG. 19 is a view showing the inside of a vehicle in which a support member that supports an occupant is provided between a door and a vehicle seat.

FIG. 20 is a top view of a vehicle seat including a turnable headrest.

FIG. 21 is an external perspective view showing a vehicle member (vehicle seat) of a third embodiment.

FIG. 22 is a perspective view showing a seat frame serving as a skeleton.

FIG. 23 is a vertical cross-sectional view of the vehicle seat including thermoelectric power generation members.

FIG. 24A is a partial enlarged view showing a part of the thermoelectric power generation member of the vehicle seat at a portion A of FIG. 23.

FIG. 24B is a modification example of a partial enlarged view showing a part of the thermoelectric power generation member of the vehicle seat at the portion A of FIG. 23.

FIG. 25 is a block diagram illustrating an electric circuit of the vehicle seat.

FIG. 26 is a perspective view of a seat frame of a vehicle member (vehicle seat) of a second example.

FIG. 27 is a bottom view of a seat frame of a vehicle member (vehicle seat) of a third example.

FIG. 28 is a side view of a vehicle member (vehicle seat) of a fourth example.

FIG. 29 is a top view of a seat frame of a vehicle member (vehicle seat) of a fifth example.

FIG. 30 is a front view of a vehicle member (vehicle door lining) of a sixth example when viewed from a vehicle inner side.

FIG. 31 is a vertical cross-sectional view of a vehicle of the sixth example, and is a view illustrating a configuration of a vehicle door.

FIG. 32 is a perspective view showing a vehicle member (vehicle interior member) of a seventh example.

FIG. 33 is a perspective view showing the appearance of a vehicle seat according to a fourth embodiment.

FIG. 34 is a side view showing a vehicle seat.

FIG. 35 is a plan view of a headrest used in the vehicle seat.

FIG. 36 is a front view of the headrest used in the vehicle seat.

FIG. 37 is a schematic side view showing a state where a seat back is tilted rearward more than a predetermined angle with respect to a vertical direction in the vehicle including the vehicle seat.

FIG. 38 is a block diagram showing a configuration of a seat control device and a vehicle control device mounted in the vehicle seat and the vehicle.

FIG. 39 is a flowchart showing one example of the flow of control of the control device when side portions of the headrest are not in a protruding state.

FIG. 40 is a flowchart showing one example of the flow of control of the control device when the side portions of the headrest do not return from a protruding state.

### DESCRIPTION OF EMBODIMENTS

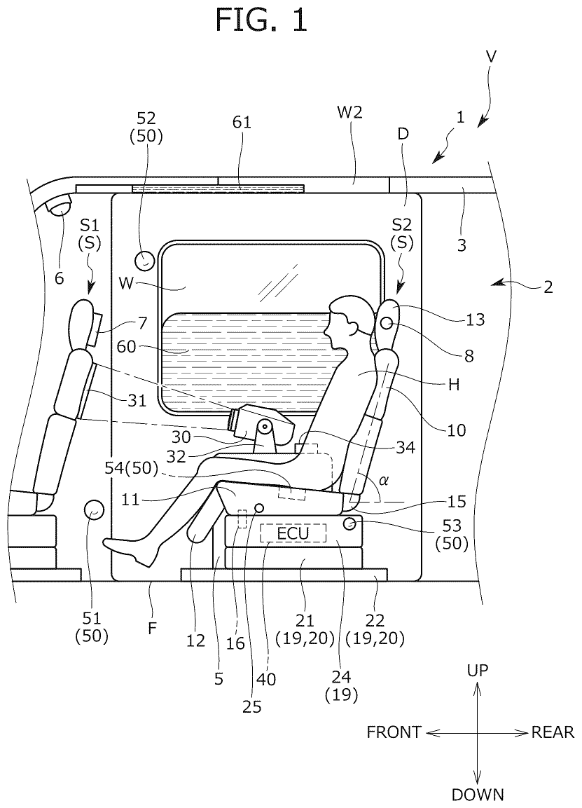

Hereinafter, a display system for vehicle and a vehicle including the display system according to an embodiment of the present invention will be described with reference to FIGS. 1 to 13.

Incidentally, the embodiment to be described below is merely one example for facilitating understanding of the present invention, and does not limit the present invention. Namely, the shapes, dimensions, dispositions, and the like of members to be described below can be modified or improved without departing from the concept of the present invention, and it goes without saying that the present invention includes equivalents thereof.

The present embodiment relates to the invention of a display system and a vehicle including the display system that include: a projection device provided in a vehicle interior of the vehicle and capable of projecting a video in the vehicle interior; a sensor provided in the vehicle to detect a state of the vehicle or an occupant of the vehicle; and a control unit that receives a signal from the sensor to control the projection device. The control unit changes a projection state of the projection device based on the signal from the sensor.

As one example of the vehicle, a vehicle V that is a four-wheeled electric vehicle (EV vehicle) will be provided, and a configuration example of the four-wheeled electric vehicle will be described. The vehicle V may be not only a four-wheeled electric vehicle but also an engine vehicle, a hybrid vehicle including both a motor and an engine for traveling, a vehicle in which a battery and a fuel cell are mounted as a power source, or the like.

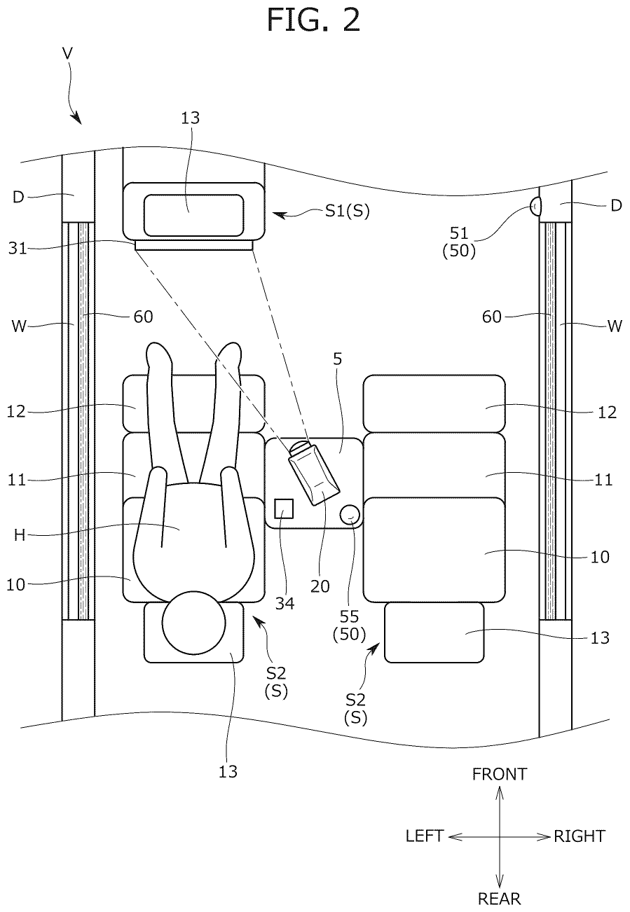

In the following description, as shown in FIG. 1, a “front to rear direction” refers to a front to rear direction when viewed from the vehicle V and an occupant H (hereinafter, may be referred to as a seated occupant) of a vehicle seat S, and is a direction that coincides with a traveling direction of the vehicle V. As shown in FIG. 2, a “seat width direction” or a “vehicle width direction” is a lateral width direction of the vehicle V and the vehicle seat S, and coincides with a right to left direction when viewed from the occupant H of the vehicle seat S. In addition, an “up to down direction” is an up to down direction of the vehicle V, and is a direction that coincides with a vertical direction when the vehicle V travels on a horizontal surface. In addition, the “outside” simply referred to indicates a side closer to the outside in a direction from the center of the vehicle V toward the outside, and the “inside” refers to a side closer to the center in a direction from the outside of the vehicle V toward the center.

Incidentally, unless otherwise specified, the shape, position, posture, and the like of each part of the vehicle seat S provided in the vehicle V to be described below will be described assuming that the vehicle seat S is in a seated state.

A configuration of the vehicle V and a display system 1 will be described with reference to FIGS. 1 to 3.

### <Vehicle V>

As shown in FIG. 1, the vehicle V includes a vehicle door D, a roof 3, and a floor F that define a passenger compartment 2, and a front seat S1 and a rear seat S2 are placed on the floor F. Both the front seat S1 and the rear seat S2 are vehicle seats S in which the occupant H can be seated. Hereinafter, the rear seat S2 disposed on the rear side of the vehicle will be mainly described; however, since the front seat S1 disposed on the front side also has the same configuration, unless otherwise differentiated, the seat may be simply referred to and described as the vehicle seat S.

The vehicle door D is provided with a window W that can be opened and closed. In addition, a sunshade 60 that blocks outside light is provided on a vehicle inner side of the window W. Brightness (illuminance) in the passenger compartment 2 can be adjusted by raising or lowering the sunshade 60. Namely, the sunshade 60 functions as an illuminance adjustment mechanism that adjusts the illuminance in the passenger compartment 2. The window W can be opened and closed manually or automatically. When the sunshade 60 can be automatically opened and closed, the sunshade 60 is controlled by an ECU 40 to be described later in the vehicle interior.

In addition, the roof 3 is provided with a roof window W2 that can be opened and closed, and outside light can be taken into the passenger compartment 2 by opening the roof window W2. In addition, the roof window W2 is provided with a roof sunshade 61. Similarly to the sunshade 60 of the window W, the roof sunshade 61 is also an illuminance adjustment mechanism, and outside light is blocked by covering the roof window W2 with the roof sunshade 61, so that the illuminance in the passenger compartment 2 can be adjusted. The roof sunshade 61 can also be opened and closed manually or automatically. When the roof sunshade 61 can be automatically opened and closed, the roof sunshade 61 is controlled by the ECU 40 to be described later in the vehicle interior.

In addition, the vehicle V is an autonomous driving vehicle that can travel autonomously, and includes a mode switching unit 62 that switches between a manual driving mode in which the vehicle V can be driven manually and an autonomous driving mode in which the vehicle V travels autonomously. For example, the occupant H executes the switching of the driving mode through the mode switching unit 62 by pressing a mode switching button. When the driving mode is switched, a signal of switching is transmitted to the ECU 40 to be described later.

### <Display System 1>

As shown in FIGS. 1 and 2, the display system 1 includes a projector 30 that is a projection device; a sensor 50 that detects the state of the vehicle V or the occupant H; and the electronic control unit 40 (ECU) that is a control unit.

The ECU 40 is connected to the projector 30 and the sensor 50 by wire or wirelessly, and transmits and receives signals. In addition, the ECU 40 can control the projector 30, and for example, can cause the projector 30 to project a video or stop projecting a video. In addition, the brightness or color tone of the video projected by the projector 30 can be corrected.

### <Projector 30>

The projector 30 is a device that projects a video 31 onto a wall surface in the vehicle interior, for example, projects the video 31 onto a back surface of a seat back 10 of the front seat S1 as a projection surface.

The projector 30 is attached to a center console 5 provided on a side of the vehicle seat S. Even when the projector 30 is a single unit, the projector 30 can change a video projection position, angle, or the like by changing the direction of a lens. In addition, a body of the projector 30 is attached to a projector movable mechanism 32, and the angle of the body of the projector 30 in a vertical direction and the angle in a horizontal direction with respect to the vehicle V can be changed by the projector movable mechanism 32.

The projector 30 is controlled by the ECU 40; however, a projector operation switch 34 is also provided for operation, and the occupant H can directly operate the projector 30 using the projector operation switch 34.

In addition, a speaker 8 is provided at a side portion of a headrest 13. The speaker 8 can stream music in time with the video projected by the projector 30. The speaker 8 is also connected to the ECU 40, and can also issue a warning sound or an audio message in addition to music. Incidentally, the position of the speaker 8 is not limited to the headrest 13, and the speaker 8 may be provided on an inner wall surface of the vehicle door D or the roof 3.

### <Sensor 50>

The vehicle V includes a door sensor 51, a window sensor 52, an incoming call sensor 53, a seating sensor 54, and an illuminance sensor 55 as the sensor 50 that detects the state of the vehicle V or the occupant H. In addition, as shown in FIG. 1, the vehicle V may be provided with an in-vehicle camera 6 and an in-vehicle monitor 7.

The in-vehicle camera 6 and the in-vehicle monitor 7 may also function as the sensor 50 that detects the state of the vehicle V or the occupant H.

The door sensor 51 is a sensor provided in the vicinity of the vehicle door D to detect the open/closed state of the vehicle door D. The window sensors 52 are sensors provided on the window W and the roof window W2 to detect the open/closed state of the window W and the roof window W2. The door sensor 51 and the window sensor 52 transmit an open indication signal to the ECU 40 when the vehicle door D, the window W, or the roof window W2 is opened.

In addition, the window sensor 52 is also connected to the sunshade 60 and the roof sunshade 61, and transmits the open/closed state of the sunshade 60 and the roof sunshade 61 to the ECU 40.

The incoming call sensor 53 is wirelessly connected to a mobile phone or a smartphone (hereinafter, a mobile terminal or the like) of the occupant H, and transmits an incoming call signal to the ECU 40 when there is an incoming call on the mobile terminal or the like. The incoming call sensor 53 and the mobile terminal or the like communicate with each other using a WiFi network, Bluetooth (registered trademark), or the like; however, instead of the incoming call sensor 53, the ECU 40 may be directly connected to the mobile terminal or the like and receive the incoming call signal from the mobile terminal or the like.

The seating sensor 54 is provided on a seat cushion 11 of the vehicle seat S, and detects whether or not the occupant H is seated in the vehicle seat S. The seating sensor 54 detects a pressure applied when the occupant H is seated in the vehicle seat S, and transmits a signal indicating the seating of the occupant H to the ECU 40 when a predetermined pressure or more is applied.

The illuminance sensor 55 is a sensor that measures an illuminance of the passenger compartment 2, and is disposed, for example, on the center console 5 (refer to FIG. 2). The illuminance is constantly measured, and the measurement results are transmitted to the ECU 40. The ECU 40 can determine whether the vehicle V travels in a dark place such as a tunnel or travels in a bright place with no shade, based on the illuminance.

The in-vehicle camera 6 is provided on the roof 3, captures a video of the occupant H seated in the vehicle seat S, and transmits the video of the occupant H to the ECU 40. The ECU 40 may determine whether or not the occupant is seated in the vehicle seat S, based on the video received from the in-vehicle camera 6.

As shown in FIG. 1, the in-vehicle monitor 7 is provided on a back surface of the headrest of the front seat S1. The in-vehicle monitor 7 is a device that displays video information, and is configured to be operable by the occupant H using an operation button or a touch input on a screen. It is assumed that the in-vehicle camera 6 and the in-vehicle monitor 7 are included in the sensor 50 that detects the state of the vehicle or the occupant.

### <Vehicle Seat S>

The vehicle seat S includes the seat back 10, the seat cushion 11, an ottoman 12, the headrest 13, and a seat support unit 19. In addition, the vehicle seat S includes a reclining mechanism 15 that tilts the seat back 10, and a tilt mechanism 16 that tilts the seat cushion 11. In addition, the seat support unit 19 includes a seat slide mechanism 20 that moves the vehicle seat S in the front to rear direction or the right to left direction, and a seat rotation mechanism 24 that rotates the vehicle seat S about an axis in the up to down direction.

The seat back 10 supports the back of the occupant H from the rear, and is configured by supporting a cushion material on a frame (not shown) and by covering the cushion material with a skin.

In addition, the seat back 10 can be moved (strictly speaking, rotated) by the reclining mechanism 15 to be described later so as to be tilted rearward with respect to the seat cushion 11.

By using the reclining mechanism 15 or the like, the vehicle seat S can be transformed into at least two states: from an upright posture where the seat back 10 is upright (refer to FIG. 1) to a reclined posture where the seat back 10 is tilted rearward. Incidentally, in a state where the vehicle seat S is in the upright posture, the occupant H assumes a normal standing posture (for example, a driving posture) with respect to the vehicle seat S. On the other hand, in a state where the vehicle seat S is in the reclined posture, the occupant H assumes a neutral posture with respect to the vehicle seat S.

The seat cushion 11 supports the buttocks of the occupant H from below, and is configured by placing a cushion material on a frame (not shown) and by covering the cushion material with a skin. A rear end portion of the seat cushion 11 is connected to a lower end portion of the seat back 10 via a shaft extending along the seat width direction. In addition, the seat cushion 11 according to the present embodiment can be rotated by the tilt mechanism 16 to be described later such that a front end portion of the seat cushion 11 is raised and lowered in the up to down direction.

The ottoman 12 supports the lower legs of the occupant H from below, and is configured by placing a cushion material on a frame board (not shown) and by covering the cushion material with a skin. The ottoman 12 is supported by the front end portion of the seat cushion 11 via a rotating shaft extending along the seat width direction. Namely, the ottoman 12 is rotatable around the rotating shaft.

The headrest supports the head of the seated occupant H from the rear, and is configured by supporting a cushion material on a frame (not shown) and by covering the cushion material with a skin. In addition, the headrest 13 can be moved upward and downward with respect to the seat back 10 by a headrest movement mechanism (not shown). Namely, in the present embodiment, the position where the head of the occupant H is supported can be changed according to the movement of the headrest 13 by the headrest movement mechanism. In addition, the speaker 8 is provided at the side portion of the headrest 13, and can issue music, audio, or the like toward the occupant H.

The reclining mechanism 15 is a mechanism that moves (rotates) the seat back 10 to change the angle where the seat back 10 is reclined with respect to the vehicle (rearward tilt angle α), and is realized, for example, by driving a motor (not shown). By operating the reclining mechanism 15, the seat back 10 is rotated about a shaft member connecting the seat back 10 and the seat cushion 11. A hall IC is provided in the motor provided in the reclining mechanism 15, and outputs a pulse every time the motor makes one revolution. The pulses are received by the ECU 40, and the ECU 40 can measure the rearward tilt angle α of the seat back 10 based on the received pulses.

The tilt mechanism 16 is a mechanism that moves (rotates) the seat cushion 11 such that the front end portion of the seat cushion 11 is raised and lowered, and is composed of, for example, a jack-type electric lift mechanism. By operating the tilt mechanism 16, a front end of the seat cushion 11 is rotated with respect to a rear end of the seat cushion 11. A hall IC is provided in a motor that drives the tilt mechanism 16, and outputs a pulse every time the motor makes one revolution. The output pulses are received by the ECU 40, and the angle where the seat cushion 11 is inclined with respect to the vehicle body floor F can be measured.

The seat support unit 19 is a device that supports the vehicle seat S from below, and is attached to a lower portion of the seat cushion 11. Specifically, the seat support unit 19 is configured by covering a frame member with a cover member, the frame member connecting the vehicle seat S and both the seat slide mechanism 20 and the seat rotation mechanism 24.

Incidentally, the ECU 40 as a control unit that controls each mechanism of the vehicle seat S, the projector 30, the in-vehicle camera 6, the sensor 50, the sunshade 60, and the like is accommodated inside the seat support unit 19. Naturally, the ECU 40 is not limited to being accommodated inside the seat support unit 19, and may be accommodated inside the seat back 10, the seat cushion 11, or the like, and may be externally attached to the vehicle seat S.

The seat slide mechanism 20 is a mechanism for sliding the vehicle seat S with respect to the vehicle body floor F in the front to rear direction and the right to left direction. The seat slide mechanism 20 includes upper rails 21, lower rails 22, and a slide motor for sliding the upper rails 21 with respect to the lower rails 22. A hall IC is also attached to the slide motor, and outputs a pulse every time the motor makes one revolution.

The upper rails 21 are fixed to the vehicle seat S via the seat support unit 19, and the lower rails 22 are fixed to the vehicle body floor F. Here, by sliding the upper rails 21 forward and rearward or rightward and leftward with respect to the lower rails 22 through operating the slide motor, the vehicle seat S, namely, the seat back 10, the seat cushion 11, the headrest 13, and the ottoman 12 can be integrally moved forward and rearward or rightward and leftward with respect to the vehicle body floor F.

The seat rotation mechanism 24 is a mechanism for rotating the vehicle seat S about the axis in the up to down direction with respect to the vehicle body floor F. The seat rotation mechanism 24 includes a seat rotation motor. A hall IC is also attached to the seat rotation motor, and outputs a pulse every time the motor makes one revolution. The pulses are received by the ECU 40, thereby being able to measure a rotation angle of the vehicle seat S with respect to a movement direction of the vehicle.

In addition, the vehicle seat S includes an operation switch 25. The operation switch 25 is an operation unit that is provided at a side portion of the seat cushion 11 of the vehicle seat S and that instructs the posture transformation of the vehicle seat S. For example, the operation switch 25 may include a first switch for transforming the vehicle seat S from the upright posture to the reclined posture, and a second switch for transforming the vehicle seat S from the reclined posture to the upright posture.

### <ECU 40>

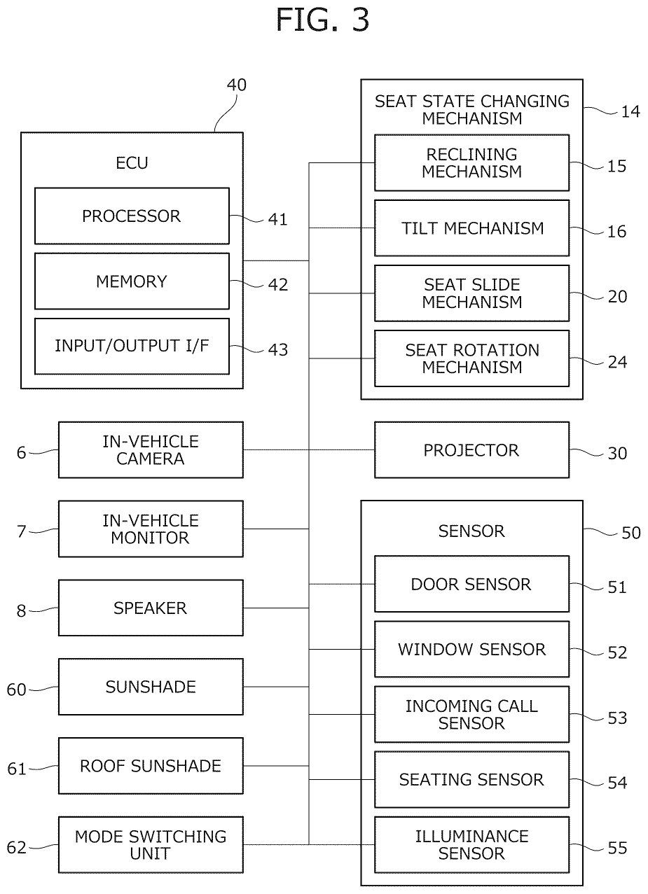

As shown in FIG. 3, the ECU 40 is connected to a plurality of the sensors 50 provided in the vehicle interior, and receives a signal, a measurement result, or the like from each of the sensors 50.

The ECU 40 is connected to devices provided in the vehicle interior, for example, the in-vehicle camera 6, the in-vehicle monitor 7, the speaker 8, the sunshade 60, the roof sunshade 61, and the mode switching unit 62, and can control the operation of each device.

In addition, as shown in FIG. 3, the ECU 40 is a control unit that controls the reclining mechanism 15, the tilt mechanism 16, the seat slide mechanism 20, the seat rotation mechanism 24, and the projector 30 described above, and is connected to each mechanism by wire or wirelessly. In addition, the ECU 40 can receive pulses from the motors provided in the reclining mechanism 15, the tilt mechanism 16, the seat slide mechanism 20, and the seat rotation mechanism 24, and calculate a rotation angle, a movement amount, or the like.

Furthermore, as shown in FIG. 3, the ECU 40 includes a processor 41, a memory 42, and an input/output interface 43.

The processor 41 is a central processing unit that executes various computational processing based on programs or data stored in the memory 42 or a signal received from each device connected thereto via the input/output interface 43, and that controls each part of the display system 1. The memory 42 is, for example, a semiconductor memory, and also functions as a work memory for the processor 41 in addition to storing various programs or data. The input/output interface 43 is connected and communicates with the reclining mechanism 15, the tilt mechanism 16, the seat slide mechanism 20, the seat rotation mechanism 24, the projector 30, the operation switch 25, the sensors 50, and in-vehicle devices (the in-vehicle camera 6, the in-vehicle monitor 7, and the like).

### <Control Process of Projector 30>

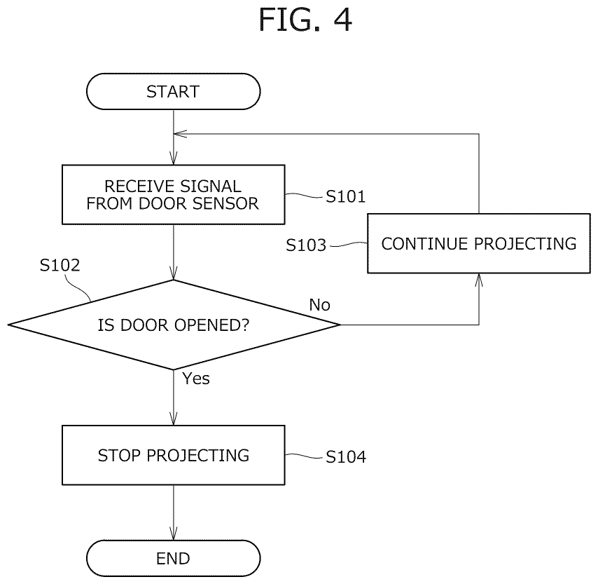

Next, a control process of the projector 30 in cooperation with the sensors 50 or the devices provided in the vehicle V will be described using the flowcharts shown in FIGS. 4 to 7.

<Projection Stop Process in Cooperation with Device>

FIG. 4 is a flowchart showing a control process of the projector 30 in cooperation with the vehicle door D. At the starting point of the control process, it is assumed that the projector 30 projects a video onto a projection surface in the vehicle interior.

The ECU 40 receives a signal indicating the open/closed state of the vehicle door D from the door sensor 51 (step S101: signal reception process). Next, the ECU 40 determines whether or not the vehicle door D is in an open state, based on the received signal (step S102: state determination process). When it is determined that the vehicle door D is not in an open state (No in step S102), the ECU 40 causes the projector 30 to continue projecting the video (step S103: projection continuation process). When it is determined that the vehicle door D is in an open state (Yes in step S102), the ECU 40 stops the projection of the projector 30 (step S104: projection stop process).

In such a manner, when it is determined that the vehicle door D is in an open state, the projection by the projector 30 is automatically stopped. Namely, when the door is opened to allow the occupant H to get in and out of the vehicle, the video is automatically stopped, so that the effort for the occupant H to stop the projector 30 can be saved and the usability of the projector 30 can be improved.

Incidentally, in the flowchart of FIG. 4, the contents of control of the vehicle door D using the door sensor 51 has been described; however, the same applies when the window sensor 52 is used. The window sensor 52 detects whether or not the window W or the roof window W2 is opened, and even when it is determined that the window W or the roof window W2 is opened, based on the signal received by the ECU 40, the ECU 40 stops the projection of the projector 30.

Since the video is automatically stopped when the occupant H opens the window W, the effort for the occupant H to stop the projector 30 can be saved, and the usability of the projector 30 can be improved.

In addition, when the occupant H starts using the in-vehicle monitor 7, the projection by the projector 30 may be automatically stopped. Namely, when the ECU 40 receives an operation acceptance signal from the in-vehicle monitor 7 and the ECU 40 determines that the use of the in-vehicle monitor 7 is started, the projection of the projector 30 is stopped. When the occupant H uses the in-vehicle monitor 7, the video is automatically stopped, so that the effort for the occupant to stop the projector 30 can be saved and the usability of the projector 30 can be improved.

In addition, when a call comes in on the mobile terminal or the like owned by the occupant H, the projection by the projector 30 may be automatically stopped. Namely, when the ECU 40 receives a signal from the incoming call sensor 53 and the ECU 40 determines that there is an incoming call on the mobile terminal or the like, the projection of the projector 30 is stopped. Since the video is automatically stopped when there is an incoming call on the mobile phone, the smartphone, or the like of the occupant H, the effort for the occupant to stop the projector 30 can be saved, and the usability of the projector 30 can be improved.

When the occupant H is not seated in the vehicle seat S, for example, when the seated occupant H stands up from the vehicle seat S, the video projected by the projector 30 may be automatically stopped. Namely, when the ECU 40 receives a signal from the seating sensor 54 and the ECU 40 determines that no person is seated in the vehicle seat S, the video projection by the projector 30 is stopped.

Incidentally, whether or not the occupant H is seated in the vehicle seat S may be determined based on a video received from the in-vehicle camera 6 instead of using the signal from the seating sensor 54.

Since the video is automatically stopped when the occupant H is seated in the vehicle seat S, the effort for the occupant H to stop the projector 30 can be saved, and the usability of the projector 30 can be improved.

### <Video Correction Process Based on Illuminance>

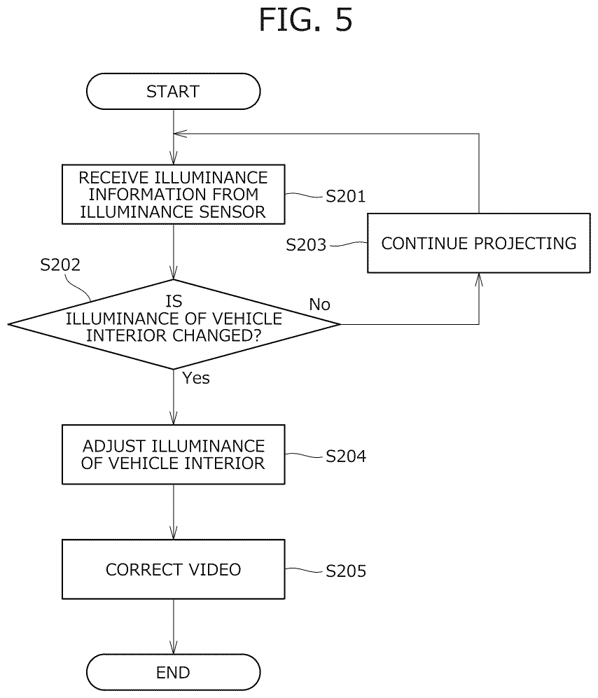

A control process (video correction process) of the projector 30 in cooperation with the illuminance sensor 55 will be described using FIG. 5. FIG. 5 is a flowchart showing the video correction process based on illuminance. At the starting point of the video correction process, it is assumed that the projector 30 projects a video onto a screen in the vehicle interior. In addition, it is assumed that the illuminance sensor 55 constantly measures the brightness (illuminance) of the vehicle interior and the outside and transmits the measurement results to the ECU 40.

The ECU 40 receives the illuminance measurement results (illuminance information) from the illuminance sensor 55 (step S201: illuminance reception process). Next, the ECU 40 determines whether or not there is a large change from the previously received illuminance information (step S202: illuminance change measurement process). When it is determined that there is no change in illuminance or the change is smaller than a predetermined value (step S202: No), the ECU 40 causes the projector 30 to continue projecting without correcting the video (step S203).

When there is a large change in the illuminance of the vehicle interior (step S202: Yes), the ECU 40 causes the illuminance of the vehicle interior to be adjusted (step S204: illuminance adjustment process).

The illuminance of the vehicle interior is adjusted using the sunshade 60 or the roof sunshade 61 that is an illuminance adjustment mechanism. For example, when the vehicle enters a tunnel or the like and the vehicle interior becomes dark, outside light is taken in by lowering the sunshade 60. In addition, for example, when the vehicle exits a tunnel and the vehicle interior becomes bright, outside light is blocked by raising the sunshade 60. The illuminance of the vehicle interior may be adjusted by taking in or blocking outside light through operating the roof sunshade 61.

After the illuminance of the vehicle interior is adjusted, the ECU 40 causes the brightness or color tone of the video to be appropriately corrected in accordance with the illuminance of the vehicle interior after the adjustment such that there is no change from the video before a change occurs in the illuminance of the vehicle interior (step S205: video correction process).

Since the video of projector 30 is corrected in accordance with the illuminance of the vehicle interior, the effort for the occupant H to operate the projector 30 to adjust the video is saved, so that the usability of the projector 30 can be improved.

Incidentally, when the sunshade 60 and the like that can be controlled by the ECU 40 is not mounted in the vehicle V, the illuminance adjustment process of step S204 may be omitted. In this case, when there is a change in illuminance, the ECU 40 controls the projector 30 to correct the video in accordance with the illuminance in the passenger compartment 2 such that the brightness or color tone of the video is not changed.

In addition, during projection, the brightness (illuminance) of the interior may be restricted by sufficiently shading the window and the like using the illuminance adjustment mechanism, and by restricting the number of vehicle interior lightings.

In addition, the video is made easier to see by setting the projection surface at a position that avoids the direction of sunlight. For example, by setting the projection surface at a position orthogonal to the direction of sunlight, the video projected by the projector 30 is made easier to see. When a plurality of the projectors 30 are provided, the projector 30 to be used may be selected depending on the direction of sunlight.

### <Control Process in Mode Switching>

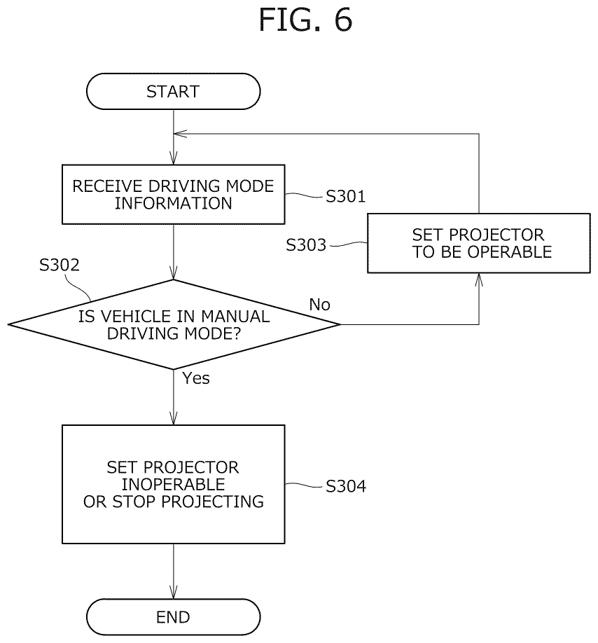

FIG. 6 is a flowchart showing a control process of the projector 30 in cooperation with the mode switching unit 62. At the start point of the control process, it is assumed that the vehicle V is being driven in the autonomous driving mode and the projector 30 projects a video. When the occupant H switches the vehicle V in autonomous driving to the manual driving mode, the occupant H presses a mode switching button to instruct the mode switching unit 62 to switch to the manual driving mode.

The ECU receives 40 driving mode information indicating the driving mode from the mode switching unit 62 (step S301: signal reception process). Next, the ECU 40 determines the driving mode based on the received information (step S302: driving mode determination process).

When the driving mode is the autonomous driving mode (step S302: No), the operation of the projector 30 is enabled or the video projection of the projector 30 is started (step S303: projection start process). When the driving mode is the manual driving mode (step S302: Yes), the ECU 40 sets the projector 30 to be inoperable or stops the projection by the projector 30 (step S304: projection stop process).

In a case where the video is projected when the driving mode is switched to the manual driving mode, the occupant H may be notified of an announcement “the video will be stopped” (step S305: announcement notification process).

By performing the above-described process during mode switching, the effort for the occupant H to change the setting of the projector 30 or operate the projector 30 is saved, so that the usability of the projector 30 can be improved.

<Control Process when Seat State is Changed>

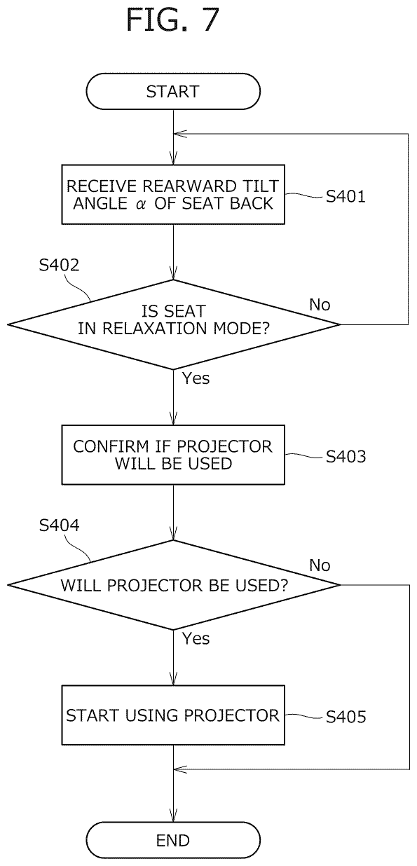

FIG. 7 is a flowchart showing a control process of the projector 30 in cooperation with a seat state changing mechanism 14 of the vehicle seat S when the shape of the seat is changed.

The occupant H operates the reclining mechanism 15 of the seat state changing mechanism 14 by pressing the operation switch 25 in a state where the occupant H is seated in the vehicle seat in the upright posture, so that the seat back 10 is reclined such that the rearward tilt angle α of the seat back 10 reaches a predetermined angle or more.

The ECU 40 receives information about the rearward tilt angle α of the seat back 10 from the reclining mechanism 15 (step S401: signal reception step). Specifically, the ECU 40 obtains the rearward tilt angle α of the seat back 10 by receiving pulses from the motor of the reclining mechanism 15 and by measuring a rotation speed.

Next, the ECU 40 determines whether or not the vehicle seat S is in a relaxation mode (step S402: mode determination process).

The relaxation mode is a state where the seat back 10 is greatly reclined rearward. The ECU 40 stores the rearward tilt angle α of the seat back 10 in the relaxation mode as a predetermined angle β. When the occupant H tilts the seat back 10 rearward using the operation switch 25 and the rearward tilt angle α reaches the predetermined angle β or less, the ECU 40 determines that the seat state of the vehicle seat S is the relaxation mode.

When the state of the vehicle seat S is not the relaxation mode (step S402: No), the process returns to step S401, and the rearward tilt angle α of the seat back 10 is acquired.

When the state of the vehicle seat S is the relaxation mode (step S402: Yes), the ECU 40 prompts the occupant H to use the projector 30 (step S403: projector use proposal process). When the occupant H is prompted to use, for example, the ECU 40 may use the speaker 8 to notify the occupant H of an announcement “do you want to start a video?” by audio. In addition, an announcement may be notified by displaying the announcement in text on the in-vehicle monitor 7.

The ECU 40 determines whether or not the occupant H wishes to use the projector 30 (step S404: projector use confirmation process).

At this time, the occupant H may convey the wish to the ECU 40 by voice, and the ECU 40 determines whether or not the occupant H wishes to use the projector 30, based on a message input by voice recognition. The occupant H may convey a wish to use the projector 30 using a touch input on the in-vehicle monitor 7 or the operation switch 25.

When it is determined that the occupant H wishes to use the projector 30 (step S404: Yes), the ECU 40 starts the use of the projector 30 and causes the projector 30 to project the video onto the screen in a theater mode (step S405: video start step).

When the occupant H does not wish to use the projector 30 (step S404: No), the process ends without doing anything.

By setting the state of the vehicle seat S to the relaxation mode, the video projection is automatically started, so that the effort to operate the projector 30 is saved and the usability of the projector 30 is improved.

Incidentally, the control process shown in FIG. 7 has been described for the case where the state of the vehicle seat S is changed by the reclining mechanism 15; however, the present invention is not limited to using the reclining mechanism 15, and may also be applied to a case where the state of the vehicle seat S is changed by the other seat state changing mechanism 14, namely, the tilt mechanism 16, the seat slide mechanism 20, or the seat rotation mechanism 24. For example, when the vehicle seat S is rotated to face rearward by the seat rotation mechanism 24, it may be determined that the vehicle seat S is in the relaxation mode, and the occupant H may be prompted to use the projector 30.

In addition, the projection surface on which the projector 30 displays a video may be configured to be automatically optimized according to the seat state changed by the seat state changing unit.

For example, the position of the projection surface or the angle of the projection surface may be changed according to the angle of the vehicle seat S, namely, the rearward tilt angle α of the seat back 10, the inclination angle of the seat cushion 11, the rotation amount of the vehicle seat, or the like.

In addition, the position or size of the projection surface may be controlled according to the position of the vehicle seat S. Namely, when the occupant H is seated in the front seat S1, a front window is used as the projection surface, and when the occupant H is seated in the rear seat S2, a back surface of the front seat S1 is used as the projection surface.

In addition, the audio to be generated may be controlled according to the position of the vehicle seat S. For example, both video and audio are restricted not to be heard at a driver's seat. Only audio is restricted and only video is displayed at a front passenger's seat. Control may be performed to stream both video and audio at rear seats.

In addition, when the vehicle seat S is rotated by the seat rotation mechanism 24 by a predetermined value or more (for example, from 90 degrees to 180 degrees or more), the operating projector 30 may be changed.

For example, when the front passenger's seat is rotated 180 degrees, switching is performed such that the projector 30 facing the front of the vehicle V is stopped and the projector 30 which projects a video toward the rear of the vehicle V starts projecting. At this time, when the projector 30 that projects a video is switched, a predetermined lap time may be set such that the video is not interrupted.

### <Operation of Projector 30>

In the display system 1, the projector 30 can be operated by the operation switch 25 provided on the vehicle seat S; however, means for operating the projector 30 is not limited thereto.

The projector 30 may be operable using the mobile terminal or the like of the occupant H. By connecting the mobile terminal or the like and the projector 30 by wire or wirelessly, the occupant H is allowed to operate the projector 30 using the mobile terminal at hand.

In addition, by detecting the movement of the occupant H using the in-vehicle camera 6, the projector 30 may be operated through a gesture of the occupant. Specifically, the ECU 40 analyzes the movement of the occupant H based on a video captured by the in-vehicle camera 6, to determine whether or not the movement coincides with a predetermined operation, and executes an operation corresponding to the case of coincidence on the projector 30.

<Video Projection onto Roof 3>

In the display system 1 shown in FIG. 1, the projector 30 projects a video onto the back surface of the seat back 10 of the front seat S1, which is a front seat, as the projection surface; however, the projection surface for the video is not limited thereto, and the video may be projected onto another wall surface.

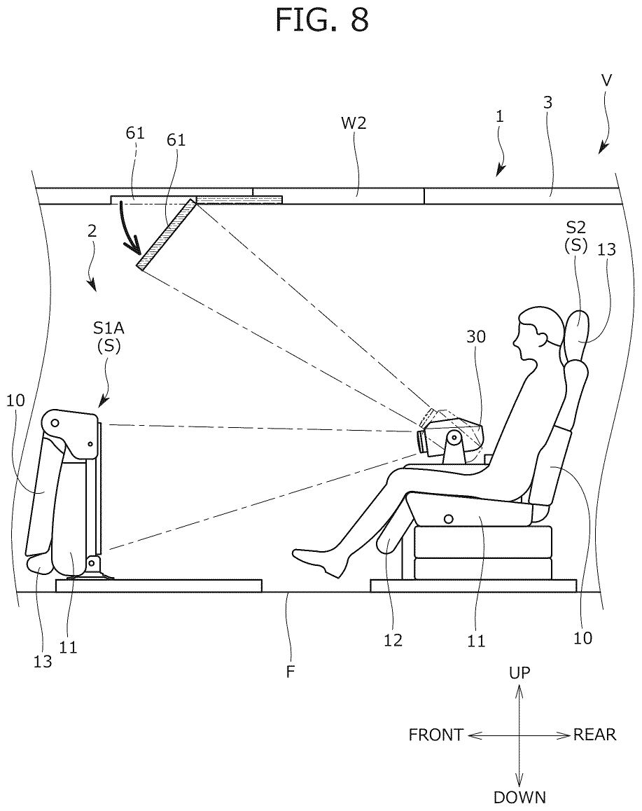

For example, similarly to the projector 30 shown in FIG. 8, a video may be projected onto the roof sunshade 61 provided on the roof window W2. At this time, the roof sunshade 61 may be configured to be inclined during projection such that the video is easy for the occupant H to see.

In addition, instead of the roof sunshade 61, the video may be projected onto a roll screen provided on the roof 3. When the video is projected and watched on the roll screen, the vehicle seat S may be in a flat state.

When the vehicle seat S is in a flat state, the occupant H watches the video on the roof in a state where the occupant H lies down with the head facing the front side of the vehicle; however, at this time, the direction of the head of the occupant H may be detected by the in-vehicle camera 6, and the position or direction of the projected video may be automatically changed in accordance with the direction of the head of the occupant H.

<Video Projection onto Tandem Seat>

FIG. 8 shows another example of the projection destination of the projector 30. A front seat SIA of the vehicle V shown in FIG. 8 is a seat that can be arranged in tandem. Namely, in the front seat SIA, the seat back 10 can be folded toward the front of the seat, and the seat itself can flip up toward the front side.

Furthermore, the video of the projector 30 can be projected onto the back surface of the seat cushion 11 of the front seat SIA arranged in tandem. Since the distance from the projector 30 to the screen can be secured compared to the video projection destination shown in FIG. 1, a larger video can be displayed.

<Video Projection onto Tailgate 65>

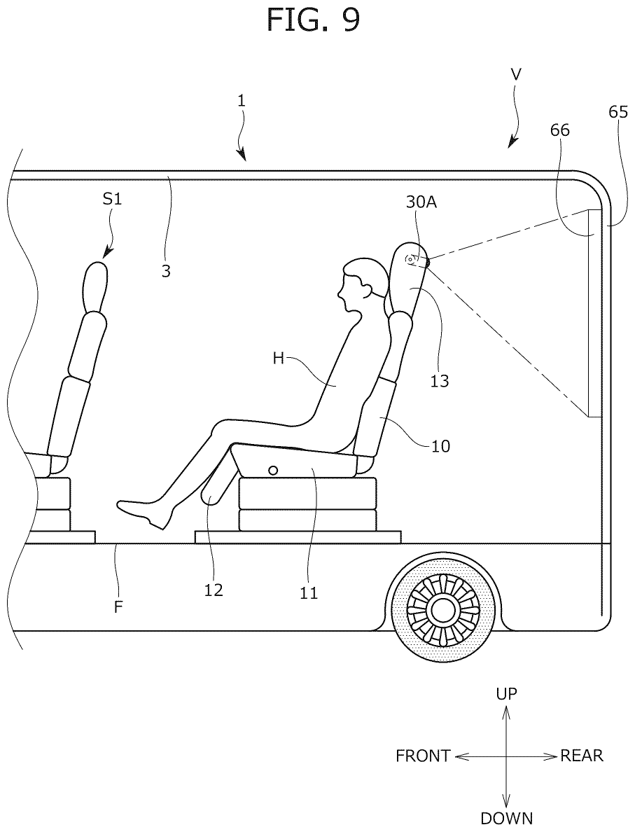

FIG. 9 shows further another example of the projection destination of the projector 30. A projector 30A shown in FIG. 9 is provided on the headrest 13. A video can be projected toward the tailgate 65 of the vehicle V by turning the projection direction of the projector 30C rearward. The rear seat S2 shown in FIG. 9 faces forward; however, the rear seat S2 may be rotated to face the rear side of the vehicle V using the seat rotation mechanism 24. At this time, the projection direction of the projector 30 may be automatically changed in accordance with the direction of the rear seat S2. In addition, the height of the projector 30C may be adjusted by allowing the headrest 13 to move upward and downward. In addition, the projector 30 may be stored in the headrest 13.

A roll screen may be provided as a screen 66 at an upper portion or a side portion of the tailgate 65, and the video of the projector 30A may be projected onto the extended roll screen.

In addition, the following vehicles can be notified of information by projecting a video from the inside toward the outside onto a window of the tailgate.

Examples of the information notified to the following vehicles include “a child is in the vehicle” and “there is a sudden change in physical condition”. In addition, advertisements that reflect the preferences of the drivers of the following vehicles may be displayed. When the projector 30A is connected to a network via communication or the like, individual advertisements may be displayed via the network.

### <Disposition of Screen>

The screen 66 provided in the vehicle interior may be an electronic shade made of glass that becomes opaque when energized. Since the screen 66 can be made opaque only during projection, the screen 66 does not obstruct visibility when a video is not projected.

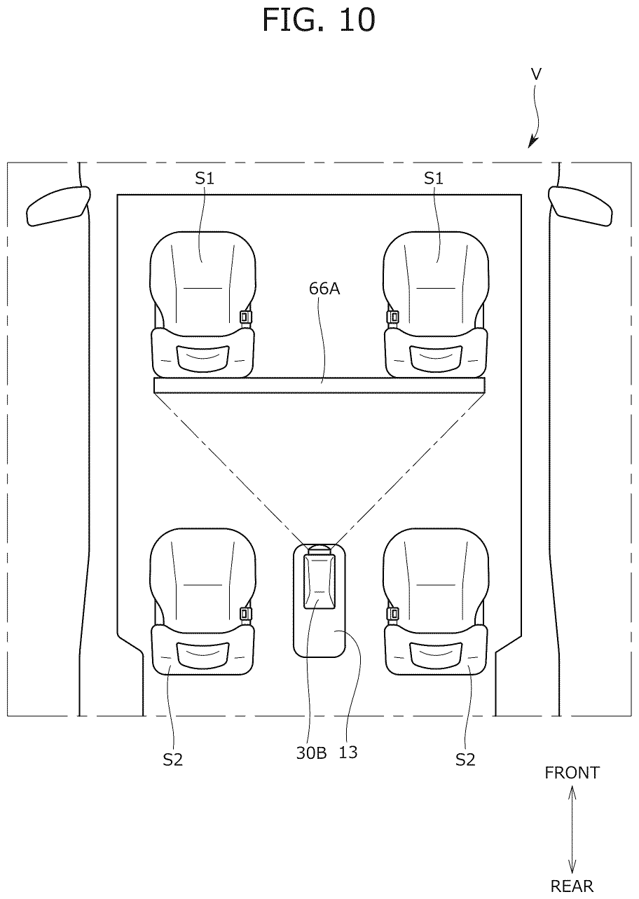

In addition, as shown in FIG. 10, a screen 66A may be disposed to bridge between the front seats S1 disposed on the right and left sides. A video of a projector 30B can be projected over a larger area.

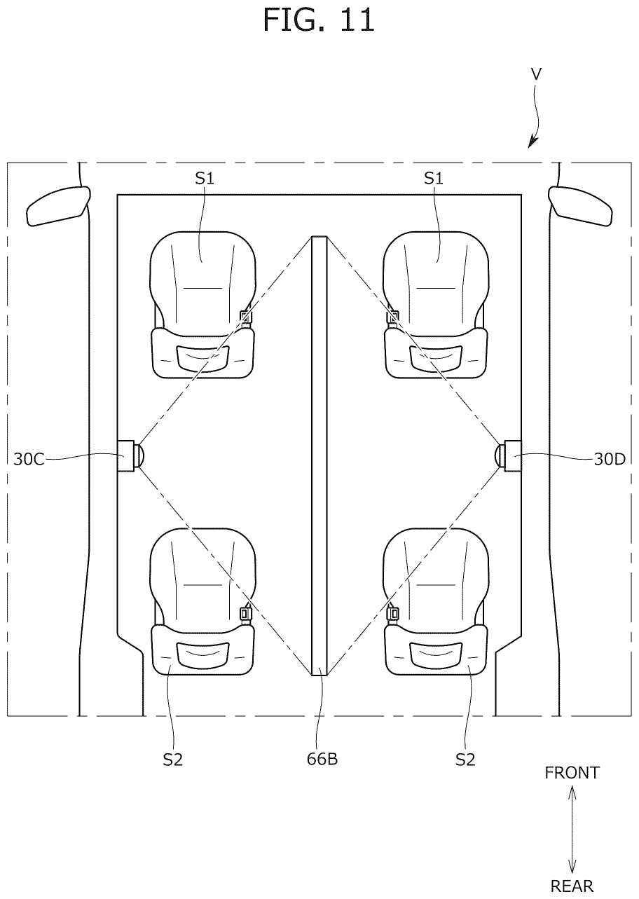

In addition, as shown in FIG. 11, a screen 66B may be disposed between the left seats and the right seats to bridge between the front seats S1 and the rear seats S2 disposed in the front and rear. In this case, projectors 30C and 30D are installed on respective right and left side surfaces (including doors) of the vehicle, and project videos onto a surface and a back surface of the screen 66B, respectively. The videos projected by the projector 30C and the projector 30D may be the same video or may be different videos.

<Cooperation with Occupant H>

In the vehicle seat S, the state (level of wakefulness, physical condition, or the like) of the occupant H may be measured by biosensors mounted in the seat back 10 and the seat cushion 11, and the projector 30 may be controlled according to the measured state.

For example, when the level of wakefulness of the occupant H is a predetermined value or less (for example, when the occupant H feels sleepy), the operation of the projector 30 is restricted. For example, the sound volume is lowered or the projection of the video is stopped.

In addition, when the occupant is in rest (rest mode is selected), the projection is interrupted or the video is changed to a video that can reduce eye strain.

In addition, when the vibration or gravitational acceleration of the vehicle body is larger than a predetermined value, the projection may be restricted or prohibited.

### <Disposition and Storage of Projector 30>

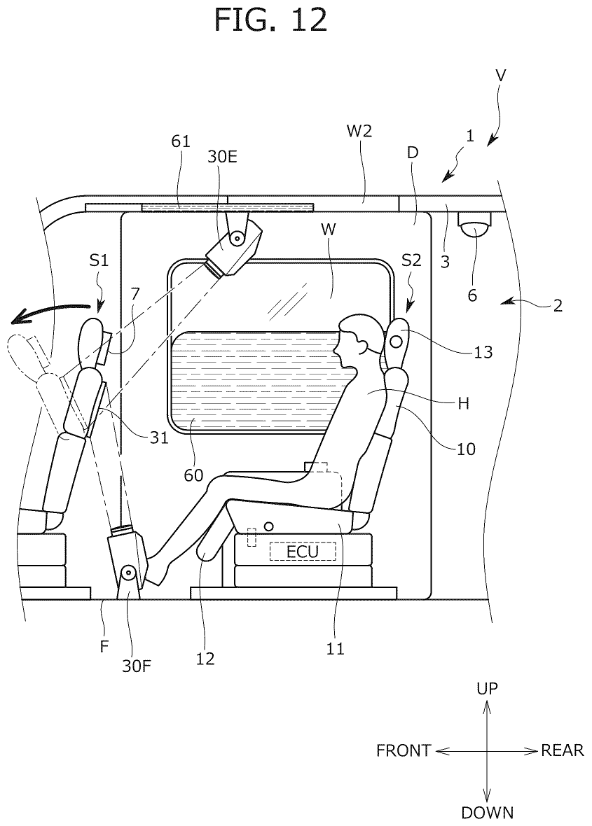

In the vehicle V shown in FIG. 1, the projector 30 is disposed on the center console 5; however, the position of the projector 30 is not limited thereto, and similarly to a projector 30E shown in FIG. 12, the projector may be provided on the roof 3. In this case, the projector 30E may be movable forward and rearward. For example, rails are provided on the roof 3, and the projector 30E is slid forward and rearward.

The projector 30 may be configured to move forward and rearward in conjunction with the forward and rearward movement of the vehicle seat S. In addition, after a predetermined time has elapsed after the movement of the vehicle seat S, the projector 30 may be moved.

In addition, when the back surface of the seat back 10 of the front seat S1 is a projection surface for the projector 30, the visibility of the video may be improved by changing the rearward tilt angle α of the seat back (for example, tilting the seat back forward).

In addition, similarly to a projector 30F shown in FIG. 12, the projector may be disposed on the floor F.

In addition, the projector 30 attached to the roof 3 may be stored in the roof 3. In addition, the projector 30 attached to the floor F may be stored in the floor F.

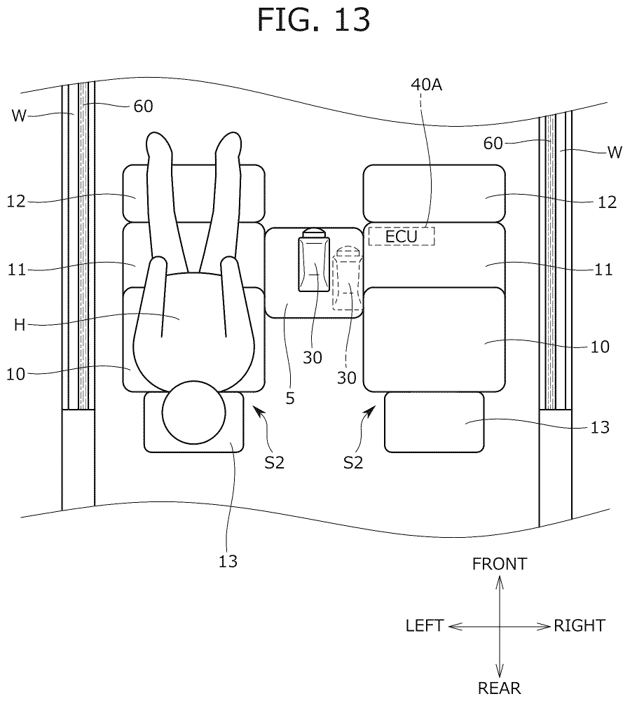

The projector 30 disposed on the center console 5 may be stored in the center console 5 as shown by a dotted line in FIG. 13. At this time, the projector 30 may be stored on a side close to the ECU 40 provided inside the seat.

### <Control Based on Charge State>

In a case where the vehicle V is an electric vehicle V (EV vehicle), when the charge state of the vehicle V is a predetermined value or less, the operation of the projector 30 may be restricted. For example, when the charge state of the vehicle V is the predetermined value or less, the operation time is shortened or the operation is prohibited. When the charge state (battery state) of the vehicle is a first predetermined value or less (for example, the remaining charge amount is 20% or less), the operable time of the projector 30 is set within a predetermined time (for example, within 10 minutes)

In addition, when the charge state is equal to or less than a second predetermined value smaller than the first predetermined value (for example, the remaining charge amount is 10% or less), the operation of the projector is restricted, for example, the operation is entirely prohibited or prohibited except for alarm.

### <Other Controls>

The operation states of the plurality of projectors may be controlled based on the driving state or the number of passengers.

In addition, when an abnormality in the vehicle V is detected, the operation of the projectors 30 may be restricted or prohibited. For example, when an abnormality in the battery, an abnormality in the vehicle seat S, an abnormality in the projector, or an abnormality in the projection surface is detected, the operation of the projector and the projection surface is restricted or prohibited.

In addition, even when an abnormality in the occupant is detected by the biosensors or the like, the operation of the projector 30 and the projection surface may be restricted or prohibited.

In the embodiment, as a specific example, the display system 1 used in the vehicle V has been described; however, the present invention is not particularly limited, and the display system of the present application can be provided in electric trains, buses, and the like, and can also be used in airplanes, ships, and the like.

### Second Embodiment

Hereinafter, a configuration of a conveyance seat and an interior member according to a second embodiment of the present invention will be described with reference to the However, the embodiment and examples to be drawings. described below example for facilitating are one understanding of the present invention, and do not limit the present invention. Namely, the present invention can be modified or improved without departing from the concept of the present invention, and it goes without saying that the present invention includes equivalents thereof.

Incidentally, hereinafter, a vehicle seat mounted in a vehicle will be provided as one example of the conveyance seat, and a configuration example of the vehicle seat will be described. However, the present invention is not limited to vehicle seats mounted in ground traveling conveyances including wheels such as an automobile and a train, and is also applicable to, for example, seats mounted in an aircraft, a ship, and the like moving in places other than the ground.

In addition, in the following description, a “front to rear direction” is a front to rear direction of the vehicle seat, and is a direction that coincides with an advancing direction when the vehicle travels. In addition, a “seat width direction” is a lateral width direction of the vehicle seat (in other words, a width direction of a seat body), and is a direction that coincides with a right to left direction when viewed from an occupant seated in the vehicle seat. In addition, an “up to down direction” is an up to down direction of the vehicle seat, and is a direction that coincides with a vertical direction when the vehicle travels on a horizontal surface.

In addition, a “vehicle outer side” or a “window side” in the seat width direction refer to a side closer to the outside of a vehicle body (for easy understanding, a side close to a nearest door or window), and a “vehicle inner side” or an “interior side” refers to a side closer to the inside of the vehicle body (for easy understanding, a side separated from a nearest door).

Incidentally, unless otherwise specified, the shape, position, posture, and the like of each part of the vehicle seat to be described below will be described assuming that the vehicle seat is in a seated state.

### First Example

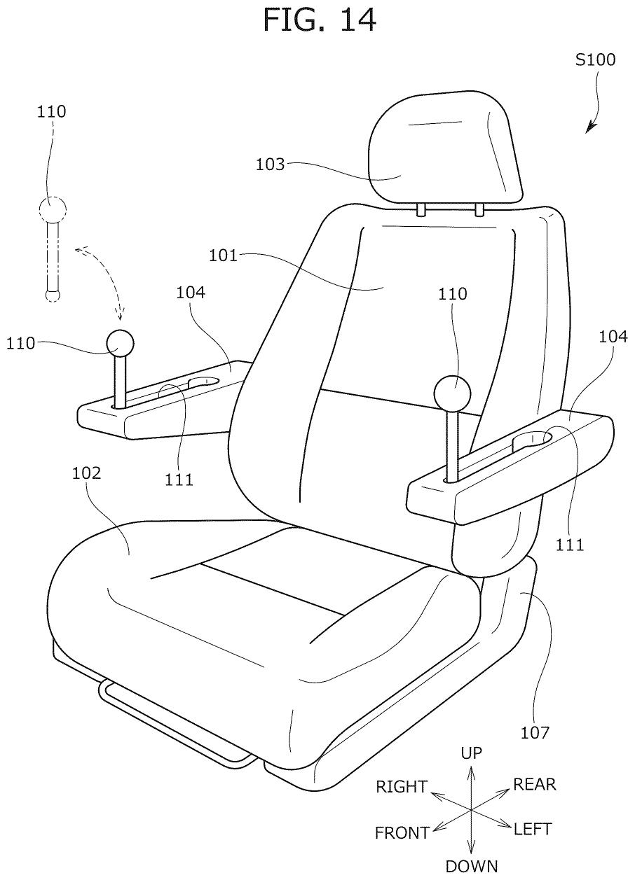

FIG. 14 is a perspective view showing a vehicle seat S100 according to a first example of the second embodiment. The vehicle seat S100 is a seat which is disposed on a vehicle body floor that defines a bottom portion of a passenger compartment and in which the occupant of the vehicle is seated. The vehicle seat S100 is used as a front seat corresponding to a front seat of the vehicle, but is not limited thereto, and can be used as a seat of rear seats.

As shown in FIG. 14, the vehicle seat S100 includes a seat back 101, a seat cushion 102, and a headrest 103. The seat back 101 is a backrest portion that supports the back of a seated occupant. The seat cushion 102 is a seating portion that supports the buttocks of the seated occupant. The headrest 103 is a portion that supports the head of the occupant.

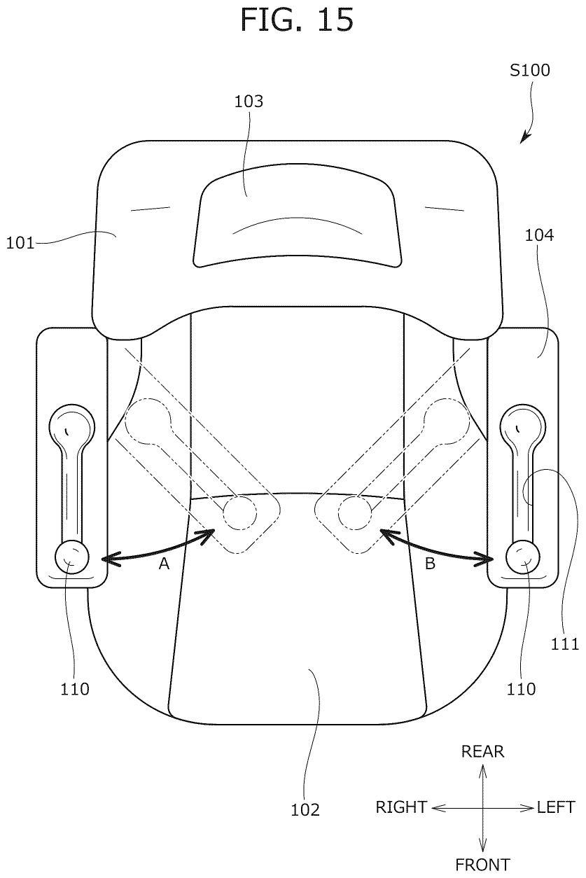

Further, armrests 104 are provided at both side portions of the seat back 101. The armrests 104 are portions that support the arms of the seated occupant, and extend forward from both the side portions of the seat back 101. In addition, the armrests 104 are attached to the seat back 101 so as to be rotatable about the seat width direction (right to left direction) as an axis, and can be rotated in the up to down direction and stored as needed. Incidentally, as will be described later, the armrests 104 and the seat back 101 are connected by hinges (not shown), and can also be rotated about the up to down direction as an axis (refer to FIG. 15). For that reason, the tips of the armrests 104 can also be moved to be pulled inward of the seat.

In addition, a reclining mechanism 107 that supports the seat back 101 so as to be adjustable in angle with respect to the seat cushion 102 is provided. The seat back 101 is rotatably attached to the seat cushion 102 by the reclining mechanism 107 so as to be tilted in the front to rear direction.

A seat back frame serving as a skeleton of the seat back 101 is provided inside the seat back 101 (not shown). In addition, a seat cushion frame serving as a skeleton of the seat cushion 102 is also provided inside the seat cushion 102 (not shown). A pad and a cushion trim cover (cushion cover) are provided around each of the seat cushion frame and the seat back frame. The pad is, for example, a urethane base material molded by foam molding using a urethane foam material, and the cushion trim cover is made of, for example, a skin material such as cloth, synthetic leather, or genuine leather.

### <Operation Lever>

The vehicle seat S100 includes an operation lever 110 at a tip portion of each of the armrests 104. The operation lever 110 is connected to an ECU for operating the vehicle, and the seated occupant can perform the steering of the vehicle body, an accelerator operation, and a brake operation using the operation lever 110.

The operation lever 110 can be tilted forward and rearward and rightward and leftward. For example, the operation lever 110 is configured such that when the occupant tilts the operation lever 110 forward, the vehicle body moves forward, namely, the vehicle travels forward. At this time, the speed can be changed by changing the tilt angle of the operation lever 110, and for example, by greatly tilting the operation lever 110 forward, the forward speed can be increased, and the vehicle can travel faster. On the other hand, the vehicle can be moved rearward by tilting the operation lever 110 rearward. The reverse speed can be increased by greatly tilting the operation lever 110 rearward.

In addition, the occupant can turn the advancing direction of the vehicle rightward and leftward by tilting the operation lever 110 rightward and leftward. In addition, the vehicle can also be operated by other methods.

When the vehicle is provided with a steering wheel (not shown), the configuration is such that one of an operation using the operation lever 110 and an operation using the steering wheel takes priority over the other. An operation method taking priority may be determined by setting alone; however, which operation method is available may be made clear by storing one of the steering wheel and the operation lever 110.

For example, when the operation lever 110 is used, the steering wheel is stored in an instrument panel, so that the vehicle body can be operated using only the operation lever 110. By storing the steering wheel, it is made clear that the steering wheel and the operation lever 110 cannot be used at the same time, and when the operation lever 110 is in use, an erroneous operation by the steering wheel can be suppressed.

In the normal case of using the steering wheel, the operation lever 110 may be stored in a lever storage portion 111 formed in the armrest 104. The occupant sets the operation lever 110 to be operable by causing the operation lever 110 to stand up from the lever storage portion 111 of the armrest 104 according to the state of the vehicle seat. For example, when the vehicle seat S100 is moved to a rearmost position within a slidable range, and the hands of the seated occupant cannot reach the steering wheel, the operation is switched to using the operation lever 110. At this time, the operation lever 110 may automatically stand up to become operable. In addition, the seated occupant may manually raise the operation lever 110, thereby enabling the operation using the operation lever 110.

The switching from the operation using the steering wheel to the operation using the operation lever 110 may be performed when the vehicle seat S100 is rotated to make the seated occupant face rearward. Since the vehicle seat S100 is rotated, the hands of the seated occupant cannot reach the steering wheel. Instead, the operation using the operation lever 110 is enabled.

In addition, when the seat back 101 of the vehicle seat S100 is greatly tilted toward the rear of the seat, the operation may be switched to using the operation lever 110. Since the hands of the seated occupant cannot reach the steering wheel due to the seat back 101 being tilted, it is convenient if the vehicle can be operated by switching to using the operation lever 110.

In addition, when an emergency situation occurs and the vehicle stops, the operation using the operation lever 110 may be enabled. Particularly, in a situation where the steering wheel is inoperable due to an accident, when the operation is switched to using the operation lever 110, the vehicle may be movable.

In addition, when a danger is detected by a sensor mounted in the vehicle and an emergency manual operation is required, the operation using the operation lever 110 may be enabled. For example, when a radar or the like detects that a person has jumped out in front of the vehicle, the person can be avoided by operating the vehicle using the operation lever 110.

In addition, the operation lever 110 may come out as a backup steering wheel during autonomous driving. By allowing the operation lever 110 to be operated only when an autonomous driving mode is set, for example, the occupant can easily instruct the vehicle about driving direction and the like during autonomous driving.

The operation lever 110 may be provided to be removable from the armrest 104. The removed operation lever 110 may be attached to another seat, an interior component (for example, a door or the instrument panel), or the like. In addition, the vehicle body may be operable in that state. The vehicle body can be operated in appropriate situations by configuring the operation lever 110 to be attachable and detachable.

The operation levers 110 may be provided on both right and left armrests 104, and the operation lever 110 may be provided only on one armrest 104.

The operation lever 110 is also applicable to an automobile without a steering wheel. In this case, during manual driving, the operation lever 110 always stands up and comes out from the armrest 104. Furthermore, when the vehicle enters the autonomous driving mode, the operation lever 110 may be stored in the armrest 104.

In addition, when the vehicle is in a manual driving mode, control may be performed such that the operation lever 110 cannot be stored in the armrest 104. In addition, in the case of the manual driving mode, control may be performed such that the armrest 104 cannot be rotated in the up to down direction and stored. In addition, control may be performed such that the operation lever 110 cannot be removed. During the manual driving mode, by performing such control, the vehicle body becoming inoperable due to an erroneous operation is suppressed.

In addition, the operation lever 110 may be stored in the lever storage portion 111 of the armrest 104 at the same time that the armrest 104 is rotated and stored. By storing the operation lever 110, occupants seated in the rear seats are prevented from being disturbed.

In addition, the armrest 104 may be configured to be extendable and retractable in the front to rear direction. In the case of the autonomous driving mode, the armrest 104 is at a normal length; however, in the case of the manual driving mode, the armrest 104 may extend forward.

Since the operation lever 110 is provided at the tip of the armrest 104 as shown in FIG. 14, the operation lever 110 is located further forward, so that the operation lever 110 is easy to operate.

In addition, as shown in FIG. 15, the armrest 104 may be provided to be rotatable about the up to down direction as an axis. By allowing the armrest 104 to move in the right to left direction (seat width direction), the operation lever 110 can be disposed at a position where the operation lever 110 is easy for the occupant to operate, namely, at a position preferred by the occupant.

In addition, when the vehicle seat S100 is rotated to face rearward, the lever operation of the operation lever 110 may be reversed. For example, when the operation lever 110 is tilted forward, the vehicle is moved rearward. By reversing the lever operation, the occupant is allowed to intuitively operate the vehicle.

In addition, when an abnormality in the vehicle is detected, or when tires slip, control may be performed such that the vehicle body cannot be operated by the operation lever 110. In this case, only the operation using the steering wheel is enabled.

In addition, when a sudden input load is applied to the operation lever 110, the lever operation by the operation lever 110 may be stopped. For example, the lever operation is controlled by monitoring the operation lever 110 using an in-vehicle camera and by determining whether the load applied to the operation lever 110 is due to an operation related to driving or due to an erroneous operation. For example, when the arm simply hits the operation lever 110, the operation lever 110 is not operated, and an erroneous operation is suppressed by determining whether or not an input is intended by the seated occupant.

In addition, whether the seated occupant is a child or an adult is identified in conjunction with a seating sensor, and when the seated occupant is a child, control may be performed such that the operation lever 110 does not operate.

### Second Example

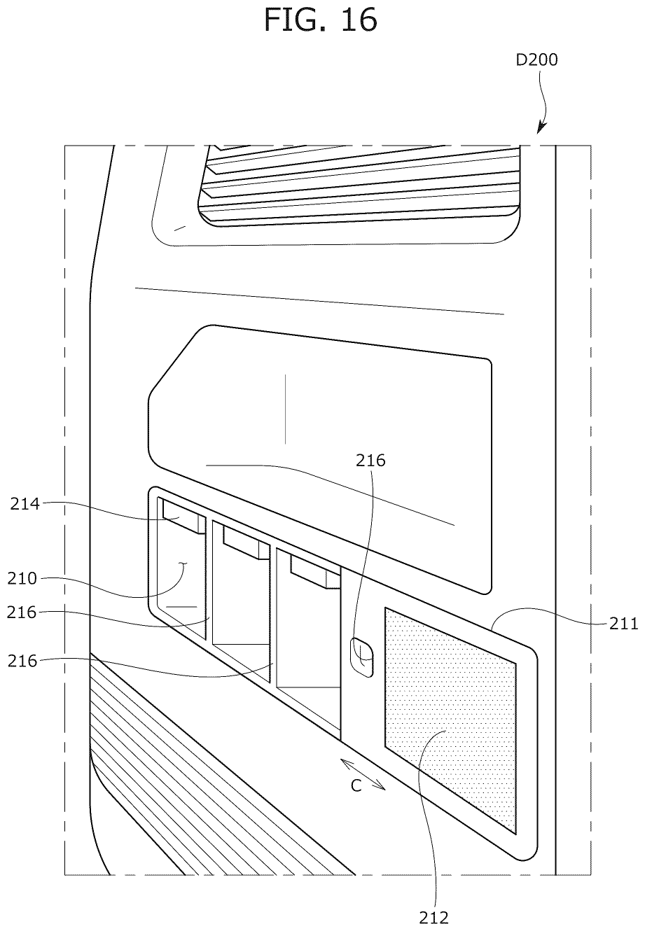

Next, a second example of the second embodiment will be described using FIG. 16. FIG. 16 is a view of a vehicle door D200 according to the second example when viewed from the interior side, and shows a storage portion 210 provided in the vehicle door D200.

In an autonomously drivable vehicle, a vehicle seat may be rotated to face rearward. For that reason, as shown in FIG. 14, even when the vehicle seat faces any direction, in order to support the arms of the seated occupant, armrests may be provided at side portions of the vehicle seat. In this case, since an armrest is not provided on a vehicle door, in the related art, it has been desired to effectively utilize a portion at which the armrest is provided.

The vehicle door D200 that is the second example is not provided with an armrest, but instead is provided with the storage portion 210 including a lid portion 211. The storage portion 210 is provided as a recess in a side portion on the interior side of the vehicle door D200, and can store a bag, a smartphone, or the like of the occupant.

The storage portion 210 is provided with the lid portion 211 that closes an opening of the storage portion 210. The lid portion 211 can close an opening portion of the storage portion 210 by sliding in the direction of two-way arrow C in FIG. 16. As a movable mechanism of the lid portion 211, in addition to a sliding structure, a bellows-type extendable and retractable structure, a roller screen-type extendable and retractable structure, and a folding-type extendable and retractable structure can be used. The lid portion 211 is not limited to these structures, and may be opened and closed by other movable mechanisms.

In addition, by configuring the lid portion 211 to be slidable through motor drive, the lid portion 211 may be structured to be automatically openable and closable through a touch operation of the occupant.

In addition, a handhold portion 216 for manually opening and closing the lid portion 211 is provided on an outer surface (surface on the interior side) of the lid portion 211. In addition, a display 212 may be provided on the outer surface of the lid portion 211. For example, whether or not luggage is stored in the storage portion 210 is displayed on the display 212.

The storage portion 210 may be detachably attached to the vehicle door D200. For example, the storage portion 210 can be completely washed by removing the storage portion 210.

In addition, an infrared sensor 214 may be provided inside the storage portion 210, the presence or absence of an article inside the storage portion 210 may be detected by the infrared sensor 214, and the occupant may be notified of the presence or absence of the item. Light, sound, voice, vibration, or the like is used for notification. The display 212 provided on the lid portion 211 may be used for notification. In addition, the presence or absence of an article may be notified to a communication device such as the smartphone owned by the occupant. Luggage being left behind can be suppressed by enabling a notification. In order to detect the presence or absence of an article, a pressure sensor may be provided instead of the infrared sensor 214.

In addition, the vehicle door D100 may be provided with a sensor that detects the open/closed state of the lid portion 211. The open/closed state of the lid portion 211 is detected by the sensor, and in a state where the lid portion 211 is opened, the vehicle door D200 is controlled not to open. When the vehicle door D200 is a sliding type, the vehicle door D200 is controlled not to move in a sliding manner. This control suppresses interference between the lid portion 211 and the vehicle when the vehicle door D200 slides. Incidentally, the vehicle door D200 may be operated manually or electrically.

A partition plate 215 is provided inside the storage portion 210. The partition plate 215 serves as a side collision protector functioning as a side collision countermeasure, and can protect luggage in the storage portion 210.

### Third Example

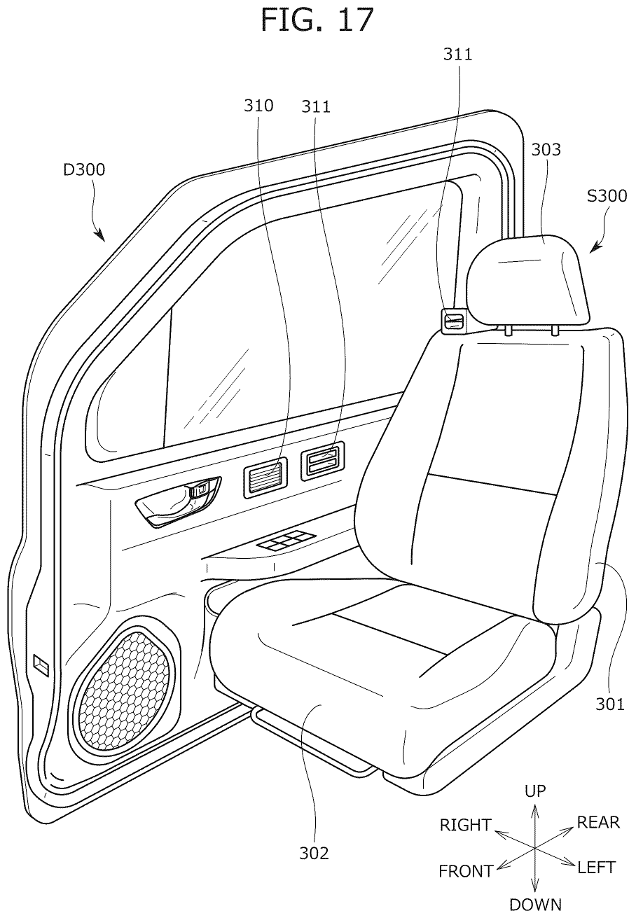

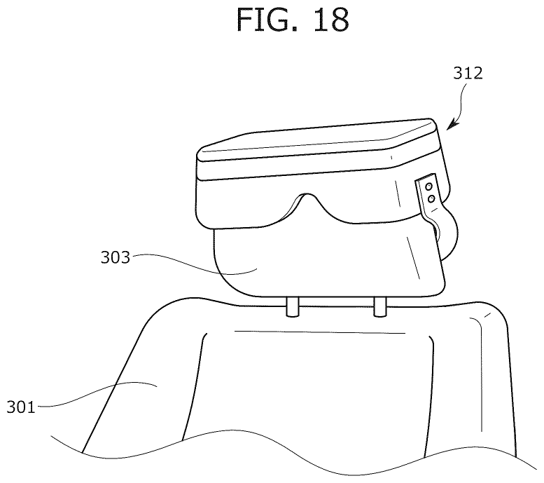

Next, a vehicle door D300 that is a third example of the second embodiment will be described using FIGS. 17 and 18. In recent years, people have come to enjoy music or video while on the move, and there has been a growing demand for improved entertainment experience in a vehicle interior space.

As shown in FIG. 17, the vehicle door D300 of the third example is provided with an air outlet 310 and a moisture outlet 311.

The air outlet 310 and the moisture outlet 311 are connected to a pump (not shown) provided in the vehicle interior. The pump is controlled by an ECU in the vehicle interior, and is configured to spray air and moisture toward the occupant from the air outlet 310 and the moisture outlet 311 in time with video or music streamed in the vehicle interior.

The air outlet 310 and the moisture outlet 311 are provided above an armrest of the vehicle door D300, but may be provided therebelow. In addition, although not shown, the air outlet 310 and the moisture outlet 311 may be provided on an instrument panel, a pillar, a roof, or a floor in addition to the vehicle door D300.

By spraying air or moisture in time with video or music, an occupant is allowed to enjoy the video or music even more, and the entertainment experience in the vehicle interior space is improved.

As shown in FIG. 17, the air outlet 310 and the moisture outlet 311 may be provided on a vehicle seat S300. The vehicle seat S300 includes a seat back 301, a seat cushion 302, and a headrest 303. The seat back 301 is a backrest portion that supports the back of a seated occupant. The seat cushion 302 is a seating portion that supports the buttocks of the seated occupant. The headrest 303 is a portion that supports the head of the occupant.

The air outlet 310 and the moisture outlet 311 are provided at a shoulder of the seat back 301, and this disposition is one example, and the air outlet 310 and the moisture outlet 311 may be provided at a bank portion of the seat cushion 302 or the headrest 303.

The air outlet 310 and the moisture outlet 311 may operate in conjunction with a seating sensor of the vehicle seat S200, and may be controlled to blow out air or moisture when it is detected that the occupant is seated.

In addition, a biosensor may be provided in the vehicle seat S300 to measure the heartbeat, pulse, or the like of the occupant, and the air outlet 310 and the moisture outlet 311 may be operated in accordance with the mental state of the occupant. For example, when the degree of fear felt by the occupant is at its maximum, air may be blown out toward the occupant. The degree of fear felt by the occupant is estimated, for example, from the heart rate acquired by the biosensor.

In addition, by controlling an air blowing device or a moisture blowing device provided in each door of the vehicle, the air blowing devices or the moisture blowing devices may be operated synchronously for a plurality of seated occupants inside the vehicle. In this case, the plurality of occupants may be allowed to have the same experience by controlling the air blowing devices and the moisture blowing devices of each vehicle not only in a single vehicle but also in a plurality of vehicles connected via communication.

A video may be displayed on a screen in the vehicle interior by a projector provided in the vehicle interior. In addition, a video may be displayed on a liquid crystal monitor in the vehicle interior. In addition, the occupant may wear a virtual reality (VR) goggle 312 and watch a video. As shown in FIG. 18, the VR goggle 312 may be detachably attached to the headrest 303. The headrest 303 is provided with a connector for charging the VR goggle 312, and the VR goggle 312 can be charged by being connected to the connector. Wireless electric power supply may be used to supply electric power to the VR goggle 312. In the case of using the wireless electric power supply, for example, the headrest 303 is provided with a power transmitter, and the VR goggle 312 is provided with a power receiver.

As shown in FIG. 18, when not in use, the VR goggle 312 can be attached to an upper portion of the headrest 303. The VR goggle 312 may be configured to be attached not only to the upper portion of the headrest 303 but also to a side portion, a rear portion, a lower portion, or the like. In addition, a storage recess for storing the VR goggle 312 inside the headrest 303 may be formed, and when not in use, the VR goggle 312 may be stored in the storage recess. In addition, a lid portion that closes an opening portion of the storage recess may be provided.

In addition, a 3D hologram video of persons watching a video or the like may be projected in the air from the vehicle seat S300 to create an atmosphere of enjoying the video together.

In addition, as a method for utilizing VR/AR videos and hologram videos, map information and tourist information may be displayed in the vehicle interior space. At this time, information or video of a destination may be displayed in real time.

### Fourth Example

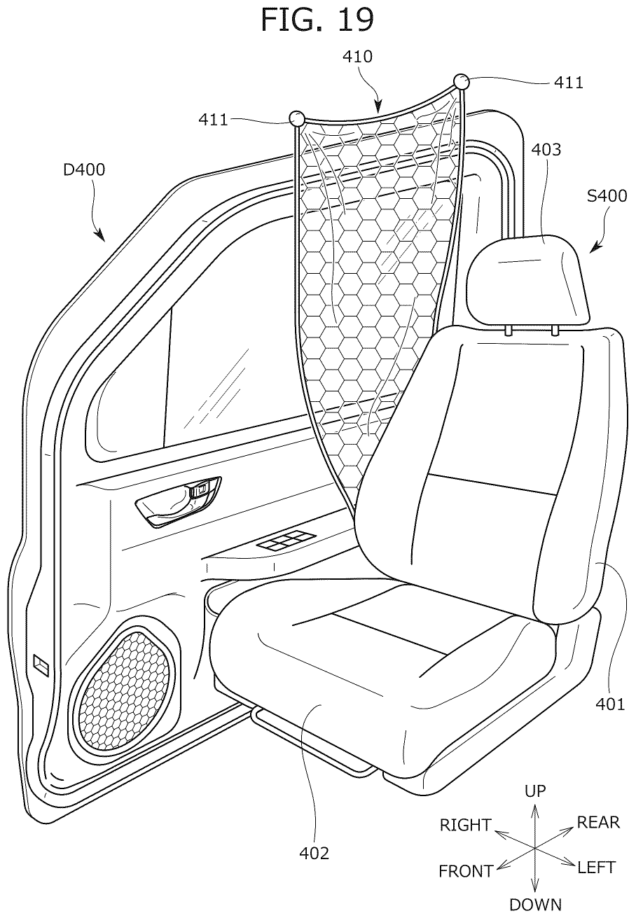

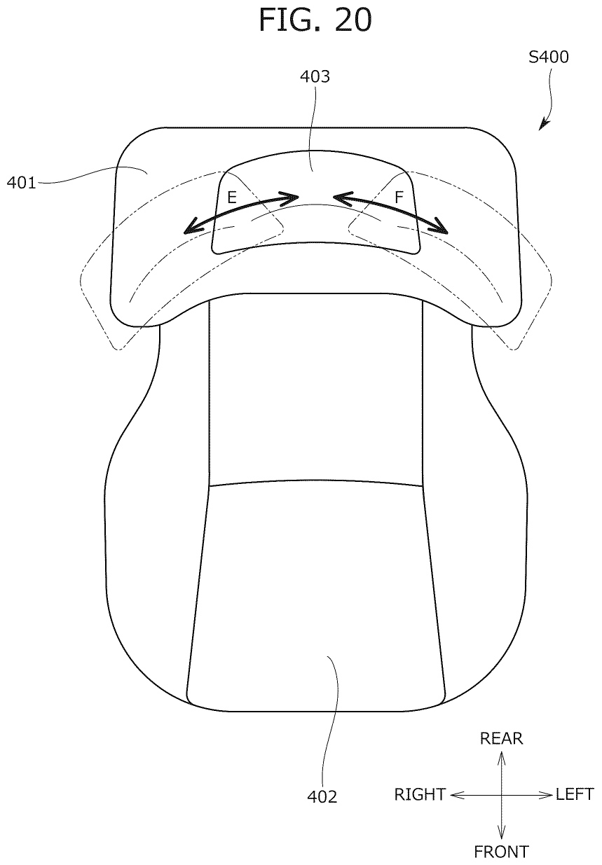

Next, a vehicle seat S400 that is a fourth example of the second embodiment will be described using FIGS. 19 and 20. During a drive, an occupant seated in a front passenger's seat or a rear seat may sleep while seated in the vehicle seat; however, it is difficult for a headrest of the related art to support the head of the occupant in a relaxed state or a sleeping state. In addition, in recent years, there has been a demand for the function of supporting the head or the like of an occupant in a relaxed state or a sleeping state in a driver's seat or the like due to autonomous driving or the like.

A vehicle seat S400 that is the fourth example is configured such that a support member 410 comes out from a side portion of the vehicle seat S400 and the support member 410 is fixed to an inside of the vehicle body. Specifically, as shown in FIG. 19, the support member 410 that is a net can be fixed to a side portion of a seat back 401 and an inner wall portion above the door D400 and can be attached to span therebetween. The seated occupant can enter a relaxed state or a sleeping state by leaning on the spanning support member 410.

The support member 410 may be stored inside the vehicle seat S400. In addition, the support member 410 may be attached to an outer surface of the vehicle seat S400. In addition, the support member 410 may be detachably attached to the vehicle seat S400. In addition, the portion to which the support member 410 is attached may be not only a side portion of the vehicle seat S400 but also a rear portion or an upper portion of the vehicle seat S400.

The support member 410 is not limited to the net-shaped member as shown in FIG. 19, and may be a cloth-shaped member or a bag-shaped member.

In addition, fixing portions 411 for fixing the support member 410 may be provided on a pillar or a frame of the door in addition to the inner wall portion above the door D400. In addition, the fixing portions 411 may be composed of hook-shaped engaging members.

In addition, as shown in FIG. 20, the support of the head of the seated occupant may be enabled by turning a headrest 403 as indicated by two-way arrows E and F in the figure. The movement of the headrest 403 may be manually performed, or the headrest 403 may be configured to move automatically.

In addition, the portion that supports the seated occupant is not limited to the headrest 403, and bank portions of the seat back 401 or a seat cushion 402 move inward to sandwich the seated occupant therebetween. In addition, the bank portions may move upward in a sliding manner and support the head of the seated occupant instead of the headrest 403.

In addition, a sensor may be provided in the vehicle seat S400 to acquire biological information such as the heartbeat or pulse of the seated occupant, and when it is determined that the seated occupant is in a sleeping state, the seat belt may be automatically tightened to support the seated occupant. By supporting the seated occupant in a sleeping state more strongly, the movement of the seated occupant when a load is suddenly applied can be suppressed.

In addition, the support member 410 and the headrest 403 may have a vibration function. When the vehicle arrives at the destination, the support member 410 or the headrest 403 can vibrate to wake up the seated occupant in a sleeping state who leans thereon.

### Third Embodiment

A third embodiment relates to a vehicle member, particularly to a vehicle member including a thermoelectric power generation member.

### BACKGROUND ART

In the related art, a thermoelectric power generation element that converts thermal energy into electrical energy by converting a temperature difference between both ends of the element into electricity or that converts electrical energy into thermal energy by causing a temperature difference between both ends of the element through allowing electricity to flow to the element has been known. Such a thermoelectric power generation element is used in cooling devices, small-scale heating devices, small-scale power generation devices, and the like.

For example, in JP 2017-050958 A, a vehicle seat including a thermoelectric conversion fabric including a Peltier element is proposed as a thermoelectric power generation member.

### Technical Problem

In JP 2017-050958 A, by conforming the thermoelectric conversion fabric to the shape of a heat source or an object that is to be adjusted in temperature, the vehicle seat that makes good heat transfer possible and that has excellent thermoelectric conversion, temperature adjustment efficiency, and responsiveness is obtained.

However, since such a thermoelectric conversion fabric has an integral configuration in which the skin itself generates electric power, the thermoelectric conversion fabric lacks versatility and has a high manufacturing cost, which is a risk.

In addition, not only vehicle seats but also various components such as a vehicle door lining are provided inside a vehicle, and in order to drive a plurality of devices mounted in these components, it has been required to efficiently generate electric power using heat received by the vehicle components.

The present invention has been made in view of the above-described problems, and an object of the present invention is to provide a vehicle member including a thermoelectric power generation member that is highly versatile and that can efficiently generate electric power.

### Solution to Problem

The above-described problems are solved by a vehicle member of the present invention that is disposed inside a vehicle and including: a thermoelectric power generation member that converts heat into electric power. The thermoelectric power generation member is provided at a predetermined portion of the vehicle member, and is configured independently of the predetermined portion.

With the above-described configuration, the vehicle member and the thermoelectric power generation member are provided as separate bodies, so that the versatility of the thermoelectric power generation member can be increased, and the manufacturing costs of vehicle components in the vehicle can be reduced.

In this case, the vehicle member may be a vehicle seat including a seat frame serving as a skeleton, a pad material placed on the seat frame, and a skin material covering the seat frame and the pad material. The vehicle seat may include an electric power storage member connected to the thermoelectric power generation member, and storing the electric power generated by the thermoelectric power generation member, and a connection member for connecting the thermoelectric power generation member and the electric power storage member.

With the above-described configuration, the electric power can be stably supplied by charging the electric power storage member with the the electric power from thermoelectric power generation member. In addition, since the thermoelectric power generation member and the electric power storage member are connected via the connection member, the degree of freedom in the disposition of the thermoelectric power generation member and the electric power storage member can be ensured.

In this case, the pad material may include an accommodation recess formed on a surface on a skin material side of the pad material in a thickness direction, and accommodating the thermoelectric power generation member. The accommodation recess may be formed on the surface on the skin material side of the pad material at a position corresponding to a portion with which the seated occupant comes into contact. The thermoelectric power generation member may be accommodated in the accommodation recess between the pad material and the skin material.

With the above-described configuration, heat of a portion that becomes hot inside the vehicle, particularly a portion of the vehicle seat that receives the body temperature of the occupant can be efficiently used for electric power generation. In addition, since the thermoelectric power generation member is accommodated in the accommodation recess and does not protrude from the surface on the skin material side, deterioration in the seating feeling of the occupant can be suppressed.

In this case, the pad material may have an insertion hole penetrating from the accommodation recess toward a seat frame side in the thickness direction of the pad material. The electric power storage member may be attached to the seat frame. The connection member may extend through the insertion hole and may be connected to the electric power storage member.

With the above-described configuration, since the thermoelectric power generation member and the electric power storage member are connected through the insertion hole provided in the pad material, the length of the connection member can be shortened, and the electric power can be efficiently supplied.

In this case, the vehicle seat may include a drive device driven by the electric power and a control device that is connected to the drive device and that controls the drive of the drive device. The thermoelectric power generation member may be attached in the vicinity of the drive device or the control device.

With the above-described configuration, heat of a portion that becomes hot inside the vehicle, particularly in the vicinity of the drive device or the control device in the vehicle seat can be efficiently used for electric power generation.

In this case, the drive device may be a blower device that is attached to the seat frame and that blows air toward the seated occupant. The thermoelectric power generation member may be attached in the vicinity of a drive member of the blower device.

With the above-described configuration, heat of a portion that becomes hot inside the vehicle, particularly in the vicinity of the drive member of the blower device in the vehicle seat can be efficiently used for electric power generation.

In this case, the vehicle member may be a vehicle door lining provided on a vehicle inner side of a vehicle door. The thermoelectric power generation member may be attached to an upper portion or a side portion on a vehicle outer side of the vehicle door lining.

With the above-described configuration, heat of a portion that becomes hot inside the vehicle, particularly a portion of the vehicle door lining that is likely to receive direct sunlight or is likely to be affected by the outside temperature can be efficiently used for electric power generation.

In this case, the vehicle door lining may include an electric power storage member connected to the thermoelectric power generation member, and storing the electric power generated by the thermoelectric power generation member. The thermoelectric power generation member and the electric power storage member may be attached to the side portion on the vehicle outer side of the vehicle door lining, and may be disposed at positions close to each other.

With the above-described configuration, the electric power can be stably supplied by charging the electric power storage member with the electric power from the thermoelectric power generation member. In addition, by attaching the thermoelectric power generation member to the side portion on the vehicle outer side of the vehicle door lining, the amount of the electric power generated can be increased by a difference between the outside temperature and the inside temperature.

In this case, the vehicle door lining may include a light-emitting member that emits light toward an inside of the vehicle. The thermoelectric power generation member may be attached in the vicinity of the light-emitting member.

With the above-described configuration, heat of a portion that becomes hot inside the vehicle, particularly in the vicinity of the light-emitting member on the vehicle door lining can be efficiently used for electric power generation.

In this case, the vehicle member may include a drive device that is provided inside the vehicle and that is driven by the electric power generated by the thermoelectric power generation member, an electric power storage member connected to the thermoelectric power generation member, and storing the electric power generated by the thermoelectric power generation member, and a control device that is connected to each of the thermoelectric power generation member, the electric power storage member, and the drive device, and that controls the drive of the drive device. The control device may be connected to a power source provided on a vehicle body, may control the power source to supply electric power to the drive device when an amount of the electric power generated by the thermoelectric power generation member is less than a predetermined threshold value or when an amount of the electric power stored by the electric power storage member is less than a predetermined threshold value, may control the thermoelectric power generation member to supply the electric power to the drive device when the amount of the electric power generated by the thermoelectric power generation member is the predetermined threshold value or more, and may control the electric power storage member to supply the electric power to the drive device when the amount of the electric power stored by the electric power storage member is the predetermined threshold value or more.

With the above-described configuration, the electric power can be stably supplied by charging the electric power storage member with the electric power generated by the thermoelectric power generation member. In addition, the electric power consumption can be controlled to an optimal level by performing cooperative control using the power source provided on the vehicle body. In addition, for example, by performing cooperative control with other power generation members such as solar power generation and vibration power generation, when the activities of the other power generation members are weak, the electric power generation by the thermoelectric power generation member can be controlled to supplement the amount of electric power generated.

### Advantageous Effects of Invention

According to the present invention, the versatility of the thermoelectric power generation member can be increased, and the manufacturing costs of the vehicle components can be reduced.

According to the present invention, the electric power can be stably supplied. In addition, the degree of freedom in the disposition of the thermoelectric power generation member and the electric power storage member can be ensured.

According to the present invention, heat of a portion that becomes hot inside the vehicle, particularly a portion of the vehicle seat that receives the body temperature of the occupant can be efficiently used for electric power generation. In addition, deterioration in the seating feeling of the occupant is suppressed.

According to the present invention, the length of the connection member can be shortened, and the electric power can be efficiently supplied.

According to the present invention, heat of a portion that becomes hot inside the vehicle, particularly in the vicinity of the drive device or the control device in the vehicle seat can be efficiently used for electric power generation.

According to the present invention, heat of a portion that becomes hot inside the vehicle, particularly in the vicinity of the drive member of the blower device in the vehicle seat can be efficiently used for electric power generation.

According to the present invention, heat of a portion that becomes hot inside the vehicle, particularly a portion of the vehicle door lining that is likely to receive direct sunlight or is likely to be affected by the outside temperature can be efficiently used for electric power generation.

According to the present invention, heat of a portion that becomes hot inside the vehicle, particularly in the vicinity of the light-emitting member on the vehicle door lining can be efficiently used for electric power generation.

According to the present invention, heat of a portion that becomes hot inside the vehicle, particularly in the vicinity of the light-emitting member on the vehicle door lining can be efficiently used for electric power generation.

According to the present invention, the electric power can be stably supplied. In addition, the electric power consumption can be controlled to an optimal level. In addition, when the activities of other power generation members are weak, the electric power generation by the thermoelectric power generation member can be controlled to supplement the amount of electric power generated.

### DESCRIPTION OF EMBODIMENT

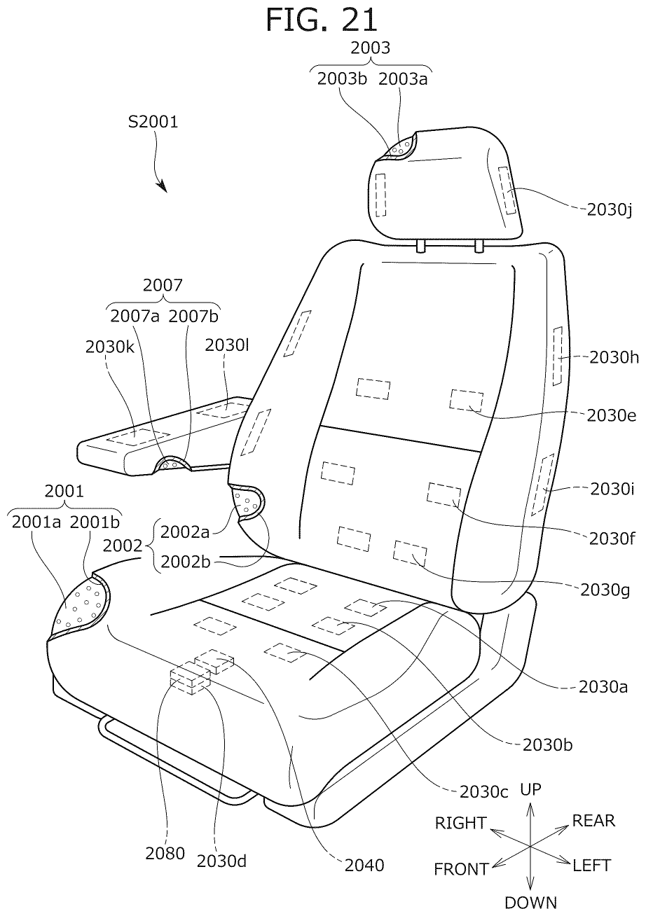

Hereinafter, examples of the present embodiment will be described with reference to FIGS. 21 to 32.

The present embodiment relates to the invention of a vehicle member disposed inside a vehicle and used by an occupant inside the vehicle, the vehicle member including a thermoelectric power generation member that converts heat into electric power, and the thermoelectric power generation member being provided at a predetermined portion of the vehicle member and being configured independently of the predetermined portion.

### First Example

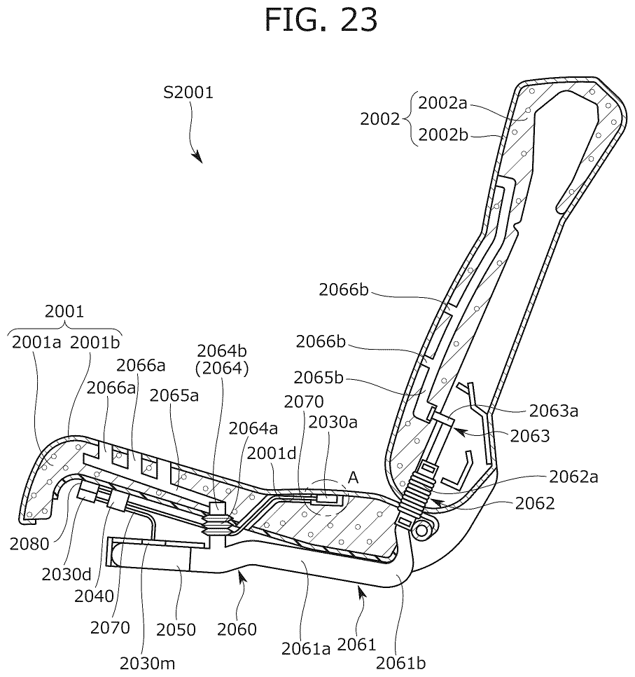

As shown in FIGS. 21 and 23, a vehicle member S2001 of a first example is a vehicle seat, and mainly includes a seat body including a seat cushion 2001, a seat back 2002, a headrest 2003, and armrests 2007 that support the arms of an occupant; a thermoelectric power generation member 2030 attached to the inside of the seat body to generate electric power using the body temperature of the occupant seated in the seat body or the outside temperature; an electric power storage member 2040 that stores electric power; a blower device 2050; and a control device 2080 electrically connected to the thermoelectric power generation member 2030, the electric power storage member 2040, and the blower device 2050 via a connection member 2070. Incidentally, a side on which the occupant is seated with respect to the seat back 2002 of the vehicle seat is a seat front side.

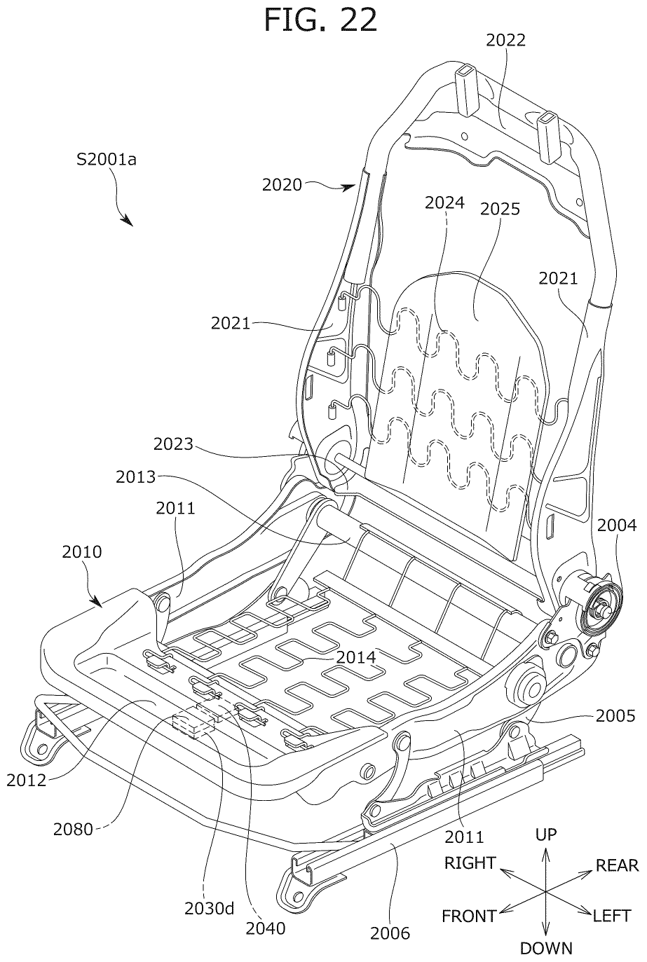

As shown in FIGS. 21 and 23, the seat cushion 2001 is a seating portion that supports the occupant from below, and is configured by placing a pad material 2001a on a cushion frame 2010 of a seat frame S2001a serving as a skeleton shown in FIG. 22, and by covering the pad material 2001a with a skin material 2001b.

The pad material 2001a is a urethane member made of urethane foam or the like. Accommodation recesses 2001c and insertion holes 2001d for passing the connection member 2070 are formed on a surface of the pad material 2001a at positions corresponding to portions with which the seated occupant comes into contact.

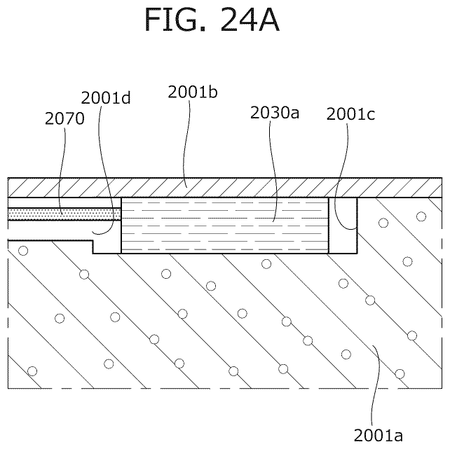

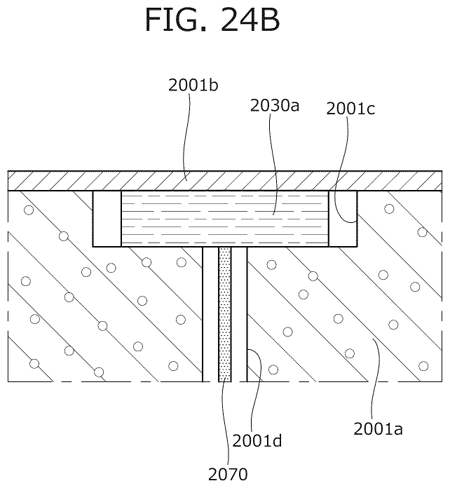

As shown in FIGS. 23 and 24A, the accommodation recess 2001c is a recess formed on a surface on a skin material 2001b side of the pad material 2001a in a thickness direction, and accommodating the thermoelectric power generation member 2030. The insertion hole 2001d penetrates from the accommodation recess 2001c of the pad material 2001a toward a cushion frame 2010 side in the thickness direction of the pad material 2001a.

In the embodiment shown in FIG. 24A, the insertion hole 2001d extends from the accommodation recess 2001c toward the seat front side, then bends, and penetrates toward the cushion frame 2010 side. On the other hand, as shown in FIG. 24B, the insertion hole 2001d may directly penetrate from the accommodation recess 2001c toward the cushion frame 2010 side.

As shown in FIGS. 21 and 23, the seat back 2002 is a backrest portion that supports the back of the occupant from the rear, and is configured by placing a pad material 2002a on a back frame 2020 serving as a skeleton shown in FIG. 22, and by covering the pad material 2002a with a skin material 2002b.

Accommodation recesses (not shown) and insertion holes (not shown) for passing the connection member 2070 are formed on a surface of the pad material 2002a at positions corresponding to portions with which the back of the seated occupant comes into contact.

As shown in FIG. 21, the headrest 2003 is a member that supports the head of the occupant, and is configured by placing a pad material 2003a on a pillar (not shown) serving as a core material, and by covering the pad material 2003a with a skin material 2003b.

As shown in FIG. 21, each of the armrest 2007 is a member that supports the arm of the occupant from below, and is configured by placing a pad material 2007a on an armrest frame (not shown) serving as a skeleton, and by covering the pad material 2007a with a skin material 2007b.

Accommodation recesses (not shown) and insertion holes (not shown) for passing the connection member 2070 are formed on a surface of the pad material 2007a at positions corresponding to portions with which the arm of the seated occupant comes into contact.

As shown in FIG. 22, the cushion frame 2010 is made of a substantially rectangular frame-shaped body, and mainly includes cushion side frames 2011 disposed on the right and left sides; a pan frame 2012 having a plate shape and installed on front end portions of the cushion side frames 2011 in a bridging manner; a rear connecting frame 2013 connecting rear portions of the cushion side frames 2011; and a plurality of elastic springs 2014 hooked onto the pan frame 2012 and the rear connecting frame 2013 and extending in a meandering manner in a seat front to rear direction.

The cushion side frames 2011 are plate-shaped frames that are elongated in the seat front to rear direction.

Incidentally, a reclining device 2004 is attached to the rear portion of the cushion side frames 2011, and a rail device 2006 is attached to lower portions of the cushion side frames 2011 via a height link device 2005.

The pan frame 2012 is a frame that supports the thighs of the occupant, and is made of a rectangular plate body, and both end portions of the pan frame 2012 in a seat width direction are placed and attached to upper surfaces of the cushion side frames 2011.

The elastic springs 2014 are elastic support members that support the buttocks of the occupant, and the plurality of elastic springs 2014 are provided at predetermined intervals in the seat width direction.

The elastic springs 2014 are configured such that front end portions of the elastic springs 2014 are hooked onto edges of hooking holes (not shown) formed on an upper surface of the pan frame 2012 and rear end portions of the elastic springs 2014 are hooked onto the rear connecting frame 2013 via hook members (not shown).

As shown in FIG. 22, the back frame 2020 is made of a substantially rectangular frame-shaped body, and mainly includes back side frames 2021 disposed on the right and left sides; an upper frame 2022 having an inverted U shape and connecting upper end portions of the back side frames 2021; a lower frame 2023 having a plate shape and connecting lower end portions of the back side frames 2021; a plurality of elastic wires 2024 hooked onto each of the back side frames 2021 and extending in a meandering manner in the seat width direction; and a support plate 2025 held by the plurality of elastic wires 2024 and supporting the occupant.

The back side frames 2021 are sheet metal members extending in an up to down direction and having a substantially C-shaped horizontal cross section, and lower end portions of the back side frames 2021 are connected to rear end portions of the cushion side frames 2011 via the reclining device 2004.

In the above-described configuration, the back frame 2020 is rotatable relative to the cushion frame 2010.

The thermoelectric power generation member 2030 is, for example, a thermoelectric power generation module composed of a rectangular plate-shaped body, and a plurality of the thermoelectric power generation members 2030 are attached to the vehicle member S2001 and are disposed independently of portions of the vehicle member S2001 that receive the body temperature of the occupant and portions (predetermined portions) that become hot inside the vehicle. Specifically, the thermoelectric power generation member 2030 mainly includes a high-temperature side substrate; a low-temperature side substrate; a plurality of thermoelectric elements disposed between the high-temperature side substrate and the low-temperature side substrate. The plurality of thermoelectric elements are a pair of a P-type thermoelectric conversion element and an N-type thermoelectric conversion element, and an example of the thermoelectric element is a Bi—Te-based element. When a temperature difference is applied between both ends of the plurality of thermoelectric elements, the plurality of thermoelectric elements generate an electromotive force due to the Seebeck effect and generate electric power.

Incidentally, the thermoelectric power generation members 2030 may be modules combined in a cylindrical shape or the like in addition to the rectangular plate-shaped modules. In the case of the rectangular plate-shaped modules described above, the thermoelectric power generation members 2030 can be attached by being shaped or pasted in accordance with the design shape of the vehicle member S2001. Furthermore, it is possible to realize the power generation members that are lighter and thinner than in the related art.

As shown in FIGS. 21 and 22, the plurality of thermoelectric power generation members 2030 are provided, and include thermoelectric power generation members 2030a to 2030c disposed on the seat cushion 2001; a thermoelectric power generation member 2030d disposed on the cushion frame 2010; thermoelectric power generation members 2030e to 2030i disposed on the seat back 2002; a thermoelectric power generation member 2030j disposed on the headrest 2003; thermoelectric power generation member 2030k and 2030l disposed on the armrests 2007; and a thermoelectric power generation member 2030m disposed on the blower device 2050.

The thermoelectric power generation members 2030a to 2030c are each disposed independently of the seat cushion 2001 at the positions of hip points of the occupant on the seat cushion 2001 or positions corresponding to the vicinities of the hip points. Specifically, the thermoelectric power generation members 2030a to 2030c are placed in the accommodation recesses 2001c formed on the surface on the skin material 2001b side of the pad material 2001a, and can be attached and detached from the seat cushion 2001. Each of the thermoelectric power generation members 2030a to 2030c is provided in pairs to be right-left symmetric with respect to the center of the seat cushion 2001 in a right to left direction. Incidentally, the number or positions of the thermoelectric power generation members 2030a to 2030c may not be limited as long as the thermoelectric power generation members 2030a to 2030c are located where the body temperature of the occupant is easily transferred.

The thermoelectric power generation member 2030a is provided at a position corresponding to the lowest part of the ischial bone of the occupant. The thermoelectric power generation member 2030b is disposed at a position slightly in front of the thermoelectric power generation member 2030a. At this position, heat from the buttocks of the occupant is most easily transferred. The thermoelectric power generation member 2030c is disposed at a position slightly in front of the thermoelectric power generation member 2030b. At this position, heat from the thighs of the occupant is most easily transferred.

As shown in FIGS. 23 and 24, the thermoelectric power generation member 2030a is accommodated in the accommodation recess 2001c between the pad material 2001a and the skin material 2001b. Similarly, the thermoelectric power generation members 2030b and 2030c are also accommodated in the accommodation recesses (not shown) between the pad material 2001a and the skin material 2001b. Since the thermoelectric power generation members 2030 are accommodated in the accommodation recesses 2001c as in the above-described configuration, the thermoelectric power generation members 2030 do not protrude from a seating surface of the seat cushion 2001, so that deterioration in the seating feeling can be suppressed. In addition, in order to enhance the seating feeling, a slab or a resin sponge may be disposed between the thermoelectric power generation members 2030 and the skin material 2001b. Incidentally, the thermoelectric power generation members 2030e to 2030g disposed on a front surface of the seat back 2002 to be described later can also be configured to be accommodated in the accommodation recesses (not shown) provided in the pad material 2002a.

As shown in FIGS. 22 and 23, the thermoelectric power generation member 2030d is attached, independently of the control device 2080, to the control device 2080, which is disposed on a bottom surface of the pan frame 2012, via a holder (not shown) in the cushion frame 2010. Specifically, the thermoelectric power generation member 2030d is a member separate from the control device 2080, and is detachably attached to the control device 2080. Incidentally, the number or positions of the thermoelectric power generation members 2030d may not be limited as long as the thermoelectric power generation members 2030d are located where heat from the control device 2080 is easily transferred.

The thermoelectric power generation members 2030e to 2030g are each disposed independently of the seat back 2002 at positions corresponding to the rear of the lumbar of the occupant on the seat back 2002. Specifically, the thermoelectric power generation members 2030e to 2030g are placed in the accommodation recesses (not shown) formed on a surface on a skin material 2002b side of the pad material 2002a, and can be attached and detached from the seat back 2002. Each of the thermoelectric power generation members 2030e to 2030g is provided in pairs to be right-left symmetric with respect to the center of the seat back 2002 in the right to left direction. Incidentally, the number or positions of the thermoelectric power generation members 2030e to 2030g may not be limited as long as the thermoelectric power generation members 2030e to 2030g are located where the body temperature of the occupant is easily transferred.

The thermoelectric power generation member 2030e is provided at a position corresponding to the back of the occupant. At this position, heat from the back of the occupant is most easily transferred. The thermoelectric power generation member 2030f is disposed at a position slightly below the thermoelectric power generation member 2030e. The thermoelectric power generation member 2030g is disposed at a position slightly below the thermoelectric power generation member 2030f. At this position, heat from the lumbar of the occupant is most easily transferred.

The thermoelectric power generation members 2030h and 2030i are each disposed independently of the seat back 2002 at positions where thermoelectric power generation members 2030h and 2030i receive warm air from an air conditioner (not shown), which is provided at the front inside the vehicle, or direct sunlight on a side surface of the seat back 2002. Specifically, the thermoelectric power generation members 2030h and 2030i are placed in the accommodation recesses (not shown) formed on the surface on the skin material 2002b side of the pad material 2002a, and can be attached and detached from the seat back 2002. Each of the thermoelectric power generation members 2030h and 2030i is provided in pairs to be right-left symmetric with respect to the center of the seat back 2002 in the right to left direction. Incidentally, the number or positions of the thermoelectric power generation members 2030h and 2030i may not be limited as long as the thermoelectric power generation members 2030h and 2030i are located where the temperature becomes high inside the vehicle.

The thermoelectric power generation member 2030h is provided at a position corresponding to the shoulder of the occupant. The thermoelectric power generation member 2030i is disposed at a position slightly below the thermoelectric power generation member 2030h. At this position, heat generated by warm air directed toward the occupant from the air conditioner provided at the front inside the vehicle is most easily transferred. In addition, the thermoelectric power generation members 2030h and 2030i located on the window side are disposed at positions where the thermoelectric power generation members 2030h and 2030i receive direct sunlight from the window and are likely to become hot.

The thermoelectric power generation member 2030j is disposed independently of the headrest 2003 at a position where the thermoelectric power generation member 2030j receives warm air from the air conditioner (not shown), which is provided at the front inside the vehicle, or direct sunlight on a side surface of the headrest 2003.

Specifically, the thermoelectric power generation member 2030j is placed in the accommodation recess (not shown) formed on a surface on a skin material 2003b side of the pad material 2003a, and can be attached and detached from the headrest 2003. The thermoelectric power generation member 2030j is provided in pairs to be right-left symmetric with respect to the center of the seat in the right to left direction. Incidentally, the number or positions of the thermoelectric power generation members 2030j may not be limited as long as the thermoelectric power generation members 2030j are located where the temperature becomes high inside the vehicle.

The thermoelectric power generation member 2030j is provided at a position corresponding to the temporal region of the occupant. At this position, heat generated by warm air directed toward the occupant from the air conditioner provided at the front inside the vehicle is most easily transferred. In addition, the thermoelectric power generation member 2030j located on the window side is disposed at a position where the thermoelectric power generation member 2030j receives direct sunlight from the window and is likely to become hot.

The thermoelectric power generation members 2030k and 2030l are each disposed independently of the armrest 2007 at positions corresponding to the arm of the occupant on a side surface of the armrest 2007. Specifically, the thermoelectric power generation members 2030k and 2030l are placed in the accommodation recesses (not shown) formed on a surface on a skin material 2007b side of the pad material 2007a, and can be attached and detached from the armrest 2007. The thermoelectric power generation member 2030k is provided at a position corresponding to the wrist of the occupant. The thermoelectric power generation member 2030l is provided at a position corresponding to the elbow of the occupant. Incidentally, the number or positions of the thermoelectric power generation members 2030k and 2030l may not be limited as long as the thermoelectric power generation members 2030k and 2030l are located where the body temperature of the occupant is easily transferred. In addition, the disposition position may be a position where thermoelectric power generation members 2030k and 2030l receive direct sunlight when the armrest 2007 is in a stored state.

The thermoelectric power generation member 2030m is attached, independently of the blower device 2050, to a drive member (motor or the like) of the blower device 2050, which is provided below the cushion frame 2010, via a holder (not shown). Specifically, the thermoelectric power generation member 2030m is a member separate from the blower device 2050, and is detachably attached to the blower device 2050. Incidentally, the number or positions of the thermoelectric power generation members 2030m may not be limited as long as the thermoelectric power generation members 2030m are located where heat of the blower device 2050 is easily transferred.

As shown in FIGS. 22 and 23, the electric power storage member 2040 is a plate-shaped storage battery (battery), stores electric power generated by the thermoelectric power generation members 2030, and supplies electric power toward the control device 2080 or the blower device 2050.

The electric power storage member 2040 is disposed on a lower surface of a rear portion of the pan frame 2012, and is attached in the vicinity of the control device 2080.

The blower device 2050 is, for example, a sirocco fan, and is disposed below the seat cushion 2001. The vehicle member S2001 is configured to blow out air blown from the blower device 2050 toward the occupant seated in the seat, through a duct 2060, a ventilation passages 2065a and 2065b, and ventilation holes 2066a and 2066b to be described later. The pad material 2001a includes the ventilation passage 2065a formed inside the pad material 2001a, and a plurality of the ventilation holes 2066a communicating with the ventilation passage 2065a from an upper surface of the pad material 2001a.

In addition, the pad material 2002a includes the ventilation passage 2065b formed inside the pad material 2002a, and a plurality of the ventilation holes 2066b communicating with the ventilation passage 2065b from a front surface of the pad material 2001a. The ventilation passages 2065a and 2065b open toward the occupant via the ventilation holes 2066a and 2066b, respectively.

The ventilation passages 2065a and 2065b are connected to the blower device 2050 by the duct 2060.

The duct 2060 is formed by connecting a plurality of components. Specifically, the duct 2060 includes a first duct 2061, a second duct 2062, a third duct 2063, and a fourth duct 2064.

The first duct 2061 includes a lower pipe portion 2061a extending in the seat front to rear direction, and a curved pipe portion 2061b extending upward while being curved to protrude rearward from a rear end of the lower pipe portion 2061a. A front end portion of the lower pipe portion 2061a is connected to the blower device 2050.

The second duct 2062 is connected to the curved pipe portion 2061b of the first duct 2061, and is provided to extend in the up to down direction. The second duct 2062 includes a first bellows portion 2062a that is flexible and that is extendable and retractable.

The third duct 2063 is connected to an upper end of the second duct 2062. The third duct 2063 includes a back connection pipe portion 2063a. The back connection pipe portion 2063a is connected to the ventilation passage 2065b formed in the pad material 2002a.

The fourth duct 2064 is connected to a front portion of the first duct 2061, and is provided to extend in the up to down direction. The fourth duct 2064 includes a second bellows portion 2064a that is flexible and that is extendable and retractable, and a cushion connection pipe portion 2064b provided on the second bellows portion 2064a. The cushion connection pipe portion 2064b is connected to the ventilation passage 2065a formed in the pad material 2001a.

The duct 2060 is disposed to straddle the seat cushion 2001 and the seat back 2002.

In detail, in the duct 2060, the first duct 2061 and the fourth duct 2064 are disposed on the seat cushion 2001, the third duct 2063 is disposed on the seat back 2002, and the second duct 2062 is disposed to straddle the seat cushion 2001 and the seat back 2002.

The connection member 2070 is a wire harness formed by bundling a plurality of electric wires (transmission paths), and electrically connects the thermoelectric power generation members 2030, the control device 2080, and the blower device 2050.

In order to connect the thermoelectric power generation members 2030, the electric power storage member 2040, and the blower device 2050, the connection member 2070 passes through the insertion holes 2001d of the pad material 2001a and extends toward the cushion frame 2010 side. The insertion holes 2001d are disposed between the plurality of thermoelectric power generation members 2030 in the seat width direction and the front to rear direction on a seating surface of the pad material 2001a. For that reason, electric power generation performance is not affected. In addition, the connection member 2070 connecting the thermoelectric power generation members 2030 and the electric power storage member 2040 can be disposed in a simple manner.

Incidentally, the connection member 2070 may extend toward the rear side of the seat cushion 2001 without passing through the insertion holes 2001d, pass through the rear of the seat cushion 2001, and extend toward the cushion frame 2010 side.

The control device 2080 is an election control unit (ECU) that controls the thermoelectric power generation members 2030, the electric power storage member 2040, and the blower device 2050, and as shown in FIGS. 22 and 23, is attached to the bottom surface of the pan frame 2012 via a holder (not shown).

The control device 2080 is a computer including a central processing unit (CPU) as a data computation and control processing unit; a ROM and a RAM as storage devices; and a communication interface that transmits and receives information data through an in-vehicle network. The control device 2080 may be realized by a semiconductor integrated circuit or a field-programmable gate array (FPGA) on which a CPU is mounted.

The storage device of the control device 2080 stores a program related to electric power supply in addition to a main program that performs functions necessary for the computer, and the electric power supply function is performed by executing these programs using the CPU.

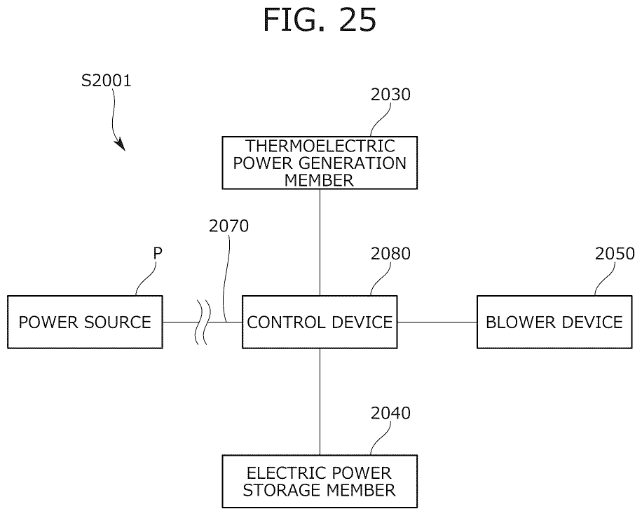

In addition, as shown in FIG. 25, the control device 2080 receives, via the connection member 2070, a supply of electric power from a power source P (for example, an in-vehicle battery) mounted on a vehicle body. The control device 2080 may be attached inside the vehicle member S2001, or may be attached outside the vehicle member S2001. In addition, the control device 2080 may control devices other than the thermoelectric power generation members 2030, the electric power storage member 2040, and the blower device 2050. Examples of the devices include a biosensor (pressure sensor), a wireless communication device, a heater, and the like that operate with low electric power.

The control device 2080 controls the power source P to supply electric power to the blower device 2050 when the amount of electric power generated by the thermoelectric power generation members 2030 is less than a predetermined threshold value or when the amount of electric power stored by the electric power storage member 2040 is less than a predetermined threshold value.

Namely, when the amount of electric power generated and stored by the thermoelectric power generation members 2030 and the electric power storage member 2040 is insufficient, the blower device 2050 receives a supply of electric power from the power source P on the vehicle body side.

In addition, the control device 2080 controls the thermoelectric power generation members 2030 or the electric power storage member 2040 to supply electric power to the blower device 2050 when the amount of electric power generated by the thermoelectric power generation members 2030 is the predetermined threshold value or more or when the amount of electric power stored by the electric power storage member 2040 is the predetermined threshold value or more. Furthermore, the control device 2080 performs control to supply electric power to the power source P on the vehicle body side or electrical components.

Namely, when the amount of electric power generated and stored by the thermoelectric power generation members 2030 and the electric power storage member 2040 is sufficient, electric power is supplied to the power source P on the vehicle body side or the electrical components.

With the above-described configuration, it is possible to realize the vehicle member S2001 that can perform the functions of the blower device 2050 or drive devices mounted in other vehicles even when electric power is not supplied from the power source P on the vehicle body.

In addition, each component for performing the functions of the blower device 2050 or the drive devices mounted in the other vehicles can be compactly disposed, and the weight can be reduced compared to the related art. In addition, the thermoelectric power generation members 2030 can also efficiently generate electric power.

### Second Example

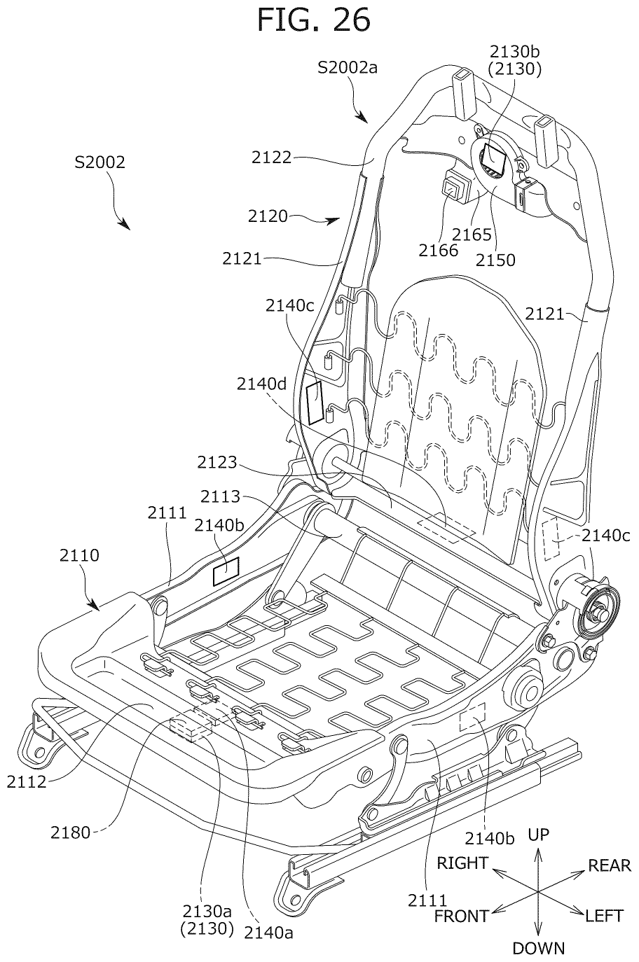

Next, a vehicle member S2002 of a second example will be described based on FIG. 26.

Incidentally, the description of contents that overlap with those of the vehicle member S2001 described above will be omitted.

The vehicle member S2002 differs from the vehicle member S2001 mainly in the disposition of components for performing the electric power generation function.

As shown in FIG. 26, the vehicle member S2002 is a vehicle seat, and mainly includes a cushion frame 2110; a thermoelectric power generation member 2130 attached to the cushion frame 2110 to generate electric power using heat from a control device 2180 and a blower device 2150; an electric power storage member 2140 that stores electric power; the blower device 2150; and the control device 2180 connected to the thermoelectric power generation member 2130, the electric power storage member 2140, and the blower device 2150.

As shown in FIG. 26, the cushion frame 2110 mainly includes right and left cushion side frames 2111, a pan frame 2112, a rear connecting frame 2113, and a plurality of elastic springs.

As shown in FIG. 26, a back frame 2120 mainly includes right and left back side frames 2121, an upper frame 2122, and a lower frame 2123.

The thermoelectric power generation member 2130 includes thermoelectric power generation members 2130a and 2130b composed of rectangular plate-shaped bodies, and a plurality of the thermoelectric power generation members 2130 are disposed at portions of the vehicle member S2002 that become hot. As shown in FIG. 26, the thermoelectric power generation member 2130 includes the thermoelectric power generation member 2130a disposed on the cushion frame 2110, and the thermoelectric power generation member 2130b disposed on the back frame 2120.

As shown in FIG. 26, the thermoelectric power generation member 2130a is attached, independently of the control device 2180, to the control device 2180, which is disposed on a bottom surface of the pan frame 2112, via a holder (not shown). Specifically, the thermoelectric power generation member 2130a is a member separate from the control device 2180, and is detachably attached to the control device 2180. Incidentally, the number or positions of the thermoelectric power generation members 2130a may not be limited as long as the thermoelectric power generation members 2130a are located where heat from the control device 2180 is easily transferred.

The thermoelectric power generation member 2130b is attached, independently of the blower device 2150, to a drive member (motor or the like) of the blower device 2150, which is provided on the upper side of the upper frame 2122 of the back frame 2120, via a holder (not shown). Specifically, the thermoelectric power generation member 2130b is a member separate from the blower device 2150, and is detachably attached to the blower device 2150. Incidentally, the number or positions of the thermoelectric power generation members 2130b may not be limited as long as the thermoelectric power generation members 2130b are located where heat of the blower device 2150 is easily transferred.

As shown in FIG. 26, the electric power storage member 2140 is a plate-shaped storage battery, stores electric power generated by the thermoelectric power generation member 2130, and supplies electric power toward the control device 2180 or the blower device 2150.

The electric power storage member 2140 includes a plurality of electric power storage members 2140a to 2140d provided on a seat frame S2002a. The electric power storage member 2140a is disposed on a lower surface of the rear side of the pan frame 2112 in the front to rear direction, and is attached in the vicinity of the control device 2180. The electric power storage member 2140b is disposed on each of the right and left cushion side frames 2111, and is connected to the thermoelectric power generation member 2130a via a connection member (not shown). The electric power storage member 2140c is disposed on each of the right and left back side frames 2121, and is connected to the thermoelectric power generation member 2130b via a connection member (not shown). The electric power storage member 2140d is disposed on the lower frame 2123, and is connected to the thermoelectric power generation member 2130b via a connection member (not shown).

The blower device 2150 is a sirocco fan, and is disposed on the upper side of the upper frame 2122 of the back frame 2120. The vehicle member S2002 is configured to blow out air blown from the blower device 2150 toward the occupant, who is seated in the seat, from a ventilation hole 2166 through a ventilation passage 2165.

The control device 2180 is a device that controls the blower device 2150, and as shown in FIG. 26, is attached to the bottom surface of the pan frame 2112 via a holder (not shown). The control device 2180 may be attached inside the vehicle member S2002, or may be attached outside the vehicle member S2002. In addition, the control device 2180 may control devices other than the blower device 2150.

Even with the above-described configuration, it is possible to realize the vehicle member S2002 that can perform the functions of the blower device 2150 or drive devices mounted in other vehicles even when electric power is not supplied from the power source on the vehicle body.

In addition, each component for performing the functions of the blower device 2150 or the drive devices mounted in the other vehicles can be compactly disposed, and the weight can be reduced compared to the related art. In addition, the thermoelectric power generation member 2130 can also efficiently generate electric power.

### Third Example

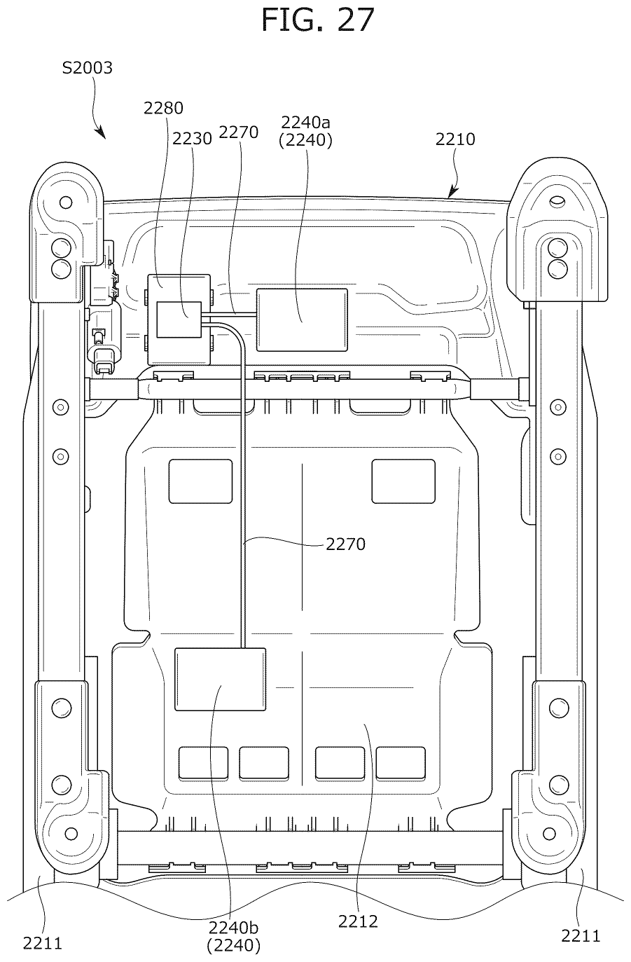

Next, a vehicle member S2003 of a third example will be described based on FIG. 27.

Incidentally, the description of contents that overlap with those of the vehicle members S2001 and S2002 described above will be omitted.

The vehicle member S2003 differs from the vehicle members S2001 and S2002 mainly in the disposition of components for performing the electric power generation function.

As shown in FIG. 27, the vehicle member S2003 is a vehicle seat, and mainly includes a cushion frame 2210; a thermoelectric power generation member 2230 attached to the cushion frame 2210 to generate electric power using heat from a control device 2280; an electric power storage member 240 that stores electric power; and the control device 2280 connected to the thermoelectric power generation member 230 and the electric power storage member 240 via a connection member 2270.

As shown in FIG. 27, the cushion frame 2210 mainly includes right and left cushion side frames 2211 and a pan frame 2212.

The thermoelectric power generation member 2230 is composed of a rectangular plate-shaped body, and a plurality of the thermoelectric power generation members 2230 are disposed at portions of the vehicle member S2003 that become hot. As shown in FIG. 27, the thermoelectric power generation member 2230 is attached, independently of the control device 2280, to the control device 2280, which is disposed on a bottom surface of the pan frame 2212, via a holder (not shown). Specifically, the thermoelectric power generation member 2230 is a member separate from the control device 2280, and is detachably attached to the control device 2280. Incidentally, the number or positions of the thermoelectric power generation members 2230 may not be limited as long as the thermoelectric power generation members 2230 are located where heat from the control device 2280 is easily transferred.

As shown in FIG. 27, the electric power storage member 2240 is a plate-shaped storage battery, stores electric power generated by the thermoelectric power generation member 2230, and supplies electric power toward the control device 2280 or drive devices mounted in the vehicle.

The electric power storage member 2240 includes a plurality of electric power storage members 2240a and 2240b provided in the vehicle member S2003. The electric power storage member 2240a is disposed on a lower surface of the front side of the pan frame 2212 in the front to rear direction, and is attached in the vicinity of the control device 2280. The electric power storage member 2240b is disposed on the lower surface on the front side of the pan frame 2212 in the front to rear direction. The electric power storage members 2240a and 2240b are connected to the thermoelectric power generation member 2230 via the connection member 2270.

The control device 2280 is a device that controls the drive devices mounted in the vehicle, and as shown in FIG. 27, is attached to the bottom surface of the pan frame 2212 via a holder (not shown). Incidentally, the control device 2280 is provided on the pan frame 2212; however, the position is not limited as long as the control device 2280 is provided below the cushion frame 2210.

Even with the above-described configuration, it is possible to realize the vehicle member S2003 that can perform the functions of the drive devices mounted in the vehicle even when electric power is not supplied from the power source on the vehicle body.

In addition, each component for performing the functions of the drive devices mounted in the vehicle can be compactly disposed, and the weight can be reduced compared to the related art. In addition, the thermoelectric power generation member 2230 can also efficiently generate electric power.

### Fourth Example

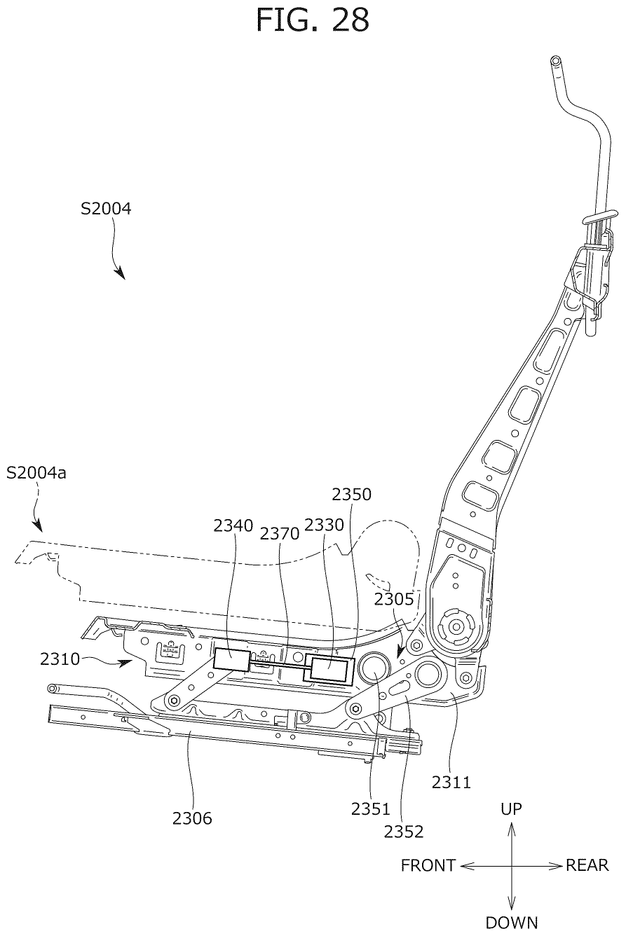

Next, a vehicle member S2004 of a fourth example will be described based on FIG. 28.

Incidentally, the description of contents that overlap with those of the vehicle members S2001 to S2003 described above will be omitted.

The vehicle member S2004 differs from the vehicle members S2001 to S2003 mainly in the disposition of components for performing the electric power generation function.

As shown in FIG. 28, the vehicle member S2004 is a vehicle seat, and mainly includes a cushion frame 2310; a thermoelectric power generation member 2330 attached to the cushion frame 2310 to generate electric power using heat from a drive mechanism 2350; an electric power storage member 2340; and a connection member 2370 electrically connecting the thermoelectric power generation member 2330 and the electric power storage member 2340.

The vehicle member S2004 includes a seat frame S2004a serving as a skeleton of a seating portion that supports the occupant from below; a height link device 2305 that is electrically driven and that can move the seat frame S2004a upward and downward; and a rail device 2306 disposed on the floor of the vehicle and supporting the seat frame S2004a so as to be movable forward and rearward.

The height link device 2305 includes the drive mechanism 2350 that is supported by cushion side frames 2311 disposed on the right and left sides of the cushion frame 2310, and that is connected to a link mechanism 2352. The drive mechanism 2350 is an electric motor that generates power according to the supply of electric power, and includes a transmission mechanism 2351 that causes the link mechanism 2352 to rotate around a horizontal axis with respect to the cushion side frames 2311 according to the power of the drive mechanism 2350. The transmission mechanism 2351 includes, for example, a drive gear fixed to a drive shaft of the drive mechanism 2350, and a driven gear fixed to the link mechanism 2352 around a horizontal axis, and is composed of gear group that mesh with each other in order. The power of the drive mechanism 2350 moves the cushion side frames 2311 upward and downward around a horizontal axis.

The thermoelectric power generation member 2330 is composed of a rectangular plate-shaped body, and is disposed at a portion of the vehicle member S2004 that becomes hot. As shown in FIG. 28, the thermoelectric power generation member 2330 is attached, independently of the drive mechanism 2350, to the drive mechanism 2350, which is disposed on the cushion side frames 2311, via a holder (not shown). Specifically, the thermoelectric power generation member 2330 is a member separate from the drive mechanism 2350, and is detachably attached to the drive mechanism 2350. Incidentally, the number or positions of the thermoelectric power generation members 2330 may not be limited as long as the thermoelectric power generation members 2330 are located where heat from the drive mechanism 2350 is easily transferred.

As shown in FIG. 28, the electric power storage member 2340 is a plate-shaped storage battery, stores electric power generated by the thermoelectric power generation member 2330, and supplies electric power toward the drive mechanism 2350.

The electric power storage member 2340 is disposed on the cushion side frames 2311 in the vicinity of the front side of the drive mechanism 2350 in the front to rear direction. The electric power storage member 2340 is connected to the thermoelectric power generation member 2330 via the connection member 2370.

Even with the above-described configuration, it is possible to realize the vehicle member S2004 that can perform the functions of drive devices mounted in the vehicle even when electric power is not supplied from the power source on the vehicle body.

In addition, each component for performing the function of the drive mechanism 2350 can be compactly disposed, and the weight can be reduced compared to the related art. In addition, the thermoelectric power generation member 2330 can also efficiently generate electric power.

### Fifth Example

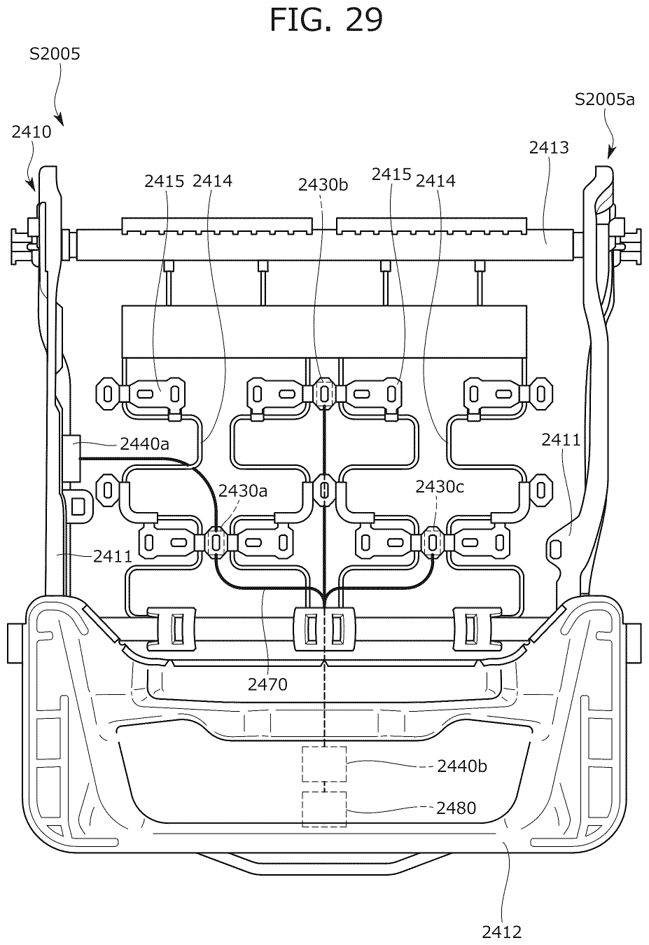

Next, a vehicle member S2005 of a fifth example will be described based on FIG. 29.

Incidentally, the description of contents that overlap with those of the vehicle members S2001 to S2004 described above will be omitted.

The vehicle member S2005 differs from the vehicle members S2001 to S2004 mainly in the disposition of components for performing the electric power generation function.

As shown in FIG. 29, the vehicle member S2005 of the present embodiment mainly includes a cushion frame 2410; a thermoelectric power generation member 2430 attached to the cushion frame 2410 to generate electric power using the body temperature of the occupant seated in a seat body or the outside temperature; an electric power storage member 2440 that stores electric power; and a control device 2480 electrically connected to the thermoelectric power generation member 2430 and the electric power storage member 2440 via a connection member 2470.

As shown in FIG. 29, the cushion frame 2410 mainly includes cushion side frames 2411, a pan frame 2412, a rear connecting frame 2413, and a plurality of elastic springs 2414.

The pan frame 2412 is a frame that supports the thighs of the occupant, and is made of a rectangular plate body, and both end portions of the pan frame 2412 in the seat width direction are placed and attached to upper surfaces of the cushion side frames 2411.

The elastic springs 2414 are elastic support members that support the buttocks of the occupant, and the plurality of elastic springs 2414 are provided at predetermined intervals in the seat width direction.

The elastic springs 2414 are configured such that front end portions of the elastic springs 2414 are hooked onto edges of hooking holes (not shown) formed on an upper surface of the pan frame 2412 and rear end portions of the elastic springs 2414 are hooked onto the rear connecting frame 2413 via hook members (not shown).

The thermoelectric power generation member 2430 is composed of a rectangular plate-shaped body, and a plurality of the thermoelectric power generation members 2430 are disposed at portions of the vehicle member S2004 that become hot. As shown in FIG. 29, the thermoelectric power generation members 2430 are attached, independently of the elastic springs 2414, to the elastic springs 2414 via holders (not shown). Specifically, the thermoelectric power generation members 2430 are members separate from the elastic springs 2414, and are detachably attached to the elastic springs 2414. Incidentally, the number or positions of the thermoelectric power generation members 2430 may not be limited as long as the thermoelectric power generation members 2430 are located where the body temperature of the occupant is easily transferred.

As shown in FIG. 29, the plurality of thermoelectric power generation members 2430 are provided, and include thermoelectric power generation members 2430a to 2430c disposed on a seat frame S2005a.

The thermoelectric power generation members 2430a to 2430c are disposed on clip members 2415 provided on a bottom surface of the pan frame 2412, and are each disposed at the positions of hip points of the occupant or positions corresponding to the vicinities of the hip points. Incidentally, the number or positions of the thermoelectric power generation members 2430a to 2430c may not be limited as long as the thermoelectric power generation members 2430a to 2430c are located where the body temperature of the occupant is easily transferred.

As shown in FIG. 29, the electric power storage member 2440 is a plate-shaped storage battery, stores electric power generated by the thermoelectric power generation members 2430, and supplies electric power toward the control device 2480 or drive devices mounted in the vehicle.

The electric power storage member 2440 includes a plurality of electric power storage members 2460a and 2460b provided in the vehicle member S2005. The electric power storage member 2440a is disposed on an inner side surface of the cushion side frame 2411. The electric power storage member 2440b is disposed on a lower surface on the front side of the pan frame 2412 in the front to rear direction. The electric power storage members 2440a and 2440b are connected to the thermoelectric power generation members 2230 via the connection member 2470.

As shown in FIG. 29, the connection member 2470 extends while being appropriately bent along the bottom surface of the pan frame 2412 in a state where the connection member 2470 is held by the clip members 2415 provided on the bottom surface of the pan frame 2412. For that reason, the connection member 2470 of the thermoelectric power generation members 2430 can be prevented from interfering with the elastic springs 2414, and the deformation or misalignment of the connection member 470 is suppressed, so that the generation of abnormal noise can also be suppressed.

In the embodiment, the elastic springs 2414 of the cushion frame 2410 extend in the seat front to rear direction; however, the extending direction is not particularly limited and can be changed, for example, the elastic springs 2414 may span between the right and left cushion side frames 2411 and extend in the seat width direction.

Even with the above-described configuration, it is possible to realize the vehicle member S2005 that can perform the functions of the drive devices mounted in the vehicle even when electric power is not supplied from the power source on the vehicle body.

In addition, each component for performing the functions of the drive devices mounted in the vehicle can be compactly disposed, and the weight can be reduced compared to the related art. In addition, the thermoelectric power generation members 2430 can also efficiently generate electric power.

### Sixth Example

Next, a vehicle member S2006 of a sixth example will be described based on FIGS. 2010 and 2011.

Incidentally, the description of contents that overlap with those of the vehicle members S2001 to S2005 described above will be omitted.

The vehicle member S2006 differs from the vehicle members S2001 to S2005 mainly in the disposition of components for performing the electric power generation function.

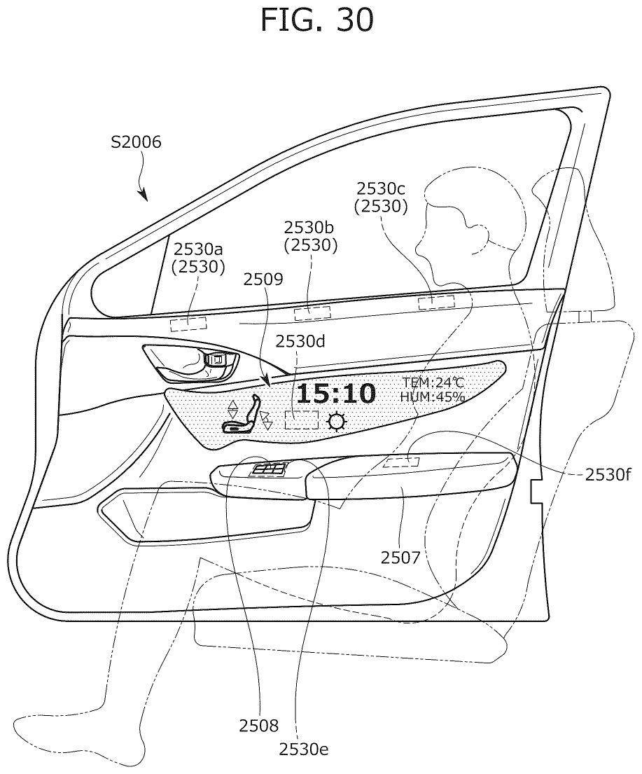

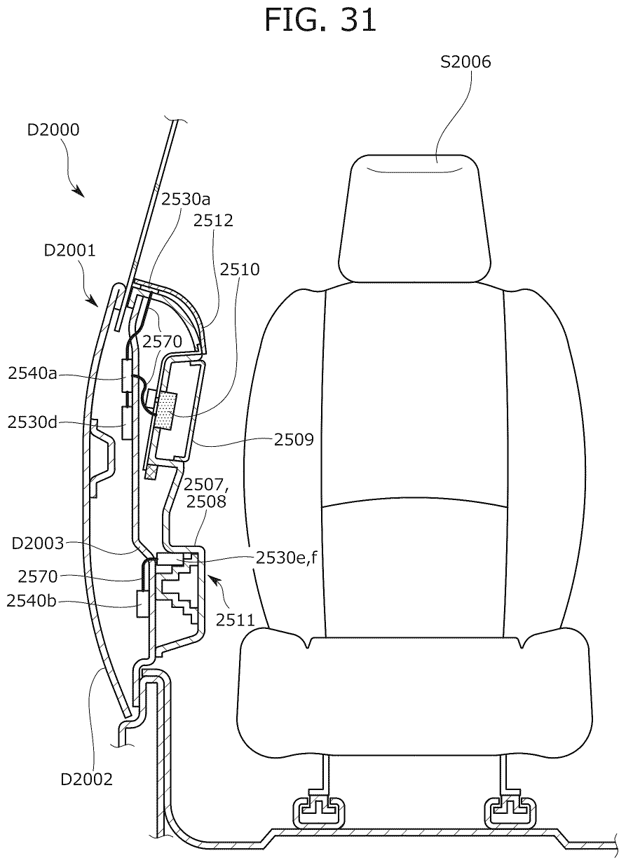

As shown in FIGS. 30 and 31, the vehicle member S2006 is a vehicle door lining, and includes a light-emitting member 2510 that emits light toward the inside of the vehicle; a thermoelectric power generation member 2530 that is electrically connected to the light-emitting member 2510 via a connection member 2570 and that supplies electric power to the light-emitting member 2510; and an electric power storage member 2540 that is electrically connected the light-emitting member 2510 and the thermoelectric power generation member 2530 via the connection member 2570 and that stores electric power.

As shown in FIGS. 30 and 31, the vehicle member S2006 is a vehicle interior member that decorates the vehicle inner side of a vehicle door D, and is composed of a component group attached to a door panel D1 serving as a substrate of the vehicle door D.

For example, as shown in FIG. 30, the vehicle member S2006 includes a door armrest 2507 that supports the arm of the occupant; an operation panel 2508 that is disposed on an upper surface of the door armrest 2507 and that adjusts the opening and closing of a power window; and a decoration panel 2509 that is irradiated with light by the light-emitting member 2510.

As shown in FIG. 31, the door panel D2001 mainly includes an outer panel D2002 and an inner panel D2003 made of a steel sheet. Incidentally, a reinforcement member may be formed on an inner surface of the outer panel D2002 or an outer surface of the inner panel D2003.

As shown in FIG. 31, the vehicle member S2006 is configured by covering a door lining base material 2511, which serves as a substrate of the vehicle member S2006, with a door lining skin material 2512.

Incidentally, in the vehicle member S2006, a front end portion of the door lining base material 2511 is rotatably attached to the vehicle body via a hinge.

For that reason, a connection member for various electrical components provided on the vehicle member S2006 extends toward a front end portion of the vehicle member S2006. Furthermore, the connection member is connected to the power source (power system) provided on the vehicle body.

The vehicle member S2006 includes the decoration panel 2509 that emits light toward the inside of the vehicle to perform the lighting function in the vehicle interior; the light-emitting member 2510 that irradiates the decoration panel 2509 with light; the thermoelectric power generation member 2530 that supplies electric power to the light-emitting member 2510; the electric power storage member 2540 that stores electric power; and the connection member 570 electrically the decoration panel 2509, the light-emitting member 2510, the thermoelectric power generation member 2530, and the electric power storage member 2540.

Each of the decoration panel 2509, the light-emitting member 2510, the thermoelectric power generation member 2530, and the electric power storage member 2540 is attached at a predetermined position on the door lining base material 2511.

As shown in FIG. 30, the decoration panel 2509 is a planar resin member exposed to the vehicle inner side, has light transmittance, and performs the decorative lighting function.

Specifically, the decoration panel 2509 has a light-emitting region on the panel surface, and can display a predetermined decorative pattern when irradiated with light by the light-emitting member 2510.

In more detail, a “touch panel” as an information display screen is formed in the light-emitting region. Furthermore, while the light-emitting member 2510 performs irradiation with light, the “touch panel” in the light-emitting region turns on and information is displayed. On the other hand, while the light-emitting member 2510 does not perform irradiation with light, the “touch panel” turns off, and the decoration panel 2509 harmonizes with the surface of the vehicle member S2006.

Here, at least one of still image information, video information, and text information is displayed on the “touch panel”. The comfort in the interior of the vehicle can be improved by displaying various information on the “touch panel”.

In the present embodiment, as information displayed on the “touch panel”, information about the current time, weather, compartment temperature, and humidity is displayed. In addition, operation buttons for operating a reclining device and a height link device of the vehicle seat are displayed.

Incidentally, the “touch panel” is not limited to displaying this information, and for example, existing operation buttons for windows, a car audio, a car navigation, and the like can also be replaced with the “touch panel” and related information is displayed.

With the above-described configuration, the occupant can operate the “touch panel” or switch over information to be displayed on the “touch panel” depending on his or her mood or situation, so that the comfort inside the vehicle is improved. In addition, the effect of reducing the number of components or securing a vehicle interior space can also be obtained. Further, the design quality is improved compared to the related art.

As shown in FIG. 31, the light-emitting member 2510 is a planar light emitter that is elongated in the seat front to rear direction. Incidentally, the light-emitting member 2510 may be a planar light emitter such as an LED display or an organic EL display.

The light-emitting member 2510 is disposed at substantially the central portion of the vehicle member S6. The decoration panel 2509 is disposed at a position on the vehicle inner side facing the light-emitting member 2510.

As shown in FIG. 31, the door lining base material 2511 is a plate-shaped frame made of resin, and extends to be elongated in a vehicle front to rear direction.

As shown in FIG. 31, the door lining skin material 2512 is made of a resin material (for example, TPO), a fabric (for example, a PET material), a genuine leather, or the like, and is formed into a shape that can cover a surface on the vehicle inner side of the door lining base material 2511. Incidentally, the vehicle member S6 may not include the door lining skin material 2512.

As shown in FIGS. 30 and 31, the thermoelectric power generation member 2530 is composed of a rectangular plate-shaped body, and a plurality of the thermoelectric power generation members 2530 are disposed at portions of the vehicle member S2006 that become hot. The plurality of thermoelectric power generation members 2530 are provided, and include thermoelectric power generation members 2530a to 2530c disposed in the vehicle front to rear direction at positions where the thermoelectric power generation members 2530a to 2530c receive direct sunlight on an upper portion of the vehicle member S2006; a thermoelectric power generation member 2530d disposed at a portion of a side portion on the vehicle outer side of the vehicle member S2006, the portion being likely to be affected by the outside temperature; a thermoelectric power generation member 2530e disposed on the operation panel 2508; and a thermoelectric power generation member 2530f disposed on the door armrest 2507.

As shown in FIG. 30, the thermoelectric power generation members 2530a to 2530c are independently attached to the upper portion of the vehicle member S2006 at three locations along the vehicle front to rear direction via holders (not shown). Specifically, the thermoelectric power generation members 2530a to 2530c are members separate from the vehicle member S2006, and are detachably attached to the vehicle member S2006. As shown in FIG. 31, the thermoelectric power generation members 2530a to 2530c are attached to the door lining base material 2511, and are covered with the door lining skin material 2512.

Incidentally, the number or positions of the thermoelectric power generation members 2530a to 2530c may not be limited as long as the thermoelectric power generation members 2530a to 2530c are located to easily receive direct sunlight from the window.

The thermoelectric power generation member 2530d is independently attached to the inner panel D2003, which is a side portion on the vehicle outer side, at a position corresponding to the light-emitting member 2510 via a holder (not shown). Specifically, the thermoelectric power generation member 2530d is a member separate from the inner panel D2003, and is detachably attached to the inner panel D2003. By providing the thermoelectric power generation member 2530d in the vicinity of the light-emitting member 2510, heat t from the light-emitting member 2510 can be efficiently used for electric power generation.

Particularly, in the case of a Peltier element, since the amount of electric power generated increases due to a difference between an outside temperature and an inside temperature, electric power can be efficiently generated.

The thermoelectric power generation member 2530e is independently attached to the door lining base material 2511 below the operation panel 2508 via a holder (not shown). Specifically, the thermoelectric power generation member 2530e is a member separate from the door lining base material 2511, and is detachably attached to the door lining base material 2511. By providing the thermoelectric power generation member 2530e in the vicinity of the operation panel 2508, heat from the hand of the occupant operating the operation panel 2508 can be efficiently used for electric power generation.

The thermoelectric power generation member 2530f is independently attached to the door lining base material 2511 below the door armrest 2507 via a holder (not shown). Specifically, the thermoelectric power generation member 2530f is a member separate from the door lining base material 2511, and is detachably attached to the door lining base material 2511. By providing the thermoelectric power generation member 2530f in the vicinity of the door armrest 2507, heat of the arm of the occupant placed on the door armrest 2507 can be efficiently used for electric power generation.

As shown in FIG. 31, the electric power storage member 2540 is a plate-shaped storage battery, stores electric power generated by the thermoelectric power generation members 2530, and supplies electric power toward the light-emitting member 2510 or drive devices mounted in the vehicle.

The electric power storage member 2540 includes a plurality of electric power storage members 2540a and 2540b provided in the vehicle member S2006. The electric power storage member 2540a is provided at an upper portion of the inner panel D2003, which is the side portion on the vehicle outer side, at a position corresponding to the light-emitting member 2510. The electric power storage member 2540a is connected to the thermoelectric power generation members 2530a to 2530c and 2530d via the connection member 2570. The electric power storage member 2540a and the thermoelectric power generation member 2530d are disposed at positions close to each other.

The electric power storage member 2540b is provided at a lower portion of the inner panel D2003, which is the side portion on the vehicle outer side, at a position corresponding to the door armrest 2507 and the operation panel 2508. The electric power storage member 2540b is connected to the thermoelectric power generation members 2530e and 2530f via the connection member 2570. The electric power storage member 2540b and both the thermoelectric power generation members 2530e and 2530f are disposed at positions close to each other.

Even with the above-described configuration, it is possible to realize the vehicle member S6 that can perform the functions of the light-emitting member 2510 or the drive devices mounted in the vehicle even when electric power is not supplied from the power source on the vehicle body.

In addition, each component for performing the functions of the light-emitting member 2510 or the drive devices mounted in the vehicle can be compactly disposed, and the weight can be reduced compared to the related art. In addition, the thermoelectric power generation members 530 can also efficiently generate electric power.

### Seventh Example

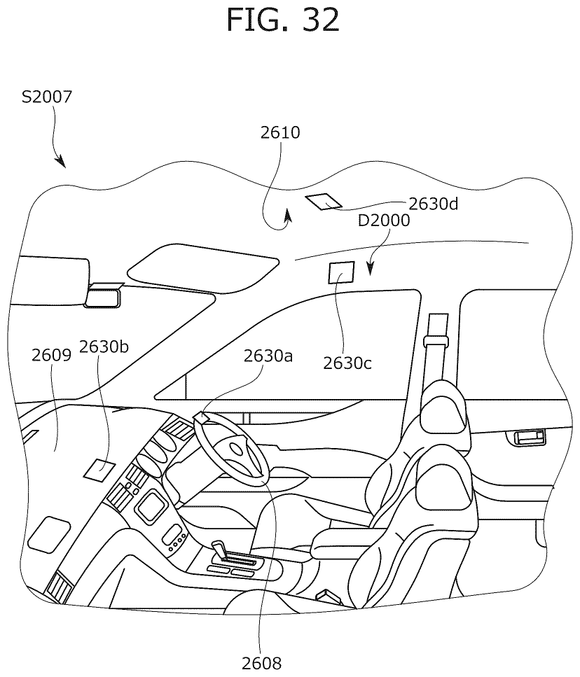

Next, a vehicle member S2007 of a seventh example will be described based on FIG. 32.

Incidentally, the description of contents that overlap with those of the vehicle members S2001 to S2006 described above will be omitted.

The vehicle member S2007 differs from the vehicle members S2001 to S2006 mainly in the disposition of components for performing the electric power generation function.

As shown in FIG. 32, the vehicle member S2007 is a vehicle interior member, and includes a thermoelectric power generation member 2630 that supplies electric power to drive device inside the vehicle; an electric power storage member (not shown) that stores electric power; and a connection member (not shown) electrically connecting the thermoelectric power generation member 2630 and the electric power storage member.

As shown in FIG. 32, a plurality of the thermoelectric power generation members 2630 are provided, and include a thermoelectric power generation member 2630a disposed on a steering wheel 2608; a thermoelectric power generation member 2630b disposed on an instrument panel 2609; a thermoelectric power generation member 2630c disposed on the vehicle inner side of a vehicle door D2000; and a thermoelectric power generation member 2630d disposed on a roof panel 2610.

The thermoelectric power generation member 2630a is attached, independently of the steering wheel 2608, to the steering wheel 2608 at a position where the thermoelectric power generation member 2630a receives warm air from an air conditioner, which is provided at the front inside the vehicle, or direct sunlight. Specifically, the thermoelectric power generation member 2630a is a member separate from the steering wheel 2608, and is detachably attached to the steering wheel 2608. Particularly, the thermoelectric power generation member 2630a is disposed at an upper portion of the steering wheel 2608, and is disposed at a position that avoids a storage portion for an airbag or switches.

The thermoelectric power generation member 2630b is attached, independently of the instrument panel 2609, to the instrument panel 2609 at a position where the thermoelectric power generation member 2630b receives direct sunlight. Specifically, the thermoelectric power generation member 2630b is a member separate from the instrument panel 2609, and is detachably attached to the instrument panel 2609. Particularly, the thermoelectric power generation member 2630b is disposed on an upper surface of the instrument panel 2609, and is disposed at a position that avoids a storage portion for an airbag, a display, a sensor attachment portion, and an air conditioning outlet.

The thermoelectric power generation member 2630c is independently attached to the vehicle inner side of the vehicle door D2000 via a holder (not shown) at a position where the thermoelectric power generation member 2630c receives warm air from the air conditioner provided at the front inside the vehicle or at a portion that is likely to be affected by the outside temperature. Specifically, the thermoelectric power generation member 2630c is a member separate from the vehicle door D, and is detachably attached to the vehicle door D2000.

The thermoelectric power generation member 2630d is attached, independently of the roof panel 2610, to the roof panel 2610 at a position where the thermoelectric power generation member 2630d receives warm air from the air conditioner provided at the front inside the vehicle or at a portion that is likely to be affected by the outside temperature. Specifically, the thermoelectric power generation member 2630d is a member separate from the roof panel 2610, and is detachably attached to the roof panel 2610. Incidentally, both the number and the positions of the thermoelectric power generation members 2630a to 2630d may not be limited as long as the thermoelectric power generation members 2630a to 2630d are located where the temperature becomes high inside the vehicle.

Even with the above-described configuration, it is possible to realize the vehicle member S2007 that can perform the functions of the drive devices mounted in the vehicle even when electric power is not supplied from the power source on the vehicle body.

In addition, each component for performing the functions of the drive devices mounted in the vehicle can be compactly disposed, and the weight can be reduced compared to the related art. In addition, the thermoelectric power generation members 2630 can also efficiently generate electric power.

### Other Examples

In the seventh example, as shown in FIG. 32, the thermoelectric power generation members 2630 are disposed on the steering wheel 2608, the instrument panel 2609, the vehicle door D2000, and the roof panel 2610; however, the disposition positions are particularly not limited and can be changed.

For example, the thermoelectric power generation members 2630 may be disposed at positions where the temperature becomes high inside a door pocket, on a roof window, or the like inside the vehicle. In the case of installation at a location other than the inside of the vehicle, the thermoelectric power generation members 630 may be disposed at a position where the temperature becomes high on a roof, an exhaust passage of an engine, a radiator, a motor, a bonnet, a tailgate, an upper surface of a door mirror, or the like.

In the first to seventh examples, the vehicle members used in automobiles have been described as specific examples; however, the present invention is not particularly limited thereto, and can be used for vehicle members for two-wheeled vehicles or vehicle members for electric trains, buses, or the like. Alternatively, the present invention can be used for conveyance members for airplanes, ships, or the like.

In the first to seventh examples, the invention has been described as relating to the vehicle member; however, the invention may relate to a method for manufacturing a vehicle member.

For example, the invention may relate to a method for manufacturing a vehicle interior member, the method including: a step of attaching a light-emitting member to a base material of a vehicle interior member, the light-emitting member emitting light toward an inside of a vehicle; a step of attaching a thermoelectric power generation member that supplies electric power to the light-emitting member; and a step of attaching an electric power storage member that is electrically connected to the light-emitting member and the thermoelectric power generation member and that stores the electric power.

According to the method, it is possible to manufacture the vehicle interior member that can perform the lighting function in the vehicle interior even when electric power is not supplied from a power source on a vehicle body.

In the present embodiment, the vehicle members (the vehicle seat, the vehicle door lining, and the vehicle interior member) according to the present invention have been mainly described.

However, the embodiment is merely one example for facilitating understanding of the present invention, and does not limit the present invention. The present invention can be modified and improved without departing from the concept of the present invention, and it goes without saying that the present invention includes its equivalents thereof.

Particularly, the dispositions or configurations of the thermoelectric power generation members and the electric power storage members described in the embodiment are merely examples, and do not limit the present invention.

A fourth embodiment of the present invention relates to a conveyance seat, particularly to a conveyance seat including a headrest having a protrusion mechanism.

### BACKGROUND ART

JP 2021-46208 A discloses a vehicle seat in which in a state where a seat back is greatly reclined rearward (relaxed state), side portions of a headrest provided on the outside in a vehicle width direction protrude forward to cover the side parts of the head of an occupant, thereby protecting the head of the occupant from a side collision. In addition, it is described that in a case where the vehicle seat is a driver's seat, the function of the side portions protruding forward operates when a vehicle is in an autonomous driving mode, and does not operate when the vehicle is in a manual driving mode.

### Technical Problem

In the vehicle seat described in JP 2021-46208 A, in the event of a side collision, the head of the occupant is protected using a curtain airbag. Furthermore, in a state where the seat back is greatly reclined rearward, the head of the occupant is out of a range where the head of the occupant can be protected by the curtain airbag, so that the head of the occupant is protected by the side portions provided in the headrest. However, in a case where the headrest fails for any reason and the side portions do not protrude forward, when the seat back is in a relaxed state, there is a possibility that the head of the occupant cannot be sufficiently protected. For that reason, there has been a desire for the conveyance seat that ensures the safety of the occupant even when there is an abnormality in the headrest.

A fourth embodiment of the present invention has been made in view of the above-described problems, and an object of the fourth embodiment is to provide a conveyance seat capable of ensuring the safety of an occupant even when there is an abnormality in a headrest.

### Solution to Problem

The above-described problems are solved by conveyance seat provided in a conveyance, the conveyance seat including: a seat cushion; a seat back rotatably attached to the seat cushion; a reclining mechanism that supports the seat back so as to be adjustable in angle with respect to the seat cushion; a headrest provided at an upper end of the seat back and including a protrusion mechanism of which side portions protrude forward; an abnormality detection unit that detects an abnormality in the protrusion mechanism; and a control unit that controls operations of the reclining mechanism and the protrusion mechanism. In a case where the abnormality detection unit detects an abnormality in the protrusion mechanism, when a rearward tilt angle of the seat back is more than a predetermined angle with respect to a vertical direction, the control unit performs a seat back return process using the reclining mechanism to rotate the seat back until the rearward tilt angle of the seat back reaches the predetermined angle, and when the rearward tilt angle of the seat back is the predetermined angle or less, the control unit performs a seat back rotation prohibition process to prohibit the rotation of the seat back by the reclining mechanism.

According to the conveyance seat, when the abnormality detection unit detects an abnormality in the protrusion mechanism of the headrest, the control unit causes the seat back to rotate until the rearward tilt angle of the seat back reaches the predetermined angle, and prohibits the rotation of the seat back when the rearward tilt angle of the seat back is the predetermined angle or less. Since the seat back is not tilted rearward by more than the predetermined angle, for example, the head of an occupant can be located within a protection range of a curtain airbag provided in the conveyance, so that even when an abnormality occurs in the protrusion mechanism, the safety of the occupant can be ensured.

In addition, in the conveyance seat, the side portions protruding forward may be provided on respective right and left sides of the headrest, and the abnormality in the protrusion mechanism may be that at least one of the side portions provided on the right and left sides may not be able to protrude forward.

By detecting an abnormality in one of the side portions provided on the right and left sides, the seat back return process or the seat back rotation prohibition process can be performed, and the safety of the occupant can be ensured.

In addition, in the conveyance seat, the side portions protruding forward may be provided on respective right and left sides of the headrest, and the abnormality in the protrusion mechanism may be that, of the side portions provided on the right and left sides, at least the side portion closer to a window of the conveyance may not be able to protrude.

By performing the seat back return process and the seat rotation prohibition process only when an abnormality is detected at least in the side portion closer to the window side of the conveyance, for example, when an abnormality is detected only in the side portion on the interior side, the seat back return process and the seat rotation prohibition process cannot be performed. For that reason, the relaxed state of the conveyance seat can be continued. On the other hand, by performing the seat back return process and the seat rotation process when an abnormality in the side portion closer to the window side is detected, the safety of the occupant can be ensured.

In addition, in the conveyance seat, when the abnormality detection unit detects the abnormality in the protrusion mechanism, the control unit may transmit an abnormality detection signal indicating that the abnormality in the protrusion mechanism has occurred, to a conveyance control unit that controls the conveyance.

Since the control unit transmits the abnormality detection signal to the conveyance control unit, the conveyance control unit can perform control corresponding to the abnormality in the protrusion function.

In addition, in the conveyance seat, when the abnormality detection unit detects the abnormality in the protrusion mechanism, the control unit may notify, via the conveyance control unit or directly, an occupant of the conveyance that the seat back return process or the seat back rotation prohibition process is performed since the abnormality in the protrusion mechanism is detected.

A sense of security is given to the occupant by notifying the occupant that the seat back return process or the seat back rotation prohibition process is performed since the abnormality in the protrusion mechanism is detected.

In addition, in the conveyance seat, the notification may be performed using at least one of audio generation means, video display means, lighting means, and vibration generation means provided in the conveyance or the conveyance seat.

The occupant can be reliably notified of the detection of the abnormality by using at least one of the audio generation means, the video display means, the lighting means, and the vibration generation means.

In addition, in the conveyance seat, the conveyance control unit may be able to switch the conveyance between an autonomous driving mode and a manual driving mode. In a case where the abnormality detection unit detects the abnormality in the protrusion mechanism, when the conveyance is in the autonomous driving mode, the control unit may transmit a mode switching signal for switching from the autonomous driving mode to the manual driving mode to the conveyance control unit.

When the side portion of the headrest cannot protrude, the conveyance is allowed to travel more safely by setting the manual driving mode.

In addition, in the conveyance seat, the conveyance control unit may be able to switch the conveyance between an autonomous driving mode and a manual driving mode. When the abnormality detection unit detects the abnormality in the protrusion mechanism, an autonomous driving prohibition signal for prohibiting the conveyance from transitioning to the autonomous driving mode may be transmitted to the conveyance control unit.

When the side portion of the headrest cannot protrude, the conveyance is allowed to travel more safely by prohibiting the transition to the autonomous driving mode and by allowing only the manual driving mode.

In addition, in the conveyance seat, the side portions protruding forward may be provided on respective right and left sides of the headrest. The abnormality in the protrusion mechanism may be that at least one of the side portions provided on the right and left sides cannot be returned from a protruding state to a normal state. When the abnormality detection unit detects the abnormality in the protrusion mechanism, the control unit may transmit an abnormality detection signal indicating that the abnormality in the protrusion mechanism has occurred, to a conveyance control unit that controls the conveyance.

When the abnormality in the protrusion mechanism is that the side portion cannot be returned from the protruding state to the normal state, the control unit transmits the abnormality detection signal indicating the occurrence of the abnormality to the conveyance control unit, so that the conveyance control unit can perform control corresponding to the abnormality.

In addition, in the conveyance seat, the conveyance control unit may be able to switch the conveyance between an autonomous driving mode and a manual driving mode. In a case where the abnormality detection unit detects the abnormality in the protrusion mechanism, when the conveyance is in the manual driving mode, the control unit may perform a safety operation process using the conveyance control unit to switch the conveyance to the autonomous driving mode and to cause the vehicle to make a safe movement.

When the side portion cannot be returned from the protruding state to the normal state, it is dangerous to drive manually, so that the conveyance is allowed to travel safely by switching the conveyance to the autonomous driving mode and by performing the safety operation process.

In addition, in the conveyance seat, the control unit may prohibit switching to the manual driving mode using the conveyance control unit.

The conveyance is allowed to travel more safely by prohibiting the switching to the manual driving mode.

In addition, in the conveyance seat, the control unit may notify, via the conveyance control unit or directly, an occupant of the conveyance that the safety operation process is performed since the abnormality in the protrusion mechanism is detected.

A sense of security is given to the occupant by notifying the occupant that the safety operation process is performed due to the detection of the abnormality in the protrusion mechanism.

In addition, in the conveyance seat, the notification may be performed using at least one of audio generation means, video display means, lighting means, and vibration generation means provided in the conveyance or the conveyance seat.

The occupant can be reliably notified of the detection of the abnormality by using at least one of the audio generation means, the video display means, the lighting means, and the vibration generation means.

In addition, in the conveyance seat, the conveyance control unit may be able to switch the conveyance between an autonomous driving mode and a manual driving mode. In a case where the abnormality detection unit detects the abnormality in the protrusion mechanism, when the conveyance is in the autonomous driving mode and an occupant selects the manual driving mode, the control unit may perform a second safety operation process using the conveyance control unit to switch the conveyance to the manual driving mode and to cause the conveyance to make a safe movement.

While the conveyance is in the manual driving mode, as the second safety operation process, for example, the control unit notifies the dealer or the like of the occurrence of a failure in the headrest using the conveyance control unit, so that the safety of the occupant can be ensured while the conveyance is manually driven.

### Advantageous Effects of Invention

According to the conveyance seat of the present invention, in a case where the abnormality detection unit provided in the seat back detects an abnormality in the protrusion mechanism of the headrest, when the rearward tilt angle of the seat back is more than the predetermined angle, the control unit causes the seat back to rotate until the rearward tilt angle of the seat back reaches the predetermined angle, and prohibits the rotation of the seat back when the rearward tilt angle of the seat back is the predetermined angle or less. Since the seat back is not tilted rearward by more than the predetermined angle, for example, the head of the occupant can be located within the protection range of the curtain airbag provided in the conveyance, so that even when there is an abnormality in the protrusion mechanism, the safety of the occupant can be ensured.

In addition, by detecting an abnormality in one of the side portions provided on the right and left sides, the seat back return process or the seat back rotation prohibition process can be performed, and the safety of the occupant can be ensured.

In addition, by performing the seat back return process and the seat rotation process only when an abnormality is detected at least in the side portion closer to the window side of the conveyance, for example, when an abnormality is detected only in the side portion on the interior side, the seat back return process and the seat rotation process cannot be performed, and the relaxed state of the vehicle seat can be continued. On the other hand, by performing the seat back return process and the seat rotation process when an abnormality in the side portion closer to the window side is detected, the safety of the occupant can be ensured.

In addition, since the control unit transmits the abnormality detection signal to the conveyance control unit, the conveyance control can unit perform control corresponding to the abnormality in the protrusion function. In addition, a sense of security is given to the occupant by notifying the occupant that the seat back return process or the seat back rotation prohibition process is performed since the abnormality in the protrusion mechanism is detected.

In addition, the occupant can be reliably notified of the detection of the abnormality by using at least one of the audio generation means, the video display means, the lighting means, and the vibration generation means.

In addition, when the side portion of the headrest cannot protrude, the conveyance is allowed to travel more safely by setting the manual driving mode.

In addition, when the side portion of the headrest cannot protrude, the conveyance is allowed to travel more safely by prohibiting the transition to the autonomous driving mode and by allowing only the manual driving mode. In addition, when the abnormality in the protrusion mechanism is that the side portion cannot be returned from the protruding state to the normal state, the control unit transmits the abnormality detection signal indicating the occurrence of the abnormality to the conveyance control unit, so that the conveyance control unit can perform control corresponding to the abnormality.

In addition, when the side portion cannot be returned from the protruding state to the normal state, it is dangerous to drive manually, so that the conveyance is allowed to travel safely by switching the conveyance to the autonomous driving mode and by performing the safety operation process.

In addition, the conveyance is allowed to travel more safely by prohibiting the switching to the manual driving mode.

In addition, a sense of security is given to the occupant by notifying the occupant that the safety operation process is performed due to the detection of the abnormality in the protrusion mechanism.

In addition, the occupant can be reliably notified of the detection of the abnormality by using at least one of the audio generation means, the video display means, the lighting means, and the vibration generation means.

While the conveyance is in the manual driving mode, as the second safety operation process, for example, the control unit notifies the dealer or the like of the occurrence of a failure in the headrest using the conveyance control unit, so that the safety of the occupant can be ensured.

### DESCRIPTION OF EMBODIMENT

Hereinafter, a configuration of a conveyance seat according to a fourth embodiment will be described with reference to the drawings. However, the embodiment to be described below is provided to facilitate understanding of the present invention, and does not limit the present invention. Namely, the present invention can be modified or improved without departing from the concept of the present invention, and it goes without saying that the present invention includes equivalents thereof.

In addition, in the following description, the contents regarding the materials, shapes, and sizes of seat components are merely one specific example, and do not limit the present invention.

Incidentally, hereinafter, a vehicle seat mounted in a vehicle will be provided as one example of the conveyance seat, and a configuration example of the vehicle seat will be described. However, the present invention is not limited to vehicle seats mounted in ground traveling conveyances including wheels such as an automobile and a train, and is also applicable to, for example, seats mounted in an aircraft, a ship, and the like moving in places other than the ground.

In addition, in the following description, a “front to rear direction” is a front to rear direction of the vehicle seat, and is a direction that coincides with an advancing direction when the vehicle travels. In addition, a “seat width direction” is a lateral width direction of the vehicle seat (in other words, a width direction of a seat body), and is a direction that coincides with a right to left direction when viewed from an occupant seated in the vehicle seat. In addition, an “up to down direction” is an up to down direction of the vehicle seat, and is a direction that coincides with a vertical direction when the vehicle travels on a horizontal surface.

In addition, a “vehicle outer side” or a “window side” in the seat width direction refer to a side closer to the outside of a vehicle body (for easy understanding, a side close to a nearest door or window), and a “vehicle inner side” or an “interior side” refers to a side closer to the inside of the vehicle body (for easy understanding, a side separated from a nearest door).

In addition, in the following description, unless otherwise specified, “rotation” refers to a rotational operation about an axis along the seat width direction.

Incidentally, unless otherwise specified, the shape, position, posture, and the like of each part of the vehicle seat to be described below will be described assuming that the vehicle seat is in a seated state.

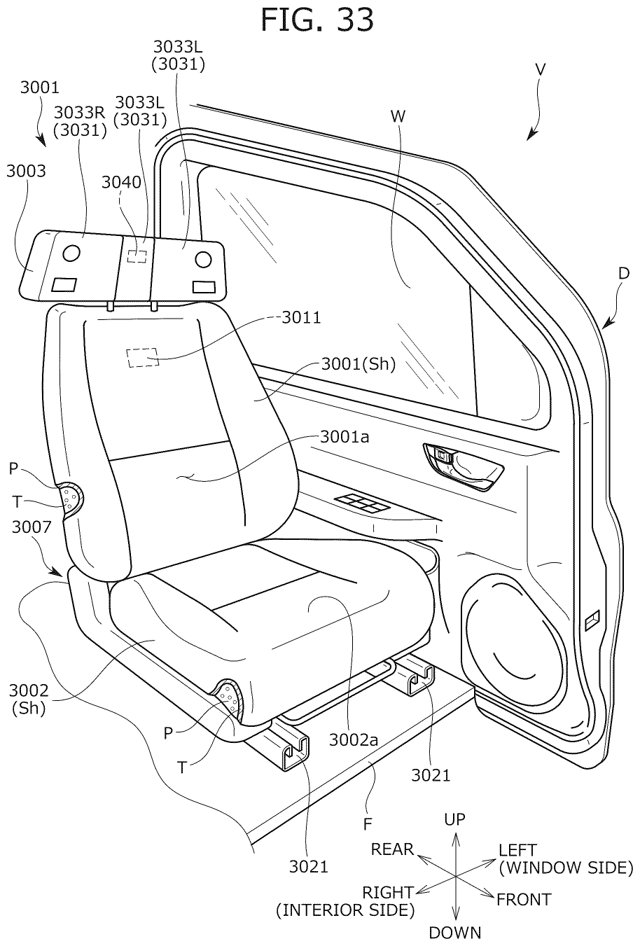

A basic configuration of a vehicle seat according to the third embodiment (hereinafter, a vehicle seat S3000) will be described with reference to FIG. 33. FIG. 1 is a perspective view of the vehicle seat S3000 mounted in a vehicle V such as an automobile, and in FIG. 33, for convenience of illustration, a part of the vehicle seat S3000 is shown with a cushion trim cover T or a pad P removed.

### <<Vehicle Seat S3000>>

The vehicle seat S3000 is a seat which is disposed on a vehicle body floor F that defines a bottom portion of a passenger compartment R and in which an occupant H of the vehicle V is seated. In the present embodiment, the vehicle seat S3000 is used as a front seat corresponding to a front seat of the vehicle. The vehicle seat S3000 is disposed on the side of a driver's seat to form a front passenger's seat. However, the vehicle seat S3000 is not limited thereto, and may be the driver's seat and can also be used as a seat of rear seats. The vehicle seat S3000 can also be used as a middle seat in a second row or a rear seat in a third row in a vehicle including three rows of seats in the front to rear direction.

In addition, as shown in FIG. 33, vehicle doors D through which the occupant gets in and out of the vehicle V are provided on the vehicle outer side of the driver's seat and the front passenger's seat. The vehicle doors D are provided with respective windows W through which the occupant can visually check the right and left sides of the vehicle V.

As shown in FIG. 33, the vehicle seat S3000 includes a seat back 3001 serving as a backrest portion that supports the back of a seated occupant; a seat cushion 3002 serving as a seating portion that supports the buttocks of the seated occupant; and a headrest 3003 that supports the head of the occupant.

In addition, the vehicle seat S3000 includes a reclining mechanism 3007 that supports the seat back 3001 so as to be adjustable in angle with respect to the seat cushion 3002, and the seat back 3001 is rotatably attached to the seat cushion 3002.

In addition, the headrest 3003 is provided with a protrusion mechanism 3031 of which right and left side portions protrude forward. Hereinafter, the seat back 3001 and the seat cushion 3002 will be described, and thereafter, the headrest 3003 including the protrusion mechanism 3031 will be described in detail.

### <Seat Back 3001>

The seat back 3001 extends in the up to down direction, and has a substantially rectangular parallelepiped shape having surfaces facing each other substantially in the front to rear direction. A front surface of the seat back 3001 forms a support surface 3001a that supports the back of the occupant H. The support surface 3001a is recessed rearward at substantially the center in the right to left direction, and is inclined slightly rearward toward the upper side. Accordingly, the support surface 3001a has a shape corresponding to the back of the occupant, and the back of the occupant H is supported by the support surface 3001a.

### <Seat Cushion 3002>

The seat cushion 3002 has a substantially rectangular parallelepiped shape having surfaces facing each other substantially in the up to down direction, and an upper surface of the seat cushion 3002 forms a seating surface 3002a for one occupant. The seating surface 3002a is recessed downward at substantially the center in the right to left direction, and is inclined slightly downward toward the lower side in the front to rear direction. Accordingly, the seating surface 3002a has a shape corresponding to the buttocks and thighs of the occupant H, and when the occupant H is seated, the buttocks and thighs of the occupant H are disposed on the seating surface 3002a.

Incidentally, the seat back 3001 and the seat cushion 3002 may be collectively referred to as a seat body Sh.

### <Pad P and Cushion Trim Cover T>

A seat back frame serving as a skeleton of the seat back 3001 is provided inside the seat back 3001 (not shown). In addition, a seat cushion frame serving as a skeleton of the seat cushion 3002 is also provided inside the seat cushion 3002 (not shown). The pad P and the cushion trim cover T (cushion cover) are provided around the seat cushion frame and the seat back frame. The pad P is, for example, a urethane base material molded by foam molding using a urethane foam material, and the cushion trim cover T is made of, for example, a skin material such as cloth, synthetic leather, or genuine leather.

### <Reclining Mechanism 3007>

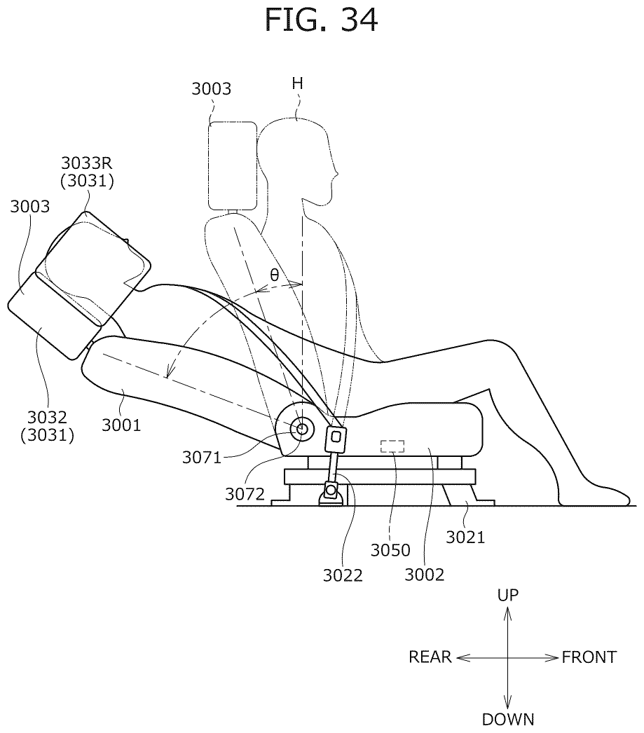

As shown in FIG. 34, the vehicle seat S3000 has a reclining function that changes a rearward tilt angle θ of the seat back 3001 with respect to the vertical direction. More specifically, the known reclining mechanism 3007 is provided at a lower end of the seat back 3001, and the seat back 3001 is rotatably supported at a rear end of the seat cushion 3002. The seat back 3001 is connected to the seat cushion 3002 so as to be adjustable in angle through rotation. The reclining mechanism 3007 is a mechanism that adjusts the angle where the seat back 3001 is tilted rearward with respect to the vertical direction (hereinafter, referred to as the rearward tilt angle θ), and the seat back 3001 is coupled to the rear end of the seat cushion 3002 at the lower end thereof so as to be tilted forward and rearward.

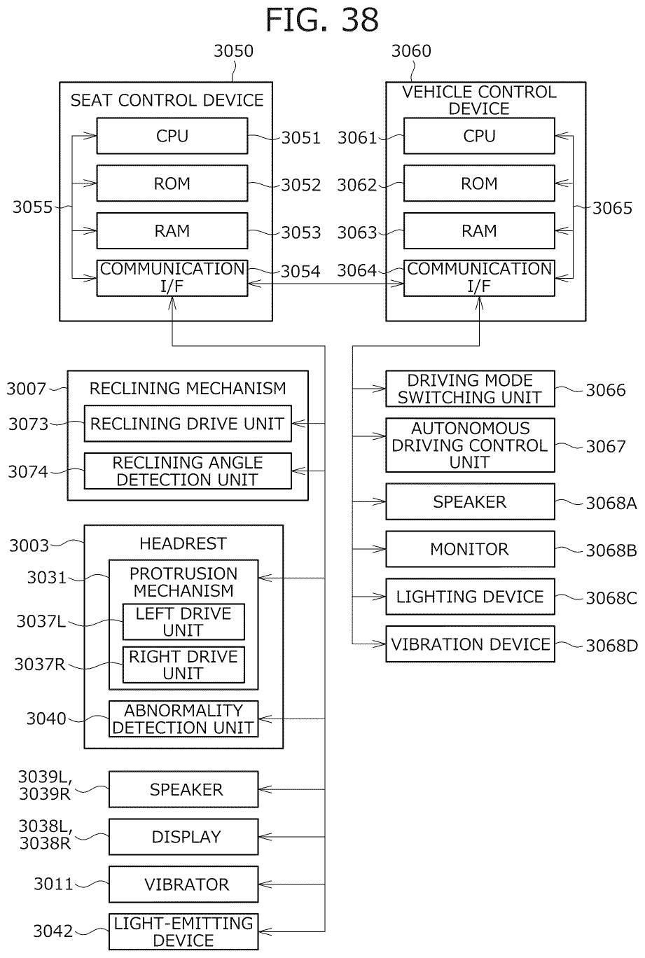

As one example, the reclining mechanism 3007 includes a reclining rod 3071 (rotating shaft) connected to a rod (not shown) disposed at a lower end portion of the seat back 3001 in the seat width direction, and a guide 3072 that rotatably supports the reclining rod 3071. Further, the vehicle seat S3000 includes a reclining drive unit 3073 (refer to FIG. 38) that rotates the reclining rod 3071. The reclining drive unit 3073 that rotates the reclining rod 3071 is composed of, for example, a motor.

In addition, the vehicle seat S3000 includes a reclining angle detection unit 3074 (refer to FIG. 38) that detects the rearward tilt angle θ of the seat back 3001 with respect to the vertical direction. For example, the reclining angle detection unit 3074 is provided on the reclining rod 3071 at a position opposite to the guide 3072.

### <Slide Rail 3021>

In addition, as shown in FIG. 33, a slide rail 3021 is installed at a lower portion of the vehicle seat S3000. The vehicle seat S3000 is attached to the vehicle body floor F in a state where the vehicle seat S3000 is slidably movable in the front to rear direction by the slide rail 3021.

The slide rail 3021 is a device that moves the vehicle seat S3000 along the front to rear direction in a sliding manner, and has a known structure (structure of a general slide rail mechanism). The slide rail 3021 includes lower rails fixed onto the vehicle body floor F, and upper rails that are slidably movable with respect to the lower rails. The upper rails are slidable with respect to the lower rails fixed to the vehicle body.

In addition, the vehicle seat S3000 is provided with a seat belt device 3022 (refer to FIG. 34) including a shoulder belt that restrains the occupant H.

### <Headrest 3003>

As shown in FIGS. 33 to 36, the headrest 3003 is disposed on the upper side of the seat back 3001 along the seat width direction, and is formed in a laterally elongated shape in which the length in the seat width direction is longer than the length in the seat front to rear direction.

The headrest 3003 is a so-called butterfly type, and includes the protrusion mechanism 3031 of which the right and left side portions protrude forward. In the present embodiment, the headrest 3003 includes, as the protrusion mechanism 3031, a main portion 3032 connected to an upper end of the seat back 3001 via two headrest pillars 3032a; a left side portion 3033L provided on the left side of the main portion 3032; and a right side portion 3033R provided on the right side of the main portion 3032. The main portion 3032 faces substantially forward, and includes a surface (main contact surface 3034) having a substantially rectangular shape. The main portion 3032 comes into contact with a rear surface of the head of the seated occupant H at the main contact surface 3034 to support the rear surface of the head of the occupant H from the rear.

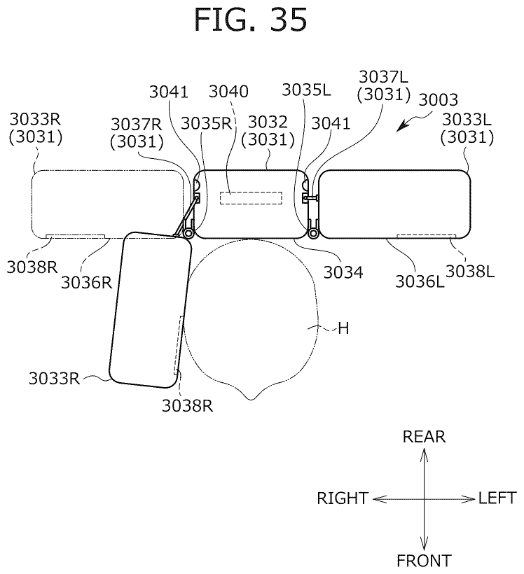

The left side portion 3033L has a substantially rectangular parallelepiped shape. As shown in FIG. 35, the left side portion 3033L is connected to a left edge of the main contact surface 3034 at one ridge via a hinge 3035L, and is connected to the main portion 3032 so as to be rotatable about the up to down direction as an axis. Accordingly, the left side portion 3033L can be displaced between a use position where one wall surface (hereinafter, a left contact surface 3036L) faces substantially forward and is continuous with the main contact surface 3034 and a support position where the left contact surface 3036L faces rightward and is located on the left of the head of the occupant H. When the left side portion 3033L is at the support position, it is preferable that the angle formed by the left contact surface and the main contact surface is 85 degrees or more and 105 degrees or less, and in the present embodiment, the angle is approximately 95 degrees. The hinge 3035L is provided with a coil spring (not shown) that biases the left side portion 3033L toward the use position.

The right side portion 3033R has a substantially rectangular parallelepiped shape. The right side portion 3033R is connected to a right edge of the main contact surface at one ridge via a hinge 3035R, and is connected to the main portion 3032 so as to be rotatable about the up to down direction as an axis. Accordingly, the right side portion 3033R can be displaced between a use position (two-dot chain line) where one wall surface (hereinafter, a right contact surface 3036R) faces substantially forward and is continuous with the main contact surface 3034 and a support position (solid line) where the right contact surface 3036R faces leftward and is located on the right side of the head of the occupant H. When the right side portion 3033R is at the support position, it is preferable that the angle formed by the right contact surface 3036R and the main contact surface 3034 is 85 degrees or more and 105 degrees or less, and in the present embodiment, the angle is approximately 95 degrees. The hinge 3035R is provided with a coil spring (not shown) that biases the right side portion 3033R toward the use position.

### <Left Drive Unit 3037L and Right Drive Unit 3037R>

An actuator (hereinafter, a left drive unit 3037L) that rotates the left side portion 3033L with respect to the main portion 3032 is provided between the main portion 3032 and the left side portion 3033L. In addition, an actuator (hereinafter, a right drive unit 3037R) that rotates the right side portion 3033R with respect to the main portion 3032 is provided between the main portion 3032 and the right side portion 3033R. In the present embodiment, as shown in FIG. 35, the left drive unit 3037L and the right drive unit 3037R are supported by a left side portion and a right side portion of the main portion 3032 corresponding thereto, respectively, so as to be rotatable about the respective up to down direction as axes. Each of the left drive unit 3037L and the right drive unit 3037R is extendable and retractable, and as shown in FIG. 35, by the extension and retraction of the left drive unit 3037L, the left side portion 3033L is rotated about the axis of the hinge 3035L and is displaced between the use position (two-dot chain line) and the support position (solid line). Similarly, the right side portion 3033R is also displaced between the use position and the support position by the extension and retraction of the right drive unit 3037R.

### <Left Display 3038L and Right Display 3038R>

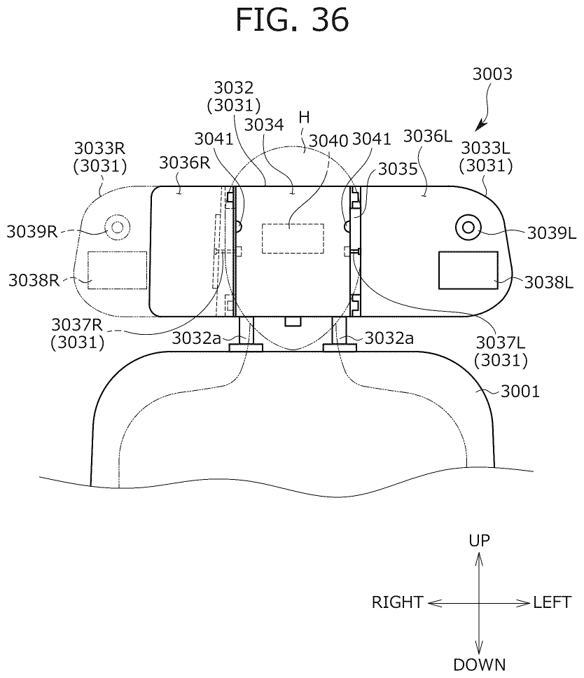

As shown in FIG. 36, displays 3038L and 3038R are provided as video display means on the left contact surface 3036L of the left side portion 3033L and the right contact surface 3036R of the right side portion 3033R, respectively. The displays 3038L and 3038R are each so-called thin organic EL displays, and are adhered to the left contact surface 3036L and the right contact surface 3036R, respectively. Hereinafter, the display provided on the left side portion 3033L will be referred to as the left display 3038L, and the display provided on the right side portion 3033R will be referred to as the right display 3038R.

### <Light-Emitting Device>

Incidentally, in the headrest 3003 of the present embodiment, the left side portion 3033L and the right side portion 3033R are provided with the displays 3038L and 3038R; however, a light-emitting device 3042 (lighting means) 41 composed of a plurality LED of elements that are substantially horizontally arranged may be provided instead of the displays 3038L and 3038R. The light-emitting device 3042 is connected to a seat control device 3050 to be described later. The light-emitting device 3042 can notify the occupant H of a message or the like through the seat control device 3050 controlling the light emission and timing of each of the LED elements included in the light-emitting device 3042.

### <Left Speaker 3039L and Right Speaker 3039R>

As shown in FIG. 36, speakers 3039L and 3039R are provided as audio generation means on the left contact surface 3036L of the left side portion 3033L and the right contact surface 3036R of the right side portion 3033R, respectively.

The speakers 3039L and 3039R are disposed at upper portions of the displays 3038L and 3038R, respectively, and are adhered to the left contact surface 3036L and the right contact surface 3036R, respectively.

Each of the speakers 3039L and 3039R is connected to the seat control device 3050 to be described later. The seat control device 3050 can cause the speakers 3039L and 3039R to issue a beep sound, an alarm sound, a voice message, music, or the like. Hereinafter, the speaker provided on the left side portion 3033L will be referred to as the left speaker 3039L, and the speaker provided on the right side portion 3033R will be referred to as the right speaker 3039R.

In addition, an abnormality detection unit 3040 that detects an abnormality in the left drive unit 3037L and the right drive unit 3037R is provided inside the main portion 3032. The abnormality detection unit 3040 measures, for example, the rotation speed of a motor provided to extend and retract the left drive unit 3037L and the right drive unit 3037R. When the rotation speed of the motor does not reach a predetermined rotation speed even though the left drive unit 3037L and the right drive unit 3037R are driven, it is determined that the left side portion 3033L or the right side portion 3033R is not rotated and is not at an appropriate angle.

Incidentally, the abnormality detection unit 3040 is not limited to this detection method, and may detect whether or not the left side portion 3033L or the right side portion 3033R is at the use position or the support position, using optical sensors 3041 provided on the right and left sides of the main portion 3032. When the abnormality detection unit 3040 detects an abnormality in the protrusion mechanism 3031, the abnormality detection unit 3040 outputs an abnormality detection signal indicating the abnormality to the seat control device 3050 to be described later. The optical sensor 3041 may be a laser sensor, a Lidar sensor, or the like.

### <Seat Control Device 3050>

The vehicle seat S3000 is provided with the seat control device 3050 that controls the reclining mechanism 3007, the protrusion mechanism 3031, or the like. For example, the seat control device 3050 is disposed below the seat cushion 3002. FIG. 38 is a block diagram showing a configuration of the seat control device 3050. The seat control device 3050 is a microcomputer including a central processing unit (CPU 3051), storage devices such as a ROM 3052 and a RAM 3053, a communication interface 3054, and the like. Incidentally, the CPU 3051, the ROM 3052, the RAM 3053, and the communication interface 3054 are connected by a bus 3055.

In addition, the seat control device 3050 is connected to the reclining mechanism 3007, the protrusion mechanism 3031 of the headrest 3003, and the left display 3038L, the right display 3038R, the left speaker 3039L, the right speaker 3039R, a vibrator 3011, and the abnormality detection unit 3040 provided on the headrest 3003. More specifically, the seat control device 3050 outputs a signal to each of the left drive unit 3037L and the right drive unit 3037R of the protrusion mechanism 3031 and the left display 3038L, the right display 3038R, the speaker 3039L, the speaker 3039R, the vibrator 3011, and the light-emitting device 3042 of the headrest 3003 via the communication interface 3054. In addition, the seat control device 3050 receives a signal from the abnormality detection unit 3040 via the communication interface 3054.

The ROM 3052 stores a program for controlling the positions of the seat back 3001 of the vehicle seat S3000 and the side portions of the headrest 3003. By loading the program stored in the ROM 3052 into the RAM 3053 and by causing the CPU 3051 to execute the program, control is performed to tilt the seat back 3001 rearward (reclining) to a predetermined angle β or to cause the side portions 3033L and 3033R of the headrest 3003 to protrude forward.

In the vehicle seat S3000, for example, in an upright state where the seat back 3001 is not tilted rearward, as shown in FIG. 33, the left side portion 3033L and the right side portion 3033R are disposed side by side on an extension line of the main portion 3032 in the seat width direction.

For example, when the seat back 3001 is tilted rearward and in a relaxed state, the seat control device 3050 causes the left drive unit 3037L to move the left side portion 3033L from the support position to the use position where the left side portion 3033L protrudes toward the front of the vehicle. In addition, at the same time, as shown by solid lines in FIGS. 35 and 36, the seat control device 3050 causes the right drive unit 3037R to move the right side portion 3033R from the support position to the use position where the right side portion 3033R protrudes to the front of the vehicle.

In a state where the left side portion 3033L and the right side portion 3033R are moved to the use positions, as shown in FIG. 34, the left side portion 3033L and the right side portion 3033R cover the side parts of the head of the occupant H, so that the head of the occupant H can be protected in the event of a side collision.

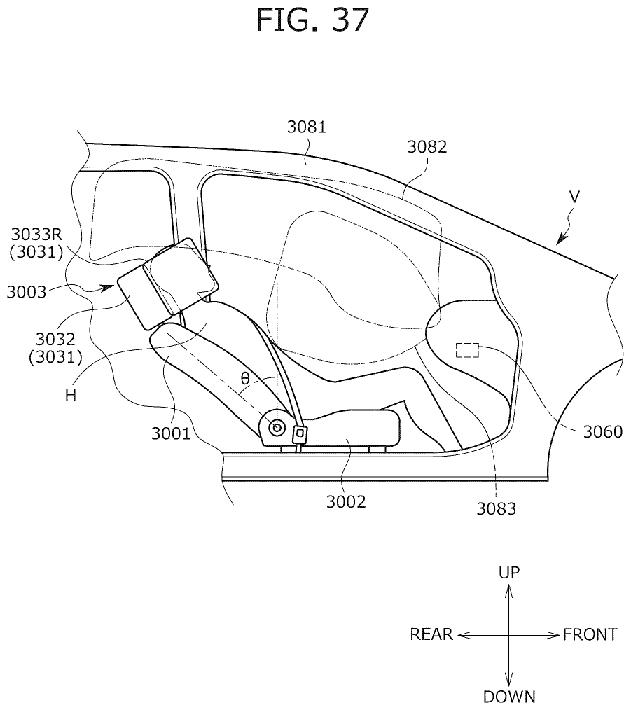

For example, the vehicle V is provided with a vehicle control device 3060 (conveyance control unit) that controls the traveling of the vehicle V. For example, the vehicle control device 3060 is provided inside a dashboard or an instrument panel disposed on the front side in the vehicle interior (refer to FIG. 37).

FIG. 38 is a block diagram showing a configuration of the vehicle control device 3060. The vehicle control device 3060 is a microcomputer including a central processing unit (CPU 3061), storage devices (storage units) such as a ROM 3062 and a RAM 3063, a communication interface 3064, and the like. The CPU 3061, the ROM 3062, the RAM 3063, and the communication interface 3064 are connected by a bus 3065.

The communication interface 3064 is connected to the communication interface 3054 of the seat control device 3050, and can receive an abnormality detection signal or the like transmitted from the seat control device 3050. In addition, the vehicle control device 3060 is connected to a driving mode switching unit 3066 that switches the driving mode of the vehicle V, and an autonomous driving control unit 3067, and can control the driving mode switching unit 3066 and the autonomous driving control unit 3067. In addition, the vehicle control device 3060 is connected to a monitor 3068A (video display means), a speaker 3068B (audio generation means), a lighting device 3068C (lighting means), and a vibration device 3068D (vibration generation means) provided in the vehicle interior, and can control these devices.

The driving mode switching unit 3066 can switch the driving mode to one of an autonomous driving mode and a manual driving mode. The occupant H can switch the driving mode between the autonomous driving mode and the manual driving mode by means of the driving mode switching unit 3066 by selecting the driving mode using a switch, a touch panel, or the like mounted in the vehicle V. Furthermore, when the autonomous driving mode is selected, the vehicle V is autonomously driven by the autonomous driving control unit 3067.

In addition, the vehicle control device 3060 can control the operation of the reclining mechanism 3007 via the seat control device 3050. More specifically, by rotating the reclining rod 3071 through operating the reclining drive unit 3073 of the reclining mechanism 3007, the seat back 3001 can be tilted rearward or the seat back 3001 can be returned to an upright state.

When the seat control device 3050 receives a signal indicating that the autonomous driving mode is selected by the vehicle control device 3060, the seat control device 3050 can operate the reclining drive unit 3073 of the reclining mechanism 3007 to bring the seat back 3001 into a state where the seat back 3001 is greatly reclined rearward (reclining state). More specifically, the reclining mechanism 3007 is driven until the rearward tilt angle θ detected by the reclining angle detection unit 3074 becomes, for example, 50 degrees or more.

When the vehicle V is in the autonomous driving mode and the vehicle seat S3000 is in a reclining state, the seat control device 3050 operates the protrusion mechanism 3031 of the headrest 3003 to move the left side portion 3033L and the right side portion 3033R of the headrest 3003 to the use positions at the front of the vehicle.

In addition, when the driving mode is switched from the autonomous driving mode to the manual driving mode, the seat control device 3050 causes the seat back 3001 to rotate forward so as to return to an upright state. At this time, the left side portion 3033L and the right side portion 3033R of the headrest 3003 are moved to the support positions by the left drive unit 3037L and the right drive unit 3037R.

FIG. 37 shows a relationship between the rearward tilt angle θ of the seat back 3001 with respect to the vertical direction and the positions of the side portions 3033L and 3033R of the headrest 3003 in the autonomous driving mode. As shown in FIG. 37, in the autonomous driving mode, the seat back 3001 is greatly reclined rearward such that the rearward tilt angle θ reaches 50 degrees or more. At this time, the side portions 3033L and 3033R protrude forward to protect the head of the occupant H.

As shown in FIG. 37, in the vehicle V, a roof-side rail 3081 is provided at an upper portion of the vehicle substantially along the vehicle front to rear direction. A curtain airbag 3082 is provided, as a head protection airbag that protects the head of the occupant H in the event of a side collision, inside the roof-side rail 3081 in the vehicle width direction and on a back surface side of an outer end portion of a roof headlining in the vehicle width direction. In addition, in the vehicle V, a front airbag 3083 that protects the occupant H in the event of a frontal collision is provided in the dashboard on the front side in the vehicle front to rear direction. FIG. 37 shows a state where the curtain airbag 3082 and the front airbag 3083 are deployed. The curtain airbag 3082 is inflated and deployed downward in the vehicle up to down direction in a curtain shape in the event of a side collision to protect the head of the occupant H in an area (protection range) overlapping the curtain airbag 3082. However, as shown in FIG. 37, when the seat back 3001 is greatly tilted rearward, there is a possibility that the head of the seated occupant H is out of the protection range of the curtain airbag 3082. For that reason, when the rearward tilt angle θ is more than the predetermined angle β, the side portions of the headrest 3003 protrude forward to protect the head of the occupant H in the event of a side collision. Incidentally, the predetermined angle β with respect to the vertical direction is an angle where the head of the occupant H can be protected by the curtain airbag 3082, and for example, the predetermined angle β is 30 degrees as one example, and is set between 10 degrees and 50 degrees depending on the protection range of the curtain airbag 3082.

In such a manner, even in a state where the seat back 3001 is in a relaxed state, the protrusion mechanism 3031 is provided in the headrest 3003 to protect the head of the occupant H from a side collision, but the protrusion mechanism 3031 may fail for any reason. When the side portions 3033L and 3033R of the headrest 3003 do not protrude forward due to a failure, the head of the occupant cannot be sufficiently protected, which is a risk, so that in the vehicle seat S3000 of the present embodiment, the headrest 3003 is provided with the abnormality detection unit 3040 that detects an abnormality in the protrusion mechanism 3031. When the abnormality detection unit 3040 detects an abnormality, for example, the seat control device 3050 is configured to perform a seat back return process to return the vehicle seat S3000 in a relaxed state to the original upright state, and to prohibit transition to the relaxed state even after returning to the upright state.

<<Control when Side Portion does not Protrude>>

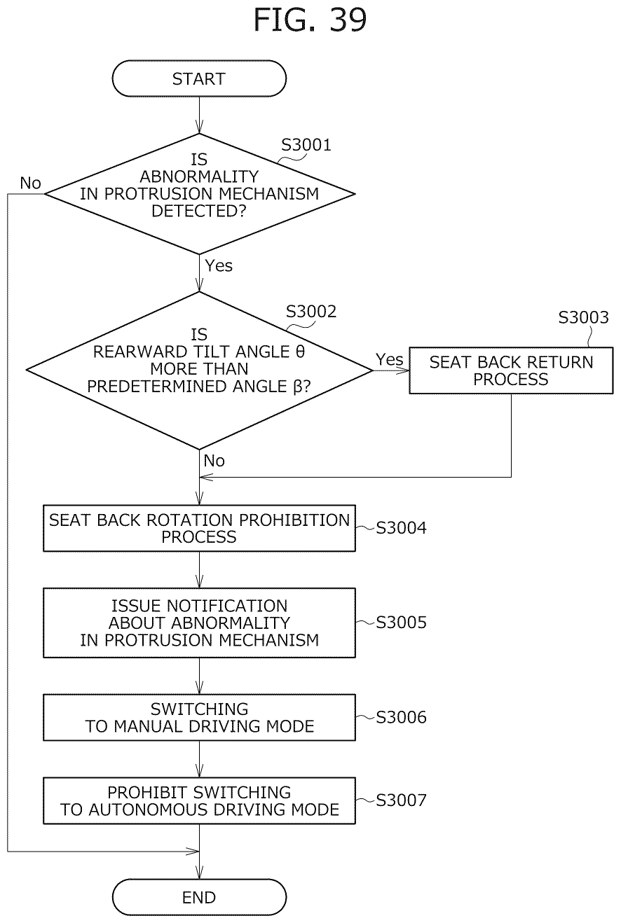

Next, one example of the flow of specific control performed by the seat control device 3050 will be described. FIG. 39 is a flowchart showing the flow of control when one of the left side portion 3033L and the right side portion 3033R of the protrusion mechanism 3031 does not move from the support position to the use position, namely, when one side portion does not protrude forward.

The seat control device 3050 causes the abnormality detection unit 3040 to check the operation of the protrusion mechanism 3031 to determine if there is an abnormality (step S3001). At this time, for example, the abnormality detection unit 3040 checks whether or not the motor rotates to the predetermined rotation speed when the seat control device 3050 operates the left drive unit 3037L and the right drive unit 3037R to move the left side portion 3033L and the right side portion 3033R from the support positions to the use positions. When the predetermined rotation speed is not reached, it is determined that the left drive unit 3037L or the right drive unit 3037R does not operate normally, and the abnormality detection unit 3040 transmits an abnormality detection signal indicating that the left side portion 3033L or the right side portion 3033R is not moved to the use position, to the seat control device 3050.

Incidentally, the method for detecting an abnormality by measuring the rotation speed of the motor is one example, and whether or not the left side portion 3033L and the right side portion 3033R are moved to the use positions when moved is checked using the optical sensors 3041 as the abnormality detection unit 3040. When the abnormality detection signal is not received from the abnormality detection unit 3040 (No in step S3001), the seat control device 3050 ends the process without taking any particular action.

When the abnormality detection signal indicating that an abnormality is detected is received from the abnormality detection unit 3040, the seat control device 3050 executes the next step S3002. At this time, the seat control device 3050 may transmit the abnormality detection signal indicating that an abnormality is detected, to the vehicle control device 3060.

When an abnormality in the protrusion mechanism 3031 is detected (Yes in step S3001), namely, when the seat control device 3050 receives the abnormality detection signal, the seat control device 3050 checks the state of the seat back 3001 using the reclining angle detection unit 3074. Specifically, the rearward tilt angle θ of the seat back 3001 is acquired from the reclining angle detection unit 3074, and it is checked whether or not the rearward tilt angle θ is more than the predetermined angle β (step S3002).

When the rearward tilt angle θ is larger than the predetermined angle β (Yes in step S3002), the seat back 3001 is in a relaxed state, and there is a risk that the head of the occupant H is out of the protection range of the curtain airbag 3082. For that reason, the seat back return process is performed to rotate the seat back 3001 such that the head of the occupant H returns to the protection range of the curtain airbag 3082 (step S3003). At this time, the seat back 3001 is rotated using the reclining mechanism 3007 such that at least the rearward tilt angle θ reaches the predetermined angle β or less.

In addition, the rearward tilt angle θ where the seat back 3001 is in an upright state may be set as a second predetermined angle β2, and the seat back 3001 may be rotated until the rearward tilt angle θ of the seat back 3001 reaches the second predetermined angle β2.

After the rearward tilt angle θ of the seat back 3001 reaches the predetermined angle β or less, a seat back rotation prohibition process is executed to prohibit the seat back 3001 from transitioning to the relaxed state again (step S3004).

When the rearward tilt angle θ is smaller than the predetermined angle β (No in step S3002), the head of the occupant H is within the protection range of the curtain airbag 3082, so that the seat back rotation prohibition process is executed to prohibit the seat back 3001 from transitioning to the relaxed state (step S3004).

Specifically, the rotation of the seat back 3001 by the predetermined angle β or more by the reclining mechanism 3007 is prohibited. By prohibiting the rotation of the seat back 3001, the head of the occupant H being out of the protection range of the curtain airbag 3082 is suppressed.

Next, the seat control device 3050 notifies the seated occupant H that the seat back return process and the seat back rotation prohibition process are performed since an abnormality in the headrest is detected (step S3005). By issuing a notification, the occupant H can know the reason that the seat back 3001 is returned to the upright state, and the seat control device 3050 can give the occupant H a sense of security.

The notification to the occupant H may be performed using the displays 3038L and 3038R that are video display means provided on the vehicle seat S3000. At this time, a message indicating that the protrusion mechanism 3031 has failed is displayed on the displays 3038L and 3038R.

In addition, the notification may be performed using the speakers 3039L and 3039R that are audio generation means provided on the vehicle seat S3000. An audio indicating that the protrusion mechanism 3031 has failed is issued from the speakers. At this time, the notified audio may be an alarm sound or the like.

In addition, the seat control device 3050 may issue a notification using the vibrator 3011 that is vibration generation means provided in the vehicle seat S3000. In the left side portion 3033L and the right side portion 3033R of the headrest 3003, when the light-emitting device 3042 that is lighting means is provided instead of the displays 3038L and 3038R, a notification may be issued by the light-emitting device 3042. In addition, the seat control device 3050 may issue a notification through a combination of these devices.

Namely, the seat control device 3050 may perform a notification to the occupant H through sound, audio, lighting, video, vibration, and the like using the displays 3038L and 3038R, the speakers 3039L and 3039R, the vibrator 3011, and the light-emitting device 3042. A notification may be performed through a combination of sound, audio, lighting, video, vibration, and the like.

A notification to the occupant may be performed not only using the displays 3038L and 3038R and the like provided on the vehicle seat S3000, but also using the monitor 3068A and the like provided in the vehicle V. The notification is performed by the vehicle control device 3060 after the vehicle control device 3060 receives the abnormality detection signal from the seat control device 3050. A notification is performed through sound, audio, lighting, video, vibration, and the like using the monitor 3068A, the speaker 3068B, the lighting device 3068C, the vibration device 3068D, and the like provided in the vehicle V. A notification may be performed through a combination of sound, audio, lighting, video, vibration, and the like.

When the vehicle control device 3060 can switch the driving mode between the autonomous driving mode and the manual driving mode using the driving mode switching unit 3066, the seat control device 3050 may perform a mode switching process to transmit a mode switching signal for switching from the autonomous driving mode to the manual driving mode to the vehicle control device 3060 (step S3006).

In the mode switching process, the vehicle control device 3060 checks the driving mode of the vehicle V when the vehicle control device 3060 receives the mode switching signal from the seat control device 3050, and switches the driving mode to the manual driving mode using the driving mode switching unit 3066 when the vehicle V is in the autonomous driving mode.

When the vehicle control device 3060 can switch the driving mode between the autonomous driving mode and the manual driving mode using the driving mode switching unit 3066, the seat control device 3050 may transmit an autonomous driving prohibition signal for prohibiting switching to the autonomous driving mode to the vehicle control device 3060 (step S3007).

The vehicle control device 3060 that receives the autonomous driving prohibition signal performs an autonomous driving prohibition process to prevent switching to the autonomous driving mode again when the driving mode is the manual driving mode.

The control shown in FIG. 39 is executed when an abnormality in the protrusion mechanism 3031 of the headrest 3003 is that at least one of the side portions 3033L and 3033R provided on the right and left sides cannot protrude forward. However, such control is one example, and the seat back return process or the seat back rotation prohibition process may be executed when the abnormality in the protrusion mechanism 3031 is that, of the side portions 3033L and 3033R provided on the right and left sides, at least the side portion closer to the window of the vehicle, namely, the side portion on the window side close to the curtain airbag 3082 cannot protrude.

If the side portion on the window side can protrude, even when an abnormality is detected in the side portion on the interior side opposite thereto, the head of the occupant H can be protected. For that reason, when an abnormality is detected only in the side portion on the interior side, the seat control device 3050 may execute the seat back return process and the seat back rotation prohibition process.

<<Control when Side Portion does not Return from Protruding State>>

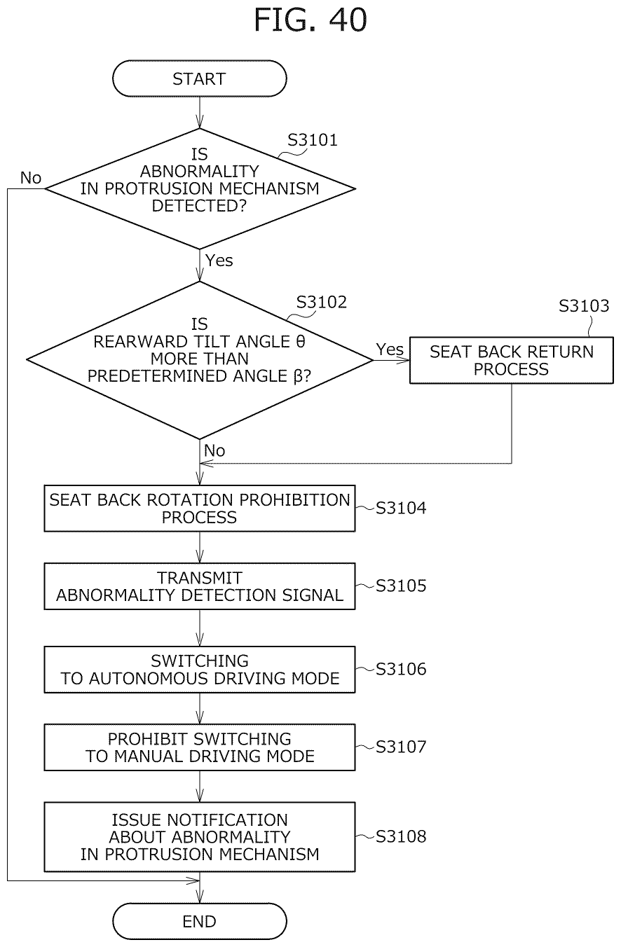

Next, another example of the flow of control performed by the seat control device 3050 will be described. FIG. 40 is a flowchart showing the flow of control when an abnormality in the protrusion mechanism 3031 of the headrest 3003 is that at least one of the left side portion and the right side portion does not return from the use position to the support position, namely, when the at least one side portion does not return from a protruding state to a normal state.

In a case where the side portion does not return from the protruding state to the original state, particularly when the vehicle seat S3000 is a driver's seat, the occupant cannot check the surroundings due to the side portion, and cannot drive safely, which is a risk. For that reason, the seat control device 3050 may switch the driving mode from the manual driving mode to the autonomous driving mode and cause the vehicle V to make safe movements using the vehicle control device 3060.

The seat control device 3050 causes the abnormality detection unit 3040 to check the operation of the protrusion mechanism 3031 to determine if there is an abnormality (step S3101). Specifically, at this time, for example, the abnormality detection unit 3040 checks whether or not the motor rotates to the predetermined rotation speed when the left drive unit 3037L and the right drive unit 3037R are operated to move the right and left side portions from the use positions to the support positions. When the predetermined rotation speed is not reached, it is determined that the left drive unit 3037L or the right drive unit 3037R does not operate normally, and the abnormality detection unit 3040 transmits an abnormality detection signal indicating that the left side portion 3033L or the right side portion 3033R cannot be moved to the support position, to the seat control device 3050.

At this time, the abnormality detection unit 3040 may detect the position of the left side portion 3033L or the right side portion 3033R using the optical sensor 3041, and detect that the left side portion 3033L or the right side portion 3033R does not return to the support position normally, namely, that the left side portion 3033L or the right side portion 3033R does not return from the protruding state to the normal state.

When the abnormality detection unit 3040 detects an abnormality in the protrusion mechanism 3031 (Yes in step S3101), namely, when the seat control device 3050 receives an abnormality detection signal, the seat control device 3050 checks the state of the seat back 3001 using the reclining angle detection unit 3074. Specifically, the rearward tilt angle θ of the seat back is acquired from the reclining angle detection unit 3074, and it is checked whether or not the rearward tilt angle θ is more than the predetermined angle β (step S3102).

When the rearward tilt angle θ is larger than the predetermined angle β (Yes in step S3102), the seat back 3001 is in a relaxed state, so that the seat back return process is performed to rotate the seat back 3001 (step S3103). By placing the seat back 3001 in an upright state, the occupant H can be notified of an abnormality in the protrusion mechanism 3031. At this time, the seat back 3001 is rotated using the reclining mechanism 3007 until at least the rearward tilt angle θ reaches the predetermined angle β or less.

In addition, the rearward tilt angle θ where the seat back 3001 is in the upright state may be set as the second predetermined angle β2, and the seat back 3001 may be rotated until the rearward tilt angle θ of the seat back 3001 reaches the second predetermined angle β2.

After the rearward tilt angle θ of the seat back 3001 reaches the predetermined angle β or less, the seat back rotation prohibition process is executed (step S3104).

When the rearward tilt angle θ is smaller than the predetermined angle β (No in step S3102), the seat control device 3050 executes the seat back rotation prohibition process to prohibit the seat back 3001 of the vehicle seat S3000 from transitioning to the relaxed state after executing the seat back return process (step S3104). Specifically, the rearward reclining and rotation of the seat back 3001 by the predetermined angle β or more by the reclining mechanism 3007 is prohibited.

At this time, when an abnormality detection signal is received from the abnormality detection unit 3040, the seat control device 3050 transmits the abnormality detection signal indicating that the left side portion or the right side portion cannot be returned from the protruding state to the normal state, to the vehicle control device 3060 (step S3105).

The vehicle control device 3060 checks whether the driving mode of the vehicle V is the autonomous driving mode or the manual driving mode. When the driving mode is the autonomous driving mode, the vehicle control device 3060 controls the vehicle V to make safe movements while remaining in the autonomous driving mode (safety operation process). At this time, for example, the vehicle control device 3060 controls the vehicle V to decelerate or controls the vehicle V to retreat to a safe place as the safety operation process. At this time, the vehicle control device 3060 may turn on a hazard lamp (step S3106).

When the vehicle V travels in the autonomous driving mode, the vehicle control device 3060 may perform a manual driving prohibition process to prohibit switching to the manual driving mode, so that the driver cannot drive manually (step S3107).

Next, the seat control device 3050 notifies the seated occupant H that the seat back 3001 is returned to the upright state, the seat back rotation prohibition process is performed, and the safety operation process is performed through the autonomous driving mode since an abnormality in the headrest 3003 is detected (step S3108). By issuing a notification, the occupant H can know the reason that the seat back 3001 is returned to the upright state and the safety operation process is performed, and the seat control device 3050 can give the occupant H a sense of security.

The notification to the occupant H may be performed using the displays 3038L and 3038R that are video display means provided on the vehicle seat S3000. A message indicating that the protrusion mechanism 3031 has failed is displayed on the displays 3038L and 3038R.

In addition, the notification may be performed using the speakers 3039L and 3039R that are audio generation means provided on the vehicle seat S3000. An audio indicating that the protrusion mechanism 3031 has failed is issued from the speakers. At this time, the seat control device 3050 may issue a notification using an alarm sound or the like.

In addition, a notification may be issued by the vibrator 3011 that is vibration generation means provided in the vehicle seat S3000. In the left side portion 3033L and the right side portion 3033R of the headrest 3003, when the light-emitting device 3042 that is lighting means is provided instead of the displays 3038L and 3038R, a notification may be issued by the light-emitting device 3042. In addition, the seat control device 3050 may issue a notification through a combination of these devices.

A notification to the occupant may be performed not only using the displays and the like provided on the vehicle seat S3000, but also using the monitor 3068A and the like provided in the vehicle V. The notification is performed by the vehicle control device 3060 after the vehicle control device 3060 receives the abnormality detection signal from the seat control device 3050. The vehicle control device 3060 issues a notification using at least one of the monitor 3068A, the speaker 3068B, the lighting device 3068C, the vibration device 3068D, and the like provided in the vehicle V. The notification may be performed through a combination of the monitor 3068A, the speaker 3068B, the lighting device 3068C, and the vibration device 3068D.

In the embodiment, when the side portions of the headrest 3003 do not return from the protruding state to the normal state, the vehicle V is set to the autonomous driving mode, and the vehicle V makes safe movements autonomously; however, this approach is one example, and during the autonomous driving mode, the occupant H may wish to engage in manual driving and select the manual driving mode. In this case, as a second safety operation process in which the vehicle V is set to the manual driving mode and performs a safe operation, the seat control device 3050 or the vehicle control device 3060 of the vehicle V may automatically notify the dealer and the like of the occurrence of a failure in the headrest. In such a manner, when an abnormality in the headrest is detected, the seat control device 3050 can ensure the safety of the occupant by causing the vehicle V to perform a safe operation via the vehicle control device 3060.

The third embodiment and the fourth embodiment will be supplementarily noted as follows.

### Third Embodiment

### (Supplementary Note 1)

A vehicle member disposed inside a vehicle, including:
a thermoelectric power generation member that converts heat into electric power;
in which the thermoelectric power generation member is provided at a predetermined portion of the vehicle member; and is configured independently of the predetermined portion.

### (Supplementary Note 2)

The vehicle member according to Supplementary Note 1,
in which the vehicle member is a vehicle seat including a seat frame serving as a skeleton, a pad material placed on the seat frame, and a skin material covering the seat frame and the pad material,
the vehicle seat includes an electric power storage member connected to the thermoelectric power generation member, and storing the electric power generated by the thermoelectric power generation member, and a connection member for connecting the thermoelectric power generation member and the electric power storage member.

### (Supplementary Note 3)

The vehicle member according to Supplementary Note 2,
in which the pad material includes an accommodation recess formed on a surface on a skin material side of the pad material in a thickness direction, and accommodating the thermoelectric power generation member,
the accommodation recess is formed on the surface on the skin material side of the pad material at a position corresponding to a portion with which the seated occupant comes into contact, and
the thermoelectric power generation member is accommodated in the accommodation recess between the pad material and the skin material.

### (Supplementary Note 4)

The vehicle member according to Supplementary Note 3,
in which the pad material has an insertion hole penetrating from the accommodation recess toward a seat frame side in the thickness direction of the pad material,
the electric power storage member is attached to the seat frame, and
the connection member extends through the insertion hole, and is connected to the electric power storage member.

### (Supplementary Note 5)

The vehicle member according to any one of Supplementary Notes 2 to 4,
in which the vehicle seat includes a drive device driven by the electric power and a control device that is connected to the drive device and that controls the drive of the drive device, and
the thermoelectric power generation member is attached in the vicinity of the drive device or the control device.

### (Supplementary Note 6)

The vehicle member according to Supplementary Note 5,
in which the drive device is a blower device that is attached to the seat frame and that blows air toward the seated occupant, and
the thermoelectric power generation member is attached in the vicinity of a drive member of the blower device.

### (Supplementary Note 7)

The vehicle member according to Supplementary Note 1,
in which the vehicle member is a vehicle door lining provided on a vehicle inner side of a vehicle door, and
the thermoelectric power generation member is attached to an upper portion or a side portion on a vehicle outer side of the vehicle door lining.

### (Supplementary Note 8)

The vehicle member according to Supplementary Note 7,
in which the vehicle door lining includes an electric power storage member connected to the thermoelectric power generation member, and storing the electric power generated by the thermoelectric power generation member, and
the thermoelectric power generation member and the electric power storage member are attached to the side portion on the vehicle outer side of the vehicle door lining, and are disposed at positions close to each other.

### (Supplementary Note 9)

The vehicle member according to Supplementary Note 7 or 8,
in which the vehicle door lining includes a light-emitting member that emits light toward an inside of the vehicle, and
the thermoelectric power generation member is attached in the vicinity of the light-emitting member.

### (Supplementary Note 10)

The vehicle member according to any one of Supplementary Notes 1 to 9,
in which the vehicle member includes a drive device that is provided inside the vehicle and that is driven by the electric power generated by the thermoelectric power generation member, an electric power storage member connected to the thermoelectric power generation member, and storing the electric power generated by the thermoelectric power generation member, and a control device that is connected to each of the thermoelectric power generation member, the electric power storage member, and the drive device, and that controls the drive of the drive device, and
the control device is connected to a power source provided on a vehicle body, controls the power source to supply electric power to the drive device when an amount of the electric power generated by the thermoelectric power generation member is less than a predetermined threshold value or when an amount of the electric power stored by the electric power storage member is less than a predetermined threshold value, controls the thermoelectric power generation member to supply the electric power to the drive device when the amount of the electric power generated by the thermoelectric power generation member is the predetermined threshold value or more, and controls the electric power storage member to supply the electric power to the drive device when the amount of the electric power stored by the electric power storage member is the predetermined threshold value or more.

### Fourth Embodiment

### (Supplementary Note 11)

A conveyance seat provided in a conveyance, including:
a seat cushion;
a seat back rotatably attached to the seat cushion;
a reclining mechanism that supports the seat back so as to be adjustable in angle with respect to the seat cushion;
a headrest provided at an upper end of the seat back and including a protrusion mechanism of which side portions protrude forward;
an abnormality detection unit that detects an abnormality in the protrusion mechanism; and
a control unit that controls operations of the reclining mechanism and the protrusion mechanism,
in which in a case where the abnormality detection unit detects an abnormality in the protrusion mechanism, when a rearward tilt angle of the seat back is more than a predetermined angle with respect to a vertical direction, the control unit performs a seat back return process using the reclining mechanism to rotate the seat back until the rearward tilt angle of the seat back reaches the predetermined angle, and when the rearward tilt angle of the seat back is the predetermined angle or less, the control unit performs a seat back rotation prohibition process to prohibit the rotation of the seat back by the reclining mechanism.

### (Supplementary Note 12)

The conveyance seat according to Supplementary Note 11,
in which the side portions protruding forward are provided on respective right and left sides of the headrest, and
the abnormality in the protrusion mechanism is that at least one of the side portions provided on the right and left sides cannot protrude forward.

### (Supplementary Note 13)

The conveyance seat according to Supplementary Note 12,
in which the side portions protruding forward are provided on respective right and left sides of the headrest, and
the abnormality in the protrusion mechanism is that, of the side portions provided on the right and left sides, at least the side portion closer to a window of the conveyance cannot protrude.

### (Supplementary Note 14)

The conveyance seat according to any one of Supplementary Notes 11 to 13,
in which when the abnormality detection unit detects the abnormality in the protrusion mechanism, the control unit transmits an abnormality detection signal indicating that the abnormality in the protrusion mechanism has occurred, to a conveyance control unit that controls the conveyance.

### (Supplementary Note 15)

The conveyance seat according to Supplementary Note 14, in which when the abnormality detection unit detects the abnormality in the protrusion mechanism, the control unit notifies, via the conveyance control unit or directly, an occupant of the conveyance that the seat back return process or the seat back rotation prohibition process is performed since the abnormality in the protrusion mechanism is detected.

### (Supplementary Note 16)

The conveyance seat according to Supplementary Note 15, in which the notification is performed using at least one of audio generation means, video display means, lighting means, and vibration generation means provided in the conveyance or the conveyance seat.

### (Supplementary Note 17)

The conveyance seat according to any one of Supplementary Notes 14 to 16,
in which the conveyance control unit can switch the conveyance between an autonomous driving mode and a manual driving mode, and
in a case where the abnormality detection unit detects the abnormality in the protrusion mechanism, when the conveyance is in the autonomous driving mode, the control unit transmits a mode switching signal for switching from the autonomous driving mode to the manual driving mode to the conveyance control unit.

### (Supplementary Note 18)

The conveyance seat according to any one of Supplementary Notes 14 to 16,
in which the conveyance control unit can switch the conveyance between an autonomous driving mode and a manual driving mode, and
when the abnormality detection unit detects the abnormality in the protrusion mechanism, an autonomous driving prohibition signal for prohibiting the conveyance from transitioning to the autonomous driving mode is transmitted to the conveyance control unit.

### (Supplementary Note 19)

The conveyance seat according to Supplementary Note 11,
in which the side portions protruding forward are provided on respective right and left sides of the headrest,
the abnormality in the protrusion mechanism is that at least one of the side portions provided on the right and left sides cannot be returned from a protruding state to a normal state, and
when the abnormality detection unit detects the abnormality in the protrusion mechanism, the control unit transmits an abnormality detection signal indicating that the abnormality in the protrusion mechanism has occurred, to a conveyance control unit that controls the conveyance.

### (Supplementary Note 20)

The conveyance seat according to Supplementary Note 19,
in which the conveyance control unit can switch the conveyance between an autonomous driving mode and a manual driving mode, and
in a case where the abnormality detection unit detects the abnormality in the protrusion mechanism, when the conveyance is in the manual driving mode, the control unit performs a safety operation process using the conveyance control unit to switch the conveyance to the autonomous driving mode and to cause the vehicle to make a safe movement.

### (Supplementary Note 21)

The conveyance seat according to Supplementary Note 20,
in which the control unit prohibits switching to the manual driving mode using the conveyance control unit.

### (Supplementary Note 22)

The conveyance seat according to Supplementary Note 20 or 21,
in which the control unit notifies, via the conveyance control unit or directly, an occupant of the conveyance that the safety operation process is performed since the abnormality in the protrusion mechanism is detected.

### (Supplementary Note 23)

The conveyance seat according to Supplementary Note 22,
in which the notification is performed using at least one of audio generation means, video display means, lighting means, and vibration generation means provided in the vehicle or the conveyance seat.

### (Supplementary Note 24)

The conveyance seat according to Supplementary Note 19,
in which the conveyance control unit can switch the conveyance between an autonomous driving mode and a manual driving mode, and
in a case where the abnormality detection unit detects the abnormality in the protrusion mechanism, when the conveyance is in the autonomous driving mode and an occupant selects the manual driving mode, the control unit performs a second safety operation process using the conveyance control unit to switch the conveyance to the manual driving mode and to cause the conveyance to make a safe movement.

### REFERENCE SIGNS LIST

### First Embodiment

V: Vehicle
S: Vehicle seat
S1: Front seat
S2: Rear seat
D: Vehicle door
W: Window
W2: Roof window
F: Vehicle body floor
H: Occupant
1: Display system
2: Passenger compartment
3: Roof
5: Center console
6: In-vehicle camera
7: In-vehicle monitor
8: Speaker
10: Seat back
11: Seat cushion
12: Ottoman
13: Headrest
14: Seat state changing mechanism
   15: Reclining mechanism
   16: Tilt mechanism
   19: Seat support unit
   20: Seat slide mechanism
      21: Upper rail
      22: Lower rail
   24: Seat rotation mechanism
25: Operation switch
30, 30A, 30B, 30C, 30D, 30E: Projector (projection device)
31: Video
32: Projector movable mechanism
34: Projector operation switch
40: ECU
   41: Processor (control unit)
   42: Memory (storage unit)
   43: Input/output interface
50: Sensor
   51: Door sensor
   52: Window sensor
   53: Incoming call sensor
   54: Seating sensor
   55: Illuminance sensor
60: Sunshade (illuminance adjustment mechanism)
61: Roof sunshade (illuminance adjustment mechanism)
62: Mode switching unit
65: Tailgate
66, 66A, 66B: Screen
α: Rearward tilt angle

### Second Embodiment

S100: Vehicle seat
101: Seat back
102: Seat cushion
103: Headrest
104: Armrest
107: Reclining mechanism
110: Operation lever
111: Lever storage portion
D200: Vehicle door
210: Storage portion
211: Lid portion
212: Display
214: Infrared sensor
215: Partition plate
216: Handhold portion
S300: Vehicle seat
D300: Vehicle door
301: Seat back
302: Seat cushion
303: Headrest
310: Air outlet
311: Moisture outlet
312: VR goggle
S400: Vehicle seat
D400: Vehicle door
401: Seat back
402: Seat cushion
403: Headrest
410: Support member
411: Fixing portion

### Third Embodiment

S2001, S2002, S2003, S2004, S2005: Vehicle member seat)
   S2001a, S2002a, S2004a, S2005a: Seat frame
S2006: Vehicle member (vehicle door lining)
S2007: Vehicle member (vehicle interior member)
2001: Seat cushion
   2001a, 2002a, 2007a: Pad material
   2001b, 2002b, 2007b: Skin material
   2001c: Accommodation recess
   2001d: Insertion hole
2002: Seat back
2003: Headrest
2004: Reclining device
2005, 2305: Height link device
2006, 2306: Rail device
2007: Armrest
2010, 2110, 2210, 2310, 2410: Cushion frame
2011, 2111, 2211, 2311, 2411: Cushion side frame
2012, 2112, 2212, 2412: Pan frame
2013, 2113, 2413: Rear connecting frame
2014, 2414: Elastic spring
2415: Clip member
2020, 2120: Back frame
2021, 2121: Back side frame
2022, 2122: Upper frame
2023, 2123: Lower frame
2024: Elastic wire
2025: Support plate
2030 (2030a to 2030m), 2130 (2130a, 2130b), 2230, 2330, 2430 (2430a to 2430c), 2530 (2530a to 2530f), 2630 (2630a to 2630d): Thermoelectric power generation member 2040, 2140 (2140a to 2140d), 2240 (2240a, 2240b), 2340, 2440 (2440a, 2440b), 2540 (2540a, 2540b): Electric power storage member
P: Power source
2050, 2150: Blower device (drive device)
2060: Duct
2061: First duct
   2061a: Lower pipe portion
   2061b: Curved pipe portion
2062: Second duct
   2062a: First bellows portion
2063: Third duct
   2063a: Back connection pipe portion
2064: Fourth duct
   2064a: Second bellows portion
   2064b: Cushion connection pipe portion
2065a, 2065b, 2165: Ventilation passage
2066a, 2066b, 2166: Ventilation hole
2070, 2270, 2370, 2470, 2570: Connection member
2080, 2180, 2280, 2480: Control device
2350: Drive mechanism (drive device)
2351: Transmission mechanism
2352: Link mechanism
D2000: Vehicle door
D2001: Door panel
D2002: Outer panel
D2003: Inner panel
2507: Door armrest
2508: Operation panel
2509: Decoration panel
2510: Light-emitting member
2511: Door lining base material
2512: Door lining skin material
2608: Steering wheel
2609: Instrument panel
2610: Roof panel

### Fourth Embodiment

V: Vehicle
H: Occupant
F: Vehicle body floor
D: Vehicle door
S3000: Vehicle seat (conveyance seat)
T: Cushion trim cover (skin)
P: Pad
Sh: Seat body
3001: Seat back
   3001a: Support surface
3011: Vibrator (vibration generation means)
3002: Seat cushion
   3002a: Seating surface
3021: Slide rail
3022: Seat belt device
3003: Headrest
3031: Protrusion mechanism
3032: Main portion
   3032a: Headrest pillar
3033L: Left side portion (side portion)
3033R: Right side portion (side portion)
3034: Main contact surface
3035L: Hinge
3035R: Hinge
3036L: Left contact surface
3036R: Right contact surface
3037L: Left drive unit
3037R: Right drive unit
3038L: Left display (video display means)
3038R: Right display (video display means)
3039L: Left speaker (audio generation means)
3039R: Right speaker (audio generation means)
3040: Abnormality detection unit
3041: Optical sensor
3042: Light-emitting device (lighting means)
3050: Seat control device (control unit)
3051: CPU
3052: ROM
3053: RAM
3054: Communication interface
3055: Bus
3060: Vehicle control device (conveyance control unit)
3061: CPU
3062: ROM
3063: RAM
3064: Communication interface
3065: Bus
3066: Driving mode switching unit
3067: Autonomous driving control unit
3068A: Monitor (video display means)
3068B: Speaker (audio generation means)
3068C: Lighting device (lighting means)
3068D: Vibration device (vibration generation means)
3007: Reclining mechanism
3071: Reclining rod
3072: Guide
3073: Reclining drive unit
3074: Reclining angle detection unit
3081: Roof-side rail
3082: Curtain airbag
3083: Front airbag

1. A display system, comprising:
a projection device provided in a vehicle interior of a vehicle and capable of projecting a video in the vehicle interior;
a sensor provided in the vehicle to detect a state of the vehicle or an occupant of the vehicle; and
a control unit that receives a signal from the sensor to control the projection device,
wherein the control unit changes a projection state of the projection device based on the signal from the sensor.

2. The display system according to claim 1,
wherein the sensor is a door sensor that detects an open/closed state of a door of the vehicle, and
the control unit stops the projection of the projection device when the door sensor detects that the door is opened.

3. The display system according to claim 1,
wherein the sensor is a window sensor that detects an open/closed state of a window or a roof window of the vehicle, and
the control unit stops the projection of the projection device when the window sensor detects that the window or the roof window is opened.

4. The display system according to claim 1,
wherein the sensor is an incoming call sensor that detects an incoming call on a mobile phone of the occupant, and
the control unit stops the projection of the projection device when the incoming call sensor detects an incoming call on the mobile phone.

5. The display system according to claim 1,
wherein the sensor is a seating sensor that detects a seated state of the occupant, and
the control unit stops the projection of the projection device when the seating sensor detects that the occupant leaves a seat.

6. The display system according to claim 1,
wherein the sensor is an illuminance sensor that measures an illuminance of the vehicle interior, and
the control unit corrects the video projected by the projection device, based on the illuminance measured by the illuminance sensor.

7. The display system according to claim 6,
wherein the vehicle includes an illuminance adjustment mechanism that adjusts the illuminance of the vehicle interior based on the illuminance measured by the illuminance sensor, and
the control unit corrects the video projected by the projection device, based on an illuminance measured by the illuminance sensor after the adjustment.

8. The display system according to claim 1,
wherein the vehicle is an autonomous driving vehicle that can travel autonomously, and includes a mode switching unit that switches between a manual driving mode and an autonomous driving mode, and
the control unit sets the projection device to be operable when the vehicle is switched to the autonomous driving mode by the mode switching unit, and sets the projection device to be inoperable or stops the projection of the projection device when the vehicle is switched to the manual driving mode.

9. The display system according to claim 1,
wherein a seat state changing mechanism that changes a state of a seat in which the occupant is seated is provided, and
the control unit prompts a use of the projection device when a seat back of the seat is tilted rearward by more than a predetermined angle by the seat state changing mechanism.

10. A vehicle, comprising: the display system according to claim 1.
